(19) United States
(12) Patent Application Publication
(10) Pub. No.: US 2009/0300231 A1
(43) Pub. Date: Dec. 3, 2009

(54) DATA OUTPUT DEVICE, EQUIPMENT CONTROL DEVICE, AND MULTIMEDIA DELIVERY SYSTEM

(75) Inventor: Toshihiko Munetsugu, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/097,821

(22) PCT Filed: Dec. 6, 2006
(86) PCT No.: PCT/JP2006/324329

§ 371 Date: Jun. 17, 2008

(30) Foreign Application Priority Data
Dec. 20, 2005 (JP) 2005-367003
Dec. 27, 2005 (JP) 2005-376596

(51) Int. Cl. G06F 13/00

(52) U.S. Cl. 710/33

(57) ABSTRACT

A technology which can appropriately resume reproduction of paused content from a terminal in another terminal in a multimedia delivery system made up of a multimedia content server and plural terminals connected to a network.

A data output device which outputs multimedia data that includes at least one of video and audio, the data output device including: a control unit operable to generate resume position information and to cause said storage unit to store the generated resume position information when a pause request, which is a request to pause output by a first or a second output unit, is received by a receiving unit which receives a signal from an external device, and to read out the resume position information from the storage unit, to cause the readout unit to read out the multimedia data, starting from a resume position shown by the resume position information, from the accumulation unit and to cause the first or the second output unit to output the read-out multimedia data to the output destination.

### TECHNICAL FIELD

The present invention relates to output of multimedia content to a network and so on, as well as control of the output.

### BACKGROUND ART

In recent years, digital broadcasting such as BS digital broadcasting, CS 110-degree digital broadcasting, and digital terrestrial broadcasting have commenced. Additionally, the popularity of HDD recorders, DVDs (Digital Versatile Disc) recorders and so on is growing. Thus, digitalized multimedia content that can be used in households is increasing.

Meanwhile, with the development of the broadband environment, internet access from households is becoming widespread. Accordingly, the spread of “home networks”, in which the respective rooms in a house are connected by an IP network, is also advancing.

Thus, digital broadcasts received by a digital broadcast receiver in the house, or digital content accumulated in a recorder can now be viewed in other rooms, using the home network. Here, the method defined in Universal Plug and Play (UPnP) is widely used in the mutual recognition of the devices and mutual communication of information regarding what content can be used, in a server (for example, a set top box or HDD recorder which receives digital broadcasts) and a client (for example, a personal computer or a digital player) on the home network. Additionally, Real Time Transport Protocol (RTP) and the like are used for communicating multimedia data, and Real Time Streaming Protocol (RTSP) and the like are used to control the data transmission. RTSP is standardized by Internet Engineering Task Force (IETF). (See for example, Non-patent Reference 1).

When reproducing or viewing long-play digital content such as movies, it is often done that the viewing is stopped for a short time and the succeeding portion will be viewed later on. In case of viewing through a network controlled with RTSP, it can be achieved by using a RESUME function of RTSP, or by the way that the client stores the pause position and requests the transmission which starts from the paused position to the server again when the output is resumed. At this point, since it becomes possible to view content in multiple rooms via the home network, there are needs such as a viewing from a succeeding portion of the content viewed in the living room can be resumed in a bedroom, for example.

### Non-patent Reference 1: RFC2326 Real Time Streaming Protocol (RTSP)

### DISCLOSURE OF INVENTION

### Problems that Invention is to Solve

However, RTSP deals with 1-on-1 transfer between the server and the client, not considering data transfer to another client, thus it is not possible to change rooms and resume viewing. Additionally, since the client changes, the method in which the client remembers the pause position cannot be used.

The present invention is realized in order to solve the problems above, and has as an object of providing a data output device, an equipment control device and a multimedia delivery system with which content can be viewed from a pause position not only from the same client but also from other clients.

### Means to Solve the Problems

In order to solve the conventional problem, the data output device in the present invention is a data output device which outputs multimedia data that includes at least one of video and audio, the data output device including: a receiving unit which receives a signal from an external device; an accumulation unit which accumulates the multimedia data; a readout unit which reads out the multimedia data from the accumulation unit; an output unit which outputs the multimedia data to a designated output destination; a storage unit which stores the multimedia data for which output by the output unit has been paused and resume position information which shows a position for resuming output of the multimedia data; and a control unit which generates the resume position information and causes the storage unit to store the generated resume position information when a pause request, which is a request to pause output by the output unit, is received by the receiving unit, and reads out the resume position information from the storage unit, causes the readout unit to read out the multimedia data, starting from the resume position indicated by the resume position information, from the accumulation unit, and causes the output unit to output the read-out multimedia data to the output destination, when a resume request which is a request to resume output by the output unit is received by the receiving unit.

In this way, the data output device in the present invention stores the resume position information. Thus, even when the output destination of the multimedia data changes, the paused output of the multimedia data can be accurately resumed from the paused position.

Optimally, the data output device is connected to plural terminals via a network, and the output unit outputs to one of the plural terminals as the output destination specified by a user.

In this way, the output unit can output to plural terminals connected via a network. Thus when one of the terminals is designated, output to the terminal can be resumed. Therefore, paused data can be outputted to an output destination which differs from that of the paused data.

Optimally, the output unit outputs the multimedia data to one of plural output destinations, and when the receiving unit has received the resume request and one of the plural output destinations, the control unit reads out the resume position information from the storage unit, causes the readout unit to read out the multimedia data, starting from the resume position indicated by the resume position information from the accumulation unit, and causes the output unit to output the read-out multimedia data to the output destination received by the receiving unit.

In this way the output unit can output to one of the plural terminals. Thus when one of the terminals is designated, output can be resumed to the designated terminal. Therefore, paused data can be outputted to other output destination.

Further and optimally, the control unit, when the pause request is received by the receiving unit, generates the resume position information and a pause identifier which is used to identify the pause request and causes the storage unit to store the generated resume position information and the pause identifier, and when the resume request, the output destination and the pause identifier are received by the receiving unit, the control unit reads out the resume position information corresponding to the pause identifier from the storage unit, causes the readout unit to read out the multimedia data starting from the resume position indicated by the resume position information from the accumulation unit, and causes the output unit to output the read-out multimedia data to the output destination.

In this way, the storage unit stores the resume position information and the pause identifier. Thus, convenience improves since the user can instruct the resume request using the pause identifier.

Further and optimally, the control unit further, when the pause request and an output destination when output is resumed are received by the receiving unit, generates the resume position information, and causes the storage unit to store the resume position information and the output destination, and when the resume request is received by the receiving unit, the control unit reads out the resume position information and the output destination from the storage unit, causes the readout unit to read out the multimedia data, starting from the resume position indicated by the resume position information, from the accumulation unit and causes the output unit to output the read-out multimedia data from the storage unit to the read-out output destination.

In this way, the storage unit stores the resume position information and the output destination. Thus output can be resumed only when the output resume request is accepted from the stored output destination. Therefore, it becomes possible, for example, that an appropriate content is outputted from an appropriate resume position according to the output destination which has received the resume request by storing plural combinations of the resume position information and the output destination.

Further and optimally, the data output device further includes a data receiving unit which receives the multimedia data from an external device; and a writing unit which writes multimedia data received by the data receiving unit into the accumulation unit; wherein the control unit, when the pause request is received while the data receiving unit receives multimedia data and the output unit outputs the multimedia data, further causes the data receiving unit to receive a succeeding portion of the multimedia data, and causes the writing unit to write the received succeeding portion of the multimedia data into the accumulation unit, and when the receiving unit has received the resume request and the output destination, the control unit causes the readout unit to read out the succeeding portion of the multimedia data written into the accumulation unit by the writing unit, and causes the output unit to output the read-out succeeding portion of the multimedia data to the output destination.

In this way, when a pause request is received during outputting the multimedia data while receiving the multimedia data, a succeeding portion of the received multimedia data is accumulated. Thus even for the data that has not been completely received when the output of the data is paused such as the data receiving via the digital broadcast or Video on Demand (VoD) and so on, the accumulated multimedia data can be outputted when the resume request is accepted. Therefore, the output of the multimedia data when the resume request is accepted can be accurately resumed.

Further and optimally, the data output device further includes a reproduction unit which reproduces the multimedia data; the output unit is which outputs the multimedia data to one of plural output destinations or the reproduction unit, and the control unit further generates the resume position information and causes the storage unit to store the generated resume position information when the pause signal is received by the receiving unit while the output unit outputs to the reproduction unit.

In this way, the data output device itself includes the reproduction unit which reproduces the multimedia data and can designate the reproduction unit as the output destination. Thus the data output device itself can be an output destination.

Further and optimally, the data output device includes a data receiving unit which receives multimedia data from an external device; a writing unit which writes the multimedia data received by the data receiving unit into the accumulation unit; the control unit, when the pause request is received while the data receiving unit receives multimedia data and the output unit outputs the multimedia data to the reproduction unit, further causes the data receiving unit to receive a succeeding portion of the multimedia data, and causes the writing unit to write the received succeeding portion of the multimedia data in the accumulation unit, and when the receiving unit has received the resume request, the control unit causes the readout unit to read out the succeeding portion of the multimedia data written into the accumulation unit by the writing unit and causes the output unit to output the read-out multimedia data to the output destination.

In this way, the data output device receives the multimedia data from an external device and accumulates the received multimedia data in the storage unit. Thus even when the multimedia data broadcasted as the digital broadcast or delivered as the VoD is paused and the resume request of it is accepted, the output of the multimedia data can be resumed accurately.

Further and optimally, the data output device further includes a Java execution unit which executes a Java (registered trademark) application, the control unit being started by the Java application.

In this way, the data output device includes a Java execution unit. Thus the application program programmed in Java (below, ‘Java application’) can be executed. Therefore the control unit can control each unit included in the data output device using a function initiated by executing the Java application.

Additionally, an equipment control device of a 19th invention, which issues a request to a data output device that outputs multimedia data which includes at least one of video and audio, is the equipment control device comprising: a transmission unit which transmits a request to the data output device, and a control unit which specifies an output destination where the data output device resumes the paused output and causes the transmission unit to transmit to the specified output destination when the pause request which is a request for the data output device to pause output of the multimedia data is transmitted to the data output device.

In this way, the equipment control device transmits the specified output destination together with the pause request to the data output device. Thus a transmission destination when the data output is resumed can be registered in the data output device and it becomes possible to cause the data output device to output the multimedia data to an appropriate output destination starting from an appropriate reproduction position.

Optimally, the equipment control device further includes a Java execution unit which executes a Java application; wherein the control unit, if the pause request is accepted from the Java application, specifies an output destination where the data output device resumes the paused output and causes the transmission unit to transmit to the specified output destination when the pause request is transmitted to the data output device.

In this way, the equipment control device further includes a Java execution unit. Thus an application programmed in Java can be executed. Therefore, the control unit can control each unit included in the data output device using a function initiated by executing the Java application.

Next, an equipment control device of a 22nd invention is the equipment control device, which is connected to a data output device which provides multimedia data that includes at least one of video and audio via a network, and which functions by a user operation, which comprising: an attribute receiving unit which receives the attributes of a content which are attached to the multimedia data provided from the data output device; a transmission unit which transmits a request to the data output device, and a control unit which judges whether or not output of the content is paused from the attributes, and if it is judged that output of the content is paused, causes the transmission unit to transmit the resume request to the data output device, when the resume request, which is a request to resume content data output, is received based on the user operation.

In this way, the equipment control device controls the data output device through the network and judges whether or not output of the content is paused referring to the attributes of the content which are attached to the content, and transmits a resume request for output of the multimedia data which includes the content if the equipment control device judges the output is paused. Thus when the output is paused, the data can be outputted starting from the paused position and it becomes possible to make the data output device to output the multimedia data to an appropriate output destination starting from an appropriate reproduction position.

Ideally, the attribute receiving unit receives attributes of the content that includes an identifier which indicates paused output for each content, and the control unit causes the transmission unit to transmit the resume request and the identifier to the data output device when it is judged that output is paused.

In this way, an identifier which expresses that the output is paused is included in attributes of the content. Thus the multimedia data can be specified according to the identifier and the output can be resumed.

Further, the equipment control device comprises a Java execution unit which executes a Java application; and the control unit judges whether or not output of the content is paused, based on the content attributes received by the attribute receiving unit, when the resume request is received from the Java application, and causes the transmission unit to transmit the resume request to the data output device if it is judged that the output is paused.

In this way, the equipment control device further includes a Java execution unit. Thus the application programmed in Java can be executed. Therefore, the control unit can control each unit included in the data output device using a function initiated by executing the Java application.

Further, an equipment control device of the 26th invention which is connected to a network and which controls a data output device which outputs multimedia data that includes at least one of video and audio, the equipment control device comprising: a storage unit which stores resume position information obtained from the multimedia data for which output is paused and the position at which output of the multimedia data is paused, and which indicates a position at which output is to be resumed, when issuing an output pause request to the data output device; a communication unit which communicates with the data output device; a control unit which receives the resume position information from the data output device and causes the storage unit to store the received resume position information, and transmits the resume position information stored in the storage unit and an output destination to the data output device when the output resume request is sent to the data output device.

In this way, the equipment control device controls the data output device through the network and stores the resume position information. Thus the equipment control device can transmit the position at which output is resumed together with a resume request to the data output device through the network. Therefore, the equipment control device can accurately control the resumption of the multimedia data output by the data output device.

Optimally, the equipment control device further comprises: a Java execution unit which executes a Java application, the control unit, when the control unit receives the pause request to the data output device from the Java application, causes the communication unit to transmit the pause request to the data output device, and causes the communication unit to receive the resume position information obtained from the multimedia data for which output is paused and the position at which output is paused from the data output device, and causes the storage unit to store the received resume position information, and, when the control unit receives an output resume request to the data output device from the Java application, reads out the resume position information stored in the storage unit, and causes the communication unit to transmit the resume position information along with the output resume request and an output destination to the data output device.

In this way, the equipment control device further comprises a Java execution unit. Thus the application programmed in Java can be executed. Therefore, the control unit can control each unit included in the data output device using a function initiated by executing the Java application.

Note that the present invention can not only be implemented as a data output device and an equipment control device which comprise such characteristic units like the units above, the present invention can also be implemented as a method in which the characteristic units included in the data output device and the equipment control device are corresponding to the steps, and be implemented as the program which causes a computer to function as the method in which the characteristic units included in the data output device and the equipment control device respectively function. And such a program can be delivered via a recordable medium such as a Compact Disc-Read Only Memory (CD-ROM) and a communication network such as the Internet. Additionally the present invention can be realized as a multimedia delivery system which includes the data output device and the equipment control device which include the characteristic units above.

### EFFECTS OF THE INVENTION

As indicated above, when using the data output device, the equipment control device and the multimedia delivery system in the present invention to view and/or reproduce multimedia content, the content can be accurately resumed even when opened on another terminal in the network.

### BRIEF DESCRIPTION OF DRAWINGS

FIG. 1 is a structural diagram for the multimedia delivery system in the first embodiment of the present invention;

FIG. 2 is a block diagram showing an exemplary structure of a data output device in the first embodiment of the present invention;

FIG. 3 is a block diagram showing a terminal and the structure of the terminal in the first embodiment of the present invention;

FIG. 4 is a diagram which shows an exemplary structure of data accumulated in an accumulation unit in the first embodiment of the present invention;

FIG. 5 is a diagram which shows an example of attribute information for the multimedia data in the first embodiment of the present invention;

FIG. 6 is a diagram which shows an example of a URI table in the first embodiment of the present invention;

FIG. 7 is a diagram which shows an example of resume position information in the first embodiment of the present invention;

FIG. 8 is a diagram which shows an example of resume position information in the first modification of the first embodiment of the present invention;

FIG. 9 is a diagram which shows an example of resume position information in a second modification of the first embodiment of the present invention;

FIG. 10 is a block diagram which shows an example of the structure of a data output device in a third modification of the first embodiment in the present invention;

FIG. 11 is a block diagram which shows an example of the structure of the data output device in a fourth modification of the first embodiment of the present invention;

FIG. 12 is a diagram which shows an exemplary structure of the multimedia delivery system in a fifth modification of the first embodiment in the present invention;

FIG. 13 is a diagram which shows an exemplary structure of the multimedia delivery system in the second embodiment of the present invention;

FIG. 14 is a block diagram showing an example of the structure of the data output device in the second embodiment of the present invention;

FIG. 15 is a diagram that shows an example of an external view when the input unit according to the second embodiment is made up of a front panel;

FIG. 16 is a diagram showing an exemplary structure of the program held and executed by the data output device in the second embodiment of the present invention;

FIG. 17 is a diagram which shows an example of a program guide displayed in the monitor according to the second embodiment of the present invention;

FIG. 18 is a diagram which shows an example of program information stored in the second memory according to the second embodiment in the present invention;

FIG. 19 is a diagram which shows an example of channel information stored in the second memory according to the second embodiment of the present invention;

FIG. 20 is a diagram which shows an example of a channel identifier stored in the second memory according to the second embodiment of the present invention;

FIG. 21 is a diagram which schematically shows an example of collected PAT information;

FIG. 22 is a diagram which schematically shows an example of collected PMT information;

FIG. 23 is a diagram which schematically shows an example of collected AIT information;

FIG. 24 shows an example of a downloaded file system;

FIG. 25 is a diagram which shows an example of a format in which the data output device accumulates multimedia data in the second memory;

FIG. 26 is a diagram which shows an example of attribute information in the second embodiment of the present invention;

FIG. 27 is a diagram which shows an example of an attribute information table in the second embodiment of the present invention;

FIG. 28 is a diagram which shows an exemplary interior structure of a network library;

FIG. 29 is a diagram which shows an example of a Java API provided by the control unit included in the internal structure of the network library;

FIG. 30 is a diagram which shows an example of the structure of the Net Device class used by the network library;

FIG. 31 is a diagram which shows an example of the structure of the ‘ServHandler’ interface used in the network library;

FIG. 32 is a diagram which shows an example of the structure of a URI table in the second embodiment of the present invention;

FIG. 33 is a diagram which shows an example of the structure of the ReopenContentInfo class used in the network library;

FIG. 34 is a diagram which shows an example of the structure of the resume position information table in the second embodiment of the present invention;

FIG. 35 is a diagram which shows an example of a Java API provided by the information receiving unit included in the internal structure of the network library;

FIG. 36 is a diagram which shows an example of the structure of the RequestInfo class used in the network library;

FIG. 37 is a diagram which shows an example of a Java API included in the network library which is provided by the data output unit included in the internal structure of the network library;

FIG. 38 is a diagram which shows an example of the structure of the RequestInfo class used in the network library;

FIG. 39 is a diagram which shows an example of a Java API included in the network library provided by an information receiving unit included in the internal structure of the network library;

FIG. 40 is a diagram which shows an example of the Java API provided by the data receiving unit included in the internal structure of the network library 1605e;

FIG. 41 is a block diagram which shows an example of the structure of the terminal in the second embodiment of the present invention;

FIG. 42 is a diagram which shows an example of the structure of the program held in respective terminals in order to be executed according to the second embodiment;

FIG. 43 is a block diagram which shows an example of the internal structure of the network library;

FIG. 44 is a diagram which shows an example of the Java API provided by the control unit included in the internal structure of the network library;

FIG. 45 is a diagram which shows the structure of the ContentInfo class used by the network library;

FIG. 46 is a diagram which shows an example of the structure of the ClientHanlder interface used in the network library;

FIG. 47 is a diagram which shows an example of Java API provided by an information transmission unit included in the internal structure of the network library;

FIG. 48 is a diagram which shows an example of the Java API provided by the information receiving unit included in the internal structure of the network library;

FIG. 49 is a diagram which shows an example of Java API provided by a judging unit included in the internal structure of the network library;

FIG. 50 is a diagram which shows an example of the Java API provided by the data receiving unit included in the internal structure of the network library;

FIG. 51 is a diagram which shows an example of the structure of the RemoteProgram class used by the network library 3004d; and

FIG. 52 is a diagram which shows the structure of the multimedia delivery system in a sixth modification of the second embodiment in the present invention.

### NUMERICAL REFERENCES

101, 1301 Data output device
102, 103, 1203, 1204, 1302, 1303, 5203, 5304 Terminal
104, 1205, 1304, 5205 Network
105, 1206, 1305, 5206 Multimedia delivery system
201 Control unit
202, 1204 Receiving unit
203 Accumulation unit
204 Readout unit
205 First output unit
206 Second output unit
207 Storage unit
208 Writing unit
209 Network interface
301 Equipment control unit
302 Control unit
303 Receiving unit
304 Transmission unit
305 Judging unit
306 Data receiving unit
307 Data decoding unit
308 Network interface
309 Display unit
401 Multimedia data
402 Multimedia data
411 Attribute data for the multimedia data 401
412 Attribute data for the multimedia data 402
421 URI table in the multimedia data
701 Resume position information
801 Resume position information
802 Resume position information
803 Resume position information
901 Resume position information
902 Resume position information
1001 Data receiving unit
1002 Data receiving interface
1101 Data decoding unit
1102 Display unit
1201, 5201 Data output device
1202, 5202 Control device
1401, 4101 Input unit
1402, 4102 First memory
1403, 4103 Second memory
1405, 4104 Demultiplex unit
1406 Descrambler
1407, 4105 TS decoder
1408, 4106 Video output unit
1409, 4107 Audio output unit
1410 TS multiplexer
1411, 4108 Network unit
1412, 4109 CPU

### BEST MODE FOR CARRYING OUT THE INVENTION

### First Embodiment

Hereinafter, the embodiment of the present invention shall be described with reference to the drawings.

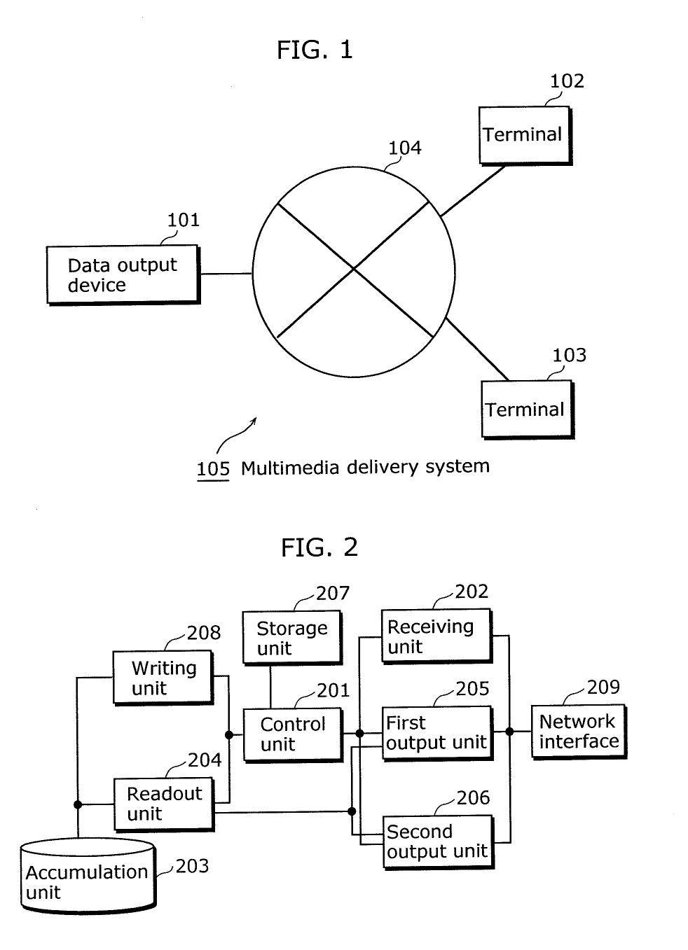

FIG. 1 is a structural diagram for the multimedia delivery system in the first embodiment of the present invention.

The multimedia delivery system 105 shown in FIG. 1 includes a data output device 101, a first terminal 102, a second terminal 103 and a network 104. The data output device 101, the terminal 102 and the terminal 103 are connected to the network 104, and can communicate mutually through the network 104.

The data output device 101 in the present embodiment receives a request transmitted from the terminal 102 and the terminal 103 via the network 104. Subsequently, the data output device 101 transmits the information, attributes or the multimedia data of each contents accumulated in response to the request to the terminal 102 and the terminal 103 through the network 104.

When the data output device 101 receives the pause request from the transmission destination terminal for the data output that is executed, the data output device 101 stores the data position at which output is to be resumed, which is the next position of the last transmitted data, in combination with the file name or a Uniform Resource Identifier (URI) of the data inside the device as resume position information, and adds the attribute ‘output paused’ to the data. Subsequently, when the data output device 101 receives a data transmission resume request from the terminal, the data output device 101 resumes the data transmission from the beginning of the untransmitted data to the designated terminal, referring the stored resume position information.

The terminal 102 and the terminal 103 transmit a transmission request for multimedia data or content attributes to the data output device 101 through the network 104 according to a user's request. Subsequently, when the terminal 102 and the terminal 103 receive the content attributes, they present the content attributes to the user if necessary, and when they receive the multimedia data, they reproduce the data and display the decoded data.

The terminal 102 and the terminal 103 can judge whether or not the content is ‘output paused’ from the content attributes, and issue a request to resume data transmission according to user's request.

The network 104 is a home network established in the household, and is an IP network configured of Ethernet (registered trademark), wireless LAN, and so on.

It follows from the above that, in the data output device 101, the terminal 102, the terminal 103 and the multimedia delivery system 105 in the present invention, for example, even when the transmission of data which was being received by the terminal 102 is paused, the data transmission can be accurately resumed in another terminal 103.

Hereinafter, the data output device 101, the terminal 102 and the terminal 103 included in the multimedia delivery system 105 of the present invention shall be described in more detail. Here, an example is explained in which data transmission is paused during data communication to the terminal 102 and the paused data transmission to the terminal 103 is resumed, however other cases are the same.

First, the data output device 101 shall be described.

FIG. 2 is a block diagram which shows an example of the structure of the data output device 101 in the first embodiment of the present invention.

The data output device 101 shown in FIG. 2 includes a control device 201, a receiving unit 202 which receives a signal from an external control device, an accumulation unit 203 which accumulates data, a readout unit 204 which reads out data from an accumulation unit 203 according to an instruction from the control unit 201, a first output unit 205, a second output unit 206, a storage unit 207 which stores resume position information obtained from the data and the pause position of data output when the data output is paused, a writing unit 208 which writes data into the accumulation unit 203 and a network interface 209 which is connected with the network 104.

The control unit 201 is below described in more detail. The control unit 201 is composed of a microprocessor, a ROM, a RAM and so on. An OS, Java (Registered Trademark), a VM (Java Virtual Machine) program, a Java program library, and a Java application program which function in the microprocessor are saved in the ROM, the RAM and the information storage unit which is not illustrated. The microprocessor reads and executes the OS at start-up. Subsequently, on the start-up of the Java application, the Java VM is read and executed and the Java application is executed, reading the Java program library if necessary.

The control unit 201 receives the signal from the receiving unit 202 and performs control for the readout unit 204, the first output unit 205, the second output unit 206, the storage unit 207, the writing unit 208 as well as data transfer and reception between each of the units according to the Java application.

The receiving unit 202 is connected to the network interface 209, and receives and passes information addressed to the data output device 101 which has reached the network interface 209 to the control unit 201. The receiving unit 202 is, typically, a socket interface provided by an OS or a Java library, or a program which uses a socket interface.

Note that this structure is not limited to one composed by software, and may be composed using hardware. Additionally, besides the network interface 209, it may also be connected together to other transmission units such as Infrared transmission at the same time.

The accumulation unit 203 is composed of an accumulation device for digital data having a large capacity which is represented by a hard disk drive and its driver software.

The readout unit 204 receives an instruction from the control unit 201, reads out data sequentially from a designated position in the designated file from among the data file accumulated by the accumulation unit 203, and transfers the data to the first output unit 205 and the second output unit 206.

The first output unit 205 and the second output unit 206 are connected to the network interface 209, function by receiving an instruction from the control unit 201, convert data sent from the control unit 201 or the readout unit 204 into a packet for an address instructed by the control unit 201, and output the data through the network interface 209. The first output unit 205 and the second output unit 206 are typically socket interfaces provided by the OS or the Java library or programs which use a socket interface. Note that this structure is not limited to one composed by software, and may be composed using hardware.

The storage unit 207, which is made up of a storage device such as a flash memory or an HDD, or a part of a storage device, receives an instruction from the control unit 201 and stores data received from the control unit 201.

The writing unit 208 receives the instruction from the control unit 201 and writes data into the accumulation unit 203. For writing data, there is a case where data is written anew and a case where the existing data is overwritten.

The network interface 209 is made up of hardware which provides an interface corresponding to the physical media in the network such as an ether cable or wireless LAN, and the driver software for the hardware.

Below, the functions of the data output device 101 are further explained in detail with reference to the drawings. Here, in order to simplify the explanation, the first output unit 205 outputs to the terminal 102 and the second output unit 206 outputs to the terminal 103, however it goes without saying that the structure is not limited to this structure.

FIG. 4 is a diagram which shows an exemplary structure of data accumulated by the accumulation unit 203 in the first embodiment of the present invention.

FIG. 4 shows an example in which the accumulation unit 203 accumulates, roughly speaking, three types of data groups: multimedia data, attribute information for multimedia data and a URI table in the multimedia data, and the accumulation unit 203 includes multimedia data 401, multimedia data 402, attribute information 411, attribute information 412 and a URI table 421 which includes multimedia data. In the present embodiment, the attribute information 411 expresses the attribute information of the multimedia data 401 and the attribute information 412 expresses the attribute information of the multimedia data 402 respectively. The multimedia data and attribute information accumulated by the accumulation unit 203 is not limited to this data and information respectively.

The multimedia data 401 and 402 are digitally encoded multimedia content data and are typically data coded in MPEG-2. Each multimedia data 401 and 402 are accumulated as one file and a file name is attached respectively to the multimedia data 401 and 402 in the accumulation unit 203.

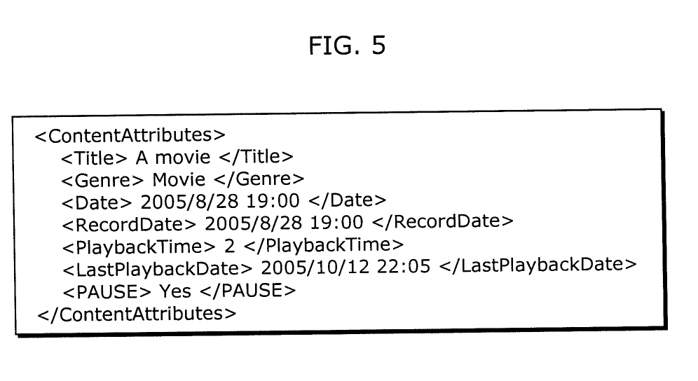

The attribute information 411 and 412 apply supplementary information to the multimedia data 401 and 402, for example, the title of the content, genre, broadcast time and date, recording time and date, number of times outputted and last time and date outputted. An example of attribute information is shown in FIG. 5.

FIG. 5 is a diagram which shows an example of the multimedia attribute information 411 in the first embodiment of the present invention. The attribute information shown in FIG. 5 is text information defined by the Extensible Markup Language (XML).

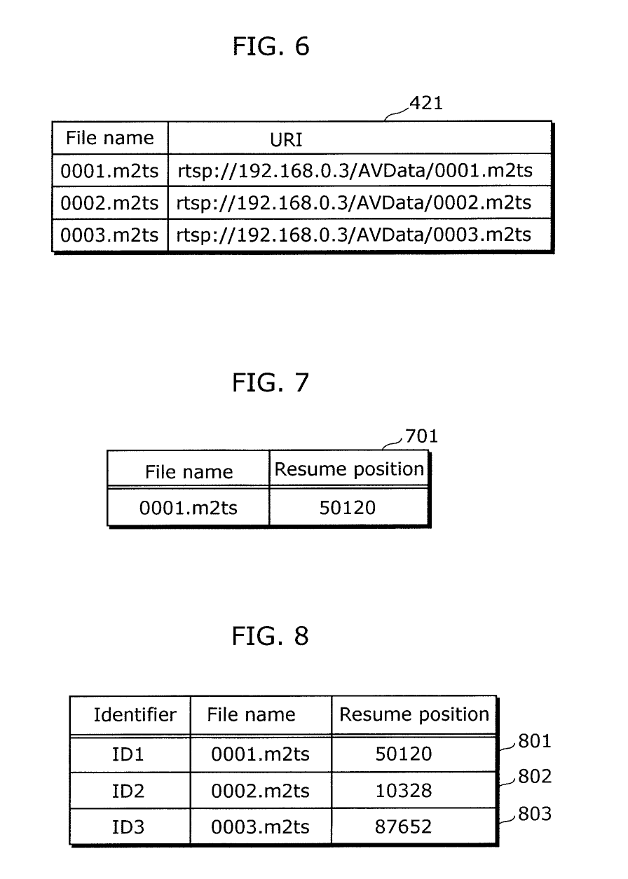

The URI table 421 is used for storing the correspondence for each set of multimedia data and its URI, and an example is shown in FIG. 6.

FIG. 6 is a diagram which shows an example of the URI table 421 according to the first embodiment of the present invention. It is shown in FIG. 6 that the URI of the multimedia data whose file name is 0001.m2ts is rtsp://192.168.0.3/AVData/0001.m2ts.

Note that the URI table is not always necessary and may be created every time when necessary by the control unit 201 using an IP address or a host name of the data output device 101, and a file name of the multimedia data, or the URI may be described in the attribute information as additional information. Additionally, the URI table is not limited to the correspondence between the file name and the URI, and may represent the correspondence between a title, an identifier, or a number and the URI, the identifier or number being added for each multimedia data.

First, the function of the data output device 101 in the process until the data transmission to the terminal 102 is paused is explained below.

When the request from the terminal 102 received by the receiving unit 202 is a request to acquire a content list, the control unit 201 controls the readout unit 204 to read out information, thereby creating a multimedia data list accumulated by the accumulation unit 203, and transmits the list from the first output unit 205 to the terminal 102.

The content list includes, for each content, at least a content title and a URI for accessing the content. Additionally, when the output of multimedia data is paused, such attribute is also included. Additionally, attribute information is read out for each multimedia data and its content is attached and transmitted if necessary.

Since methods defined in UPnP AV can be used for a protocol of the request to acquire the content list and the response to it and the data format of the content list, a detailed explanation is not provided. However, the extended format originally is used for the output paused attribute of the multimedia data. Since the format of the content list is defined in XML, the format can be extended without contradictions by using an XML Namespace. For example, the PAUSE element which is in an proprietary name space Na is added to the information for each contents and when the content of the PAUSE element is ‘Yes’, the content information for the data can be expressed as “output paused”.

Additionally, when the request received from the receiving unit 202 in the terminal 102 is a transmission request, the control unit 201 instructs the readout unit 204 to read out the requested multimedia data from the accumulation unit 203, and instructs the first output unit 205 to transmit the read out data. For example, when it is requested that data whose URI is rtsp://192.168.0.3/AVData/0001.m2ts be transmitted from the beginning, the message below is transmitted from the terminal 102 to the output device 101 using RTSP as the transmission request.

PLAY rtsp://192.168.0.3/AVData/0001.m2ts RTSP/1.0

### CSeq: 2

### Session: 12345

Range: smtpe=0:00:00

When the control unit 201 receives the above message, multimedia data, whose URI is rtsp://192.168.0.3/AVdata/0001.m2ts is retrieved by referencing the URI Table 421 read out by the readout unit 204. For the present embodiment, the multimedia data 401 corresponds to rtsp://192.168.0.3/AVdata/001.m2ts. When there is corresponding multimedia data, the control unit 201 creates a response message defined by RTSP as below, and instructs the first output unit 205 to transmit the response message to the first output unit 205.

### RTSP/1.0 200 OK

### CSeq: 2

### Session: 12345

Range: smtpe=0:00:00-0:55:00
RTP-Info: url=rtsp://192.168.0.3/AVData/0001.m2ts; seq=12312 3532; rtptime=53265

Subsequently, the control unit 201 instructs the readout unit 204 to read out data sequentially from the beginning of the multimedia data 401, and instructs the first output unit 205 to transmit the read out data to the terminal 102. Data transmission is performed using a method defined in RTP and a detailed explanation is not provided.

When the request received from the receiving unit 202 in the terminal 102 is a request to pause data transmission, the control unit 201 instructs the first output unit 205 to stop data transmission and receive the amount of transmitted data by instructing the first output unit 205. Additionally, the control unit 201 instructs the readout unit 204 to stop data read-out from the accumulation unit 203. When using RTSP, pausing the data transmission can be performed by using the PAUSE command. The message below is transmitted from the terminal 102.

PAUSE rtsp://192.168.0.3/AVData/0001.m2ts RTSP/1.0

### CSeq: 3

### Session: 12345

When the above PAUSE command is received, the control unit 201 stops the data transmission, creates the response message below, and instructs the first output unit 205 to transmit the response message.

### RTSP/1.0 200 OK

### CSeq: 3

### Session: 12345

Additionally, the control unit 201 instructs the readout unit 204 to read out the attribute information 411, and adds the output paused attribute. In the present embodiment, the attribute information shown in FIG. 5 is represented by the element “PAUSE”. In other words, it is the only case which represents the content transmission is posed that there is a PAUSE element and that the content of the PAUSE element is ‘Yes’.

After renewing the attribute information 411, the control unit 201 instructs the writing unit 208 to overwrite the attribute information 411 in the accumulation unit 203.

The control unit 201 further finds a transmission resume position which is the start point when the data transfer is resumed using the amount of transmitted data that is received from the first output unit 205. Thus for example when 50,119 bytes of data is transmitted, the start point of the data is the 50,120th byte.

The control unit 201 creates the transmission resume position by combining the start point and the information for identifying the multimedia data 401, for example its file name, and stores the resume position information in the storage unit 207. An example of the resume position information is shown in FIG. 7.

FIG. 7 is a diagram which shows an example of the resume position information in the first embodiment of the present invention. FIG. 7 shows the resume position information 701 for the above paused data transmission. Note that in the present embodiment, a transmission resume position is found based on the amount of transmitted data received from the first output unit 205, however the transmission resume position may be found based on the information from the read out unit 204, for example based on the amount of read-out data.

In RTSP, a TEARDOWN command which terminates the session is subsequently transmitted and received, however in the present embodiment even when TEARDOWN is performed, the resume position information 701 and the attribute information 411 are not updated.

Note that in order to express a pause which is to be resumed subsequently more clearly, a structure may be utilized in which PAUSE or TEARDOWN are extended and the creation or holding of the resume position information 701 and the update or holding of the attribute information 411 are requested. For example, the PAUSE message above is written as below, in the case that X-Keep-Pause-Status, which is an proprietary extension header, is used, and that only when the value is ‘Yes’, the resume position information 701 is created and/or held and the attribute information 411 is updated and/or held.

PAUSE rtsp://192.168.0.3/AVData/0001.m2ts RTSP/1.0

### CSeq: 3

### Session: 12345

### X-Keep-Pause-Status: Yes

In this case, since there is an X-Keep-Pause-Status header in the received PAUSE message and its value is ‘Yes’, the control unit 201 creates the resume position information 701 and holds it, and updates the attribute information 411 and holds it. Besides the cases in which there is no X-Keep-Pause-Status header, or where there is an X-Keep-Pause-Status but with a value other than ‘Yes’, the control unit 201 does not create the resume position information 701, and does not update the attribute information 411.

Next, the function of the data output device 101 in the process which resumes the data transmission that has been paused in communication with the terminal 103 above is explained below.

First, in relation to acquiring the content list, the explanation is not repeated since it is the same as above.

The processing of the control unit 201 when the request for the terminal 103 received from the receiving unit 202 is a request for resuming the paused data transmission is explained below. In the present embodiment, the request is made using X-Restart, which is an proprietary extension header, with the value ‘Yes’. In this case, the below message is transmitted from the terminal 103.

PLAY rtsp://192.168.0.3/AVData/0001.m2ts RTSP/1.0

### CSeq: 2

### Session: 54321

### X-Restart: Yes

The control unit 201 first retrieves for the resume position information of the multimedia data whose URI is sent in the PLAY message (in this case, the multimedia data 401) by referencing the URI table 421, from the resume position information stored in the storage unit 207. In this case, the relevant resume position information is the resume position information 701.

The control unit 201 reads out the fact that, from the resume position information 701 the starting point is the 50,120th byte from the beginning of the data, and sends an instruction to read out data starting from the 50,120th byte from the beginning of the multimedia data 401. The readout unit 204 receives an instruction to start reading out the data.

The control unit 201 subsequently creates the response message below, and instructs the second output unit 206 to transmit the response message to the terminal 103. Note that the 50,120th byte corresponds to the point where 8 minutes pass from the beginning of the multimedia data 401.

### RTSP/1.0 200 OK

### CSeq: 2

### Session: 54321

Range: smtpe=0:08:00-0:55:00
RTP-Info: url=rtsp://192.168.0.3/AVData/0001.m2ts; seq=123 073412; rtptime=52865

Subsequently, the control unit 201 determines the data transmission destination to be the terminal 103 since the PLAY message is sent from the terminal 103, and instructs the second output unit 206 to transmit the data read out by the readout unit 204 to the terminal 103. Additionally, the control unit 201 deletes the resume position information 701 from the storage unit, deletes the attribute “output paused” from the attribute information 411 and updates the attribute information 411.

Note that in the case of the present embodiment, an explicit designation from the terminal 103 of the output destination, which is the transmission destination terminal, is omitted since the control unit 201 judges that the terminal from which the RTSP message has been sent is a transmission destination terminal. In this case, the output destination can be obtained from the reception packet or the socket interface. Additionally, a structure may be utilized in which the transmission destination is designated by the method defined in UPnP AV or the PLAY message to which are added a proprietary extension, and so on.

Next, the terminal 102 and the terminal 103 are explained below.

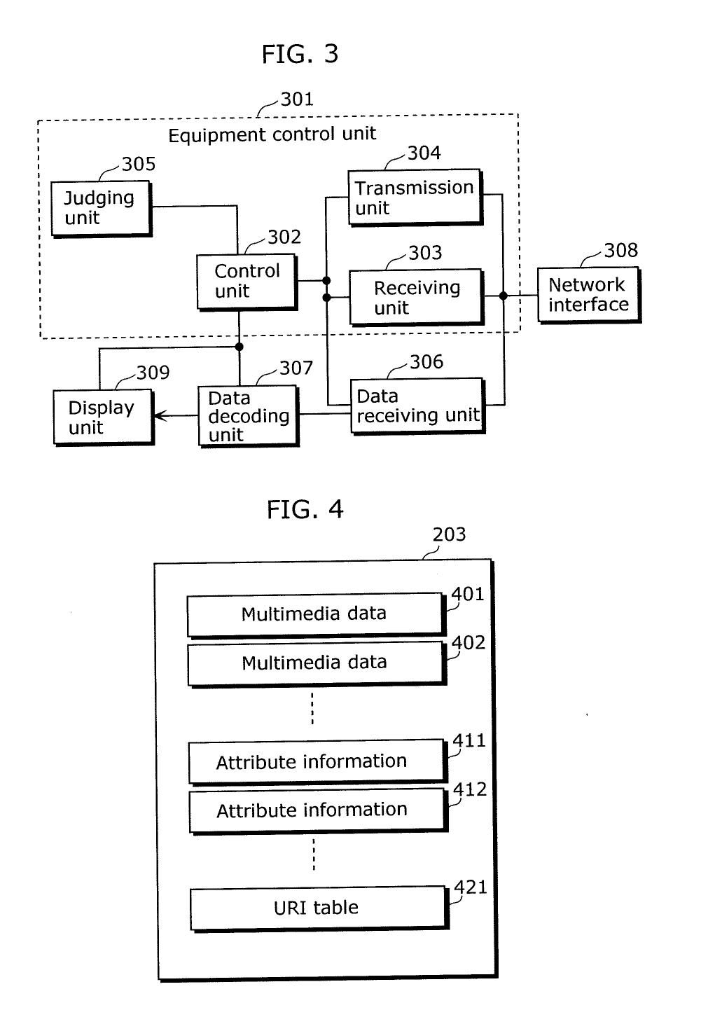

FIG. 3 is a block diagram which shows an exemplary structure of the terminal 102 and the terminal 103 in the first embodiment of the present invention.

The terminal 102 and the terminal 103 shown in FIG. 3 include an equipment control unit 301, a control unit 302, a receiving unit 303 which receives a message sent from the data output device 101, a transmission unit 304 which transmits a request message to the data output device 101, a judging unit 305 which judges whether or not the output is paused by interpreting the multimedia data attributes in the messages received by the receiving unit 303, a data receiving unit 306 which receives multimedia data transmitted from the data output device 101, a data decoding unit 307 which decodes the received multimedia data, a network interface 308 connected with the network 104 and a display unit 309 which displays the decoded multimedia data.

More specifically, the equipment control unit 301 includes a control unit 302, a receiving unit 303, a transmission unit 304 and a judging unit 305.

The control unit 302 is described below in more detail. The control unit 302 is composed of a microprocessor, a ROM, a RAM and so on. An OS, a Java VM program, a Java program library, and a Java application program which function in the microprocessor are saved in the ROM, the RAM and the information storage unit which is not illustrated.

The microprocessor reads and executes the OS at start-up. Subsequently, on the start-up of the Java application, the Java VM is read and executed and the Java application is executed, reading the Java program library if necessary. The control unit 302 receives the user's request from the user interface unit which is not illustrated, and controls the receiving unit 303, the transmission unit 304, the judging unit 305, the data receiving unit 306, the data decoding unit 307 and the display unit 309, and transmits and receives data itself and these units, according to the Java application.

The receiving unit 303 is connected to the network interface 308, receives information addressed to the terminal which has reached the network interface 308 and passes the information to the control unit 302. The receiving unit 303 is, typically, a socket interface provided by an OS or a Java library, or a program which uses a socket interface. Note that this structure is not limited to one composed by software, and may be composed using hardware.

The transmission unit 304 is connected to the network interface 308, functions by receiving an instruction from the control unit 302, and after converting data sent from the control unit 302 into a packet for an address instructed by the control unit 302, transmits the data through the network interface 308. The transmission unit 304 is, typically, a socket interface provided by an OS or a Java library, or a program which uses a socket interface. Note that this structure is not limited to one composed by software, and may be composed using hardware.

The judging unit 305 judges whether or not the “output is paused” for the multimedia data by interpreting the message received by the receiving unit 303 and retrieving the attributes of the multimedia data included. The result is returned to the control unit 302. The judging unit 305 is typically a subroutine included in a Java library or a Java application program. Note that this structure is not limited to one composed by software, and may be composed using hardware.

The data receiving unit 306 is connected with the network interface 308, and receives the multimedia data transmitted from the data output device 101 according to an instruction from the control unit 302, and passes the received multimedia data to the data decoding unit 307. The data receiving unit 306 is, typically, a socket interface provided by an OS or a Java library, or a program which uses a socket interface. Note that this structure is not limited to one composed by software, and may be composed using hardware.

The data decoding unit 307 decodes the transmitted multimedia data according to an instruction from the control unit 302. As described the above, the multimedia data is coded according to a coding argorithm typified by MPEG2. The data decoding unit 307 decodes the data and transmits the decoded data to the display unit 309. The data decoding unit 307 is typically composed of a hardware decoder and the corresponding driver software.

The network interface 308 has the same structure as the above network interface 209.

The display unit 309 is a device composed of a monitor and a speaker, or is a device which transmits video or audio signals to an external monitor or speaker.

Below, the processing on the terminal 102 and the terminal 103 is explained referring the following example in which data transmission is paused during data transmission to the terminal 102, and the paused data transmission to the terminal 103 is resumed as described above. Note that the terminal 102 and the terminal 103 already recognize that at least the data output device 101 is connected to the network 104, and that the data output device 101 is a server which provides multimedia content data. Since such discovery of a device on the network, and detection of the device's capability can be carried out using a method defined in the UPnP Device Architecture (DA), a detailed description shall be omitted.

First, functions in the process of the terminal 102 up until video reproduction is paused are explained.

The control unit 302 creates a content list transmission request message, and instructs the transmission unit 304 to transmit the message to the data output device 101 according to the request from the user. Further, the receiving unit 303 receives the content list message sent from the data output device 101 and presents information such as the content title to the user. The provision to the user may be performed using the display unit 309 or may be performed using another provision unit not illustrated.

Next, when receiving the reproduction request from the user in which one of the contents has been selected from the content list provided to the user, the control unit 302 creates a data transmission request message and instructs the transmission unit 304 to transmit the message to the data output device 101. An example of a data transmission request message is the PLAY message of RTSP described above. Accordingly, the receiving unit 303 receives a response message from the data output device 101. An example of a response message is the response to the PLAY message described above.

When the response message indicates transmitting the data, the control unit 302 instructs the data receiving unit 306 to receive the multimedia data transmitted from the data output device 101, instructs the data decoding unit 307 to decode the received multimedia data and further instructs the display unit 309 to display the decoded multimedia data.

Additionally, when the response message indicates that transmission of the data cannot be performed, the control unit 302 notifies the user of it.

Next, when receiving a reproduction pause request from the user, the control unit 302 creates a data transmission pause request message and instructs the transmission unit 304 to transmit the message to the data output device 101. An example of the data transmission pause request message is the PAUSE message of RTSP described above.

Subsequently, the control unit 302 instructs the receiving unit 303 to receive the response message from the data output device 101, and in order to stop the reception of multimedia data by the data receiving unit 306, the decoding of data by the data decoding unit 307 and the displaying of data by the display unit 309, instructs the respective units to stop.

Next, a function in the terminal 103 for resuming reproduction which has been paused in the terminal 102 is explained below.

First, the control unit 302 obtains the content list message from the data output device 101 using the same method as above according to the user's request.

Next, the control unit 302 presents the information such as the content title from the received content list message to the user in the same way as above. At this time, the control unit 302 instructs the judging unit 305 to judge the content for which data output is paused and presents the judgment information together. Presenting that data output is paused can be performed by for example using a method such as marking the content title, displaying the content title in another color or by creating another list of paused content and providing it.

Subsequently, when receiving the reproduction resume request from the user for content for which output is paused, the control unit 302 creates a data transmission resume request message and instructs the transmission unit 304 to transmit the message to the data output device 101. An example of a data transmission resume request message is the message in which the extension header X-Restart is added to a PLAY message described above.

Next, the receiving unit 303 receives a response message from the data output device 101. An example of a response message is the aforementioned response message to the PLAY message to which the X-Restart header is attached.

When the response message is indicates transmitting the data, the control unit 302 instructs the data receiving unit 306 to receive the multimedia data transmitted from the data output device 101, instructs the data decoding unit 307 to decode the received multimedia data and further instructs the display unit 309 to display the decoded multimedia data.

Additionally, when the response message indicates that transmission of the data cannot be performed, the control unit 302 notifies the user of it.

Note that in the present embodiment, since the terminal to which the RTSP command message has been transmitted is a data output destination for the data output device 101, a clear designation of the output destination from the terminal 103 which is a transmission destination terminal is omitted. However a structure may be used which designates a transmission destination by the method defined in UPnP AV or the to the PLAY message to which are added a proprietary extension.

As explained above, when the data output device 101 which is included in the multimedia delivery system 105 according to the embodiment receives the output pause request from the terminal while outputting data, stores the resume position information in the device obtained from the multimedia data and the output pause position, receives the output resume request and the output destination terminal from the terminal, reads out the stored resume position information and resumes data output.

Additionally, when the output of some multimedia data is judged to be paused in the data output device 101, then the terminal 102 and the terminal 103 according to the present embodiment include the equipment control unit 301 which resumes data output to the data output device 101 by transmitting a data output resume request and an output destination terminal. According to this structure for example, viewing of some multimedia content is paused in the terminal 102 and it is possible to resume viewing of the multimedia content in the terminal 103 from the pause point.

### Modification of the First Embodiment

Although the present invention is described based on the first embodiment, it should be obvious that the present invention is not limited to the above-mentioned embodiments. The present invention also includes such cases as described below.

(1) The data output device 101 may have a structure in which an identifier for identifying the pause point is issued when the data output is paused, the identifier is stored in the storage unit 207 with the resume position information, the content list is transmitted as a content list which includes the identifier, and when a data output resume request is received together with the identifier, data output is resumed. An example of the data stored in the storage unit 207 in this case is shown in FIG. 8.

FIG. 8 is a diagram which shows an example of resume position information in the first modification of the first embodiment in the present invention. As shown in FIG. 8, an example is shown in which resume position information 801, resume position information 802 and resume position information 803 are stored in the storage unit 207. For example, the resume position information 801 is related to the pause point of an identifier ID1 and shows that the multimedia data for the file name 0001.m2ts resumes from the 50,120th byte.

Additionally, the equipment control unit 301 in the terminal 102 and the terminal 103 may have a structure in which when the identifier above is acquired, a data output resume request and the identifier above are transmitted.

Additionally the identifier above may be used as an attribute value for the paused output. In other words, the content of the PAUSE element in FIG. 5 is set to the identifier, and it may be judged that only when the PAUSE element is included and it is not empty, the data output device is in a paused state, and when there is no PAUSE element, or there is a PAUSE element but it is an empty element with no content, the data output device is not in an output paused state.

Additionally, the above identifier may be used as an attribute value which expresses paused output in the content list outputted by the data output device 101.

Additionally, the data output device 101 may have a structure which does not insert the identifier above to the content list but replies to the terminal with the identifier above in a response to the data output pause request. In this case, only the user who knows the identifier can resume output, thereby realizing the effect of improving security and so on.

Additionally, the identifier above may be provided to the data output device 101 from the terminal. Further, the data output device 101 may have a structure which does not include the identifier above in the content list. In the same way in this case, only the user who knows the identifier can resume output, thereby realizing the effect of improving security and so on.

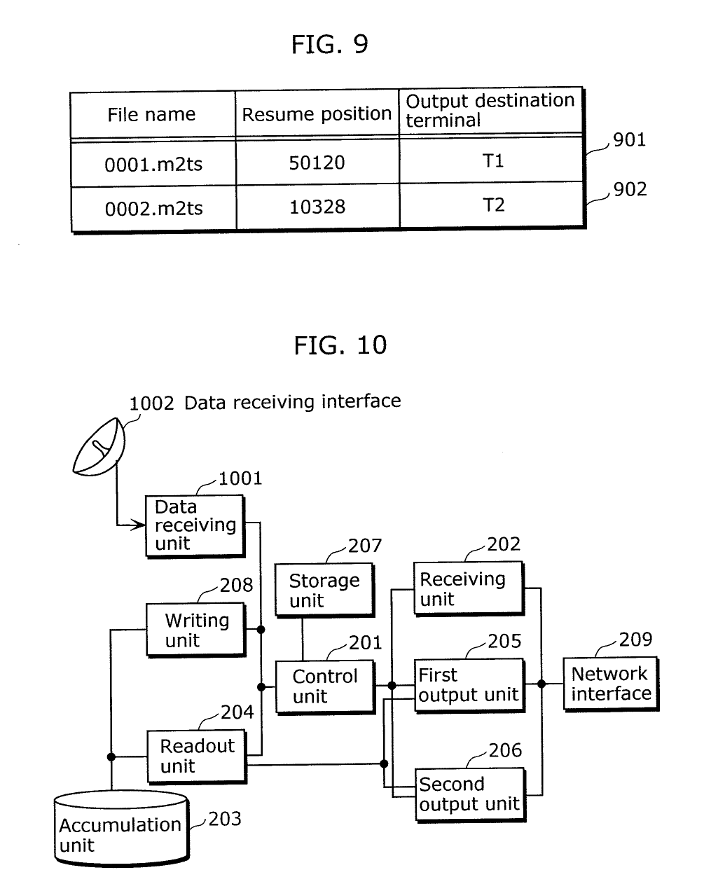

(2) The terminal 102 and the terminal 103 may be structured such that when transmitting a request for pausing data output, an output destination when data output is resumed may also be transmitted, and the data output device 101 may save the resume position information and the output destination in the storage unit 207 and when the data output resume request for the data is accepted, the data may be outputted to the output destination. For an example of the data output pause request of this case, the extension header X-Reopen-Terminal is added to the PAUSE command message in the above embodiment and a specific terminal is recorded as the value. The IP address of the terminal, the host name of each terminal or the nickname given to each terminal may serve as the output destination. The information can be obtained via the method defined in UPnP DA. An example of the data stored in the storage unit 207 in this case is shown in FIG. 9.

FIG. 9 is a diagram which shows an example of resume position information in the second modification of the first embodiment. As shown in FIG. 9, resume position information 901 and resume position information 902 are stored in the storage unit 207. For example, the resume position information 901 shows that output of the multimedia data with the file name 0001.m2ts is resumed from the 50,120th byte and the output destination is the terminal T1.

Additionally, when the data output device 101 receives a data output pause request along with an output destination, the data output may be resumed only via a request from the terminal which is the output destination.

Additionally, if the data output device 101 receives a data output pause request along with an output destination, the data output may be resumed only when a data output resume request and an output destination are received, and match when compared to the stored output destination.

Further, when the data output device 101 receives a data output pause request along with an output destination, not only the specific destination may be selected as the output destination but also a part or all the candidate destinations may be selected.

In this case, for example, when the data output device 101 receives the data output pause request along with a specific output destination as an output destination, the data output is resumed only by requesting so from the terminal which is the output destination. Additionally, when the data output device 101 receives the data output pause request along with a part or all of candidate output destinations which is an output destination when output is resumed, data output is resumed only by requesting so from the terminal which is one of the output destinations received as the output destination when output is resumed.

(3) The data output device 101 further includes a data receiving unit which receives data from the outside, and may transmit data accumulated in the accumulation unit 203 and data received by the receiving unit. FIG. 10 shows a typical structural diagram for this situation.

FIG. 10 is a block diagram which shows an example of the structure of the data output device according to the third modification of the first embodiment in the present invention.

The data output device shown in FIG. 10 includes a data receiving unit 1001, a receiving interface 1002, the control unit 201, the receiving unit 202, the accumulation unit 203, the readout unit 204, the first output unit 205, the second output unit 206, the storage unit 207, the writing unit 208 and the network interface 209.

The data receiving unit 1001 extracts multimedia data from the signal received from the receiving interface 1002 and is typically a digital broadcast tuner and the like. In this case, the receiving interface 1002 is an antenna.

Additionally, in FIG. 10, the control unit 201, the receiving unit 202, the accumulation unit 203, the readout unit 204, the first output unit 205, the second output unit 206, the storage unit 207, the writing unit 208 and the network interface 209 are the same as the units in FIG. 2, however the control unit 201 further controls the data receiving unit 1001, and the first output unit 205 and the second output unit 206 can output multimedia data which is output of the data receiving unit 1001. The writing unit 208 can write multimedia data received by the data receiving unit 1001 into the accumulation unit 203.

While outputting the multimedia data from the data receiving unit 1001 and when a data output pause request is received, the control unit 201 stops output from the first output unit 205 or the second output 206 and instruct the writing unit 208 to write the succeeding portion of the multimedia data sequentially, which is output from the data receiving unit 1001, into the accumulation unit 203.

Further, the control unit 201 creates the attribute information for the multimedia data and makes it written, and creates a URI for the multimedia data and updates the URI table 421. Additionally, the control unit 201 creates the resume position information using a file name for writing the multimedia data and the resume position from the beginning of the file, and stores the resume position information in the storage unit 207.

Therefore, when a request to resume output of the multimedia data is received, the control unit 201 can resume data output using the same method explained in the above embodiment.

Note that above, when a request for pausing the data output is received, a succeeding portion of the data is written into the accumulation unit 203, data may be written from the beginning of the multimedia data beforehand into the accumulation unit 203 without waiting for a request to pause the data output. In this case, the output resume position information can be created with the same method as the embodiment above.

Additionally, the data output device 101 always inserts data of a fixed amount of time or a fixed capacity in the multimedia data which is outputted by the data receiving unit 1001 into an unillustrated buffer region, and may write a data with the data saved in the buffer region when a request to pause output is received. Additionally, the data output resume position may be calculated including the data in the buffer region or not including the data in the buffer region.

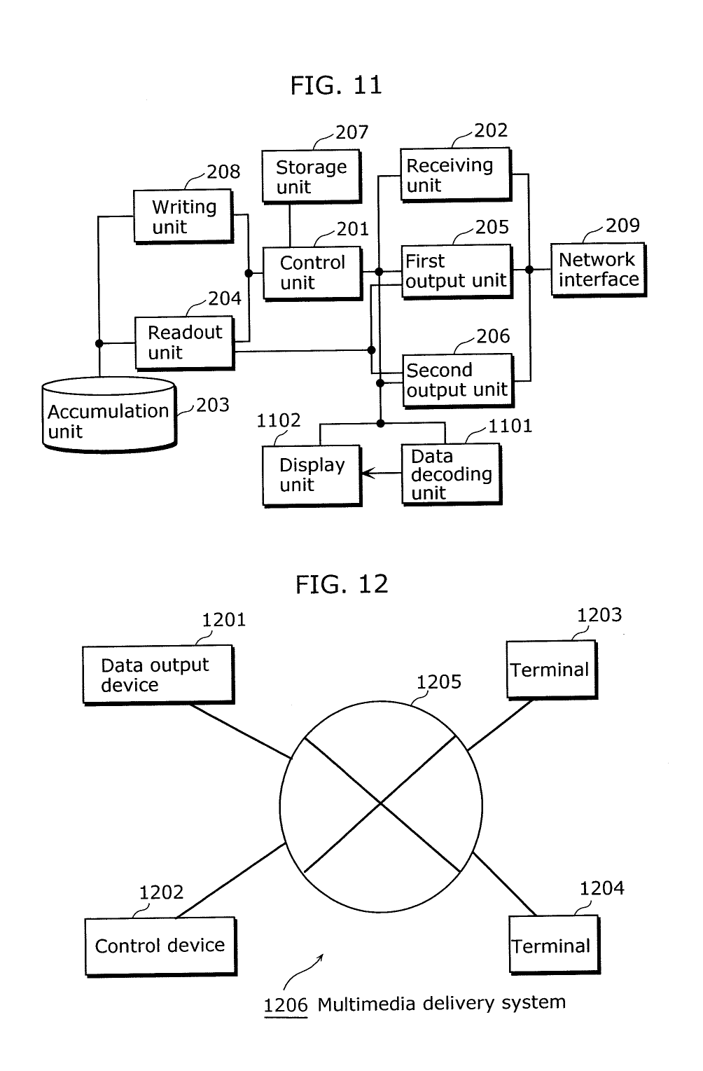

(4) The data output device 101 may further include a data decoding unit which decodes the multimedia data and a display unit which displays the decoded multimedia data. FIG. 11 shows a typical structural diagram for this situation.

FIG. 11 is a block diagram which shows a structure of the data output device in the fourth modification of the first embodiment of the present invention. The data output device shown in FIG. 11 includes the control unit 201, the receiving unit 202, the accumulation unit 203, the readout unit 204, the first output unit 205, the second output unit 206, the storage unit 207, the writing unit 208, the network interface 209, the data decoding unit 1101 and the display unit 1102.

The control unit 201, the receiving unit 202, the accumulation unit 203, the readout unit 204, the first output unit 205, the second output unit 206, the storage unit 207, the writing unit 208 and the network interface 209 are the same as the units shown in FIG. 2. However, it is different from the units shown in FIG. 2 only that the control unit 201 further controls the data decoding unit 1101 and the display unit 1102. The data decoding unit 1101 is the same as the data decoding unit 307 in the terminal 102 and the terminal 103, and the display unit 1102 is the same as the display unit 309.

Additionally, the first output unit 205 is connected to the data decoding unit 1101 in FIG. 11. In this structure, it becomes possible that the data output from the first output unit 205 which is data output to the data decoding unit 1101 is paused and the data is output as data output from another output unit, the second output unit 206, and that the data output to the second output unit 206 is paused and the output is resumed as the data rom the first output unit 205 to the data decoding unit 1101.

Note that although described in the above embodiment, the receiving unit 202 may also have reception via infrared communication and so on, and the control unit 201 may function by controlling each unit according to a request transmitted from outside of the network 104. In this case, for example, the content list, the response message and so on are not outputted from the first output unit 205, but are converted into an appropriate message and presented to the user, for example, by display the message in the display unit 1102.

(5) In the above embodiment, the data output device 101 stores the resume position information, however a third device on the network may store the data. FIG. 12 shows a structural diagram of the multimedia delivery system for this case.

FIG. 12 is a diagram which shows an exemplary structure of the multimedia delivery system in the fifth modification of the first embodiment in the present invention.

A multimedia delivery system 1206 shown in FIG. 12 includes a data output device 1201, a control device 1202 which controls the data output device and terminal through the network, a first terminal 1203, a second terminal 1204 and a network 1205. The data output device 1201, the control device 1202, the terminal 1203 and the terminal 1204 are connected to the network 1205 and can communicate mutually through the network 1205.

The data output device 1201 receives a request from the control device 1202, the terminal 1203 and the terminal 1204 transmitted through the network 1205. Subsequently, the data output device 1201 transmits information and attributes for each content accumulated when necessary to the control device 1202 through the network 1205 and transmits the multimedia data in the content accumulated when necessary to the terminal 1203 and the terminal 1204 through the network 1205. Additionally, transmitting the multimedia data from an arbitrary position according to the request can be performed.

When the data output device 1201 receives the pause request for the data output being executed from the control device 1202 or the transmission destination terminal, the data output device 1202 transmits the data position at which output is to be resumed, which is the position like the next position of the last transmitted data, as well as the file name or the URI of the multimedia data through the network 1205 to the control device 1202.

Note that as described below, in this case the file name or URI of the multimedia data does not have to be transmitted.

The control device 1202 functions according to a user's request.

The data output device 1202 controls the terminal 1203 and the terminal 1204 through the network 1205 in order to make them receive the multimedia data from the data output device 1201 and reproduce the multimedia data. Such control can be performed by the methods defined in UPnP AV and thus the details are not provided.

Additionally, the control device 1202 receives information and attributes such as the title of the content and so on by requesting the information and attributes from the data output device 1201, and presents the information and attributes to the user using the display unit of the terminal 1203, the terminal 1204, or the control device 1202. Additionally, when the control device 1202 receives the request for pausing the reproduction of the content from the user, the control device 1202 controls the terminal 1203 or the terminal 1204 which are executing reproduction to transmit the data transmission pause request to the data output device 1201 and to pause the reproduction.

Further, the control device 1202 receives information which can specify the data such as the data position at which output is resumed and the file name or URI of the multimedia data by communicating with the data output device 1201 and stores the data as the resume position information.

The resume position information can use the same as one of the first embodiment and the modifications.

Note that since the URI of the multimedia data is used when the control device 1202 issues a reproduction request, the URI is already known when reproduction is paused. Therefore, the URI is not necessarily received from the data output device when reproduction is paused.

When the reproduction resume request and the terminal for reproduction are designated by the user, the control unit 1202 further reads out the resume position information, and instructs the terminal to reproduce the data which starts from the resume position and which is received from the data output device 1201.

The terminal 1203 and the terminal 1204 receive the designated range of the designated multimedia data from the designated server, and reproduce and display the data according to a request transmitted through the network 1205 from the control device 1202.

The network 1205 is the same as the network 104 in the above first embodiment.

According to the explanation above, in the multimedia delivery system 1206 with the present structure, since the control device 1202 manages the resume position information, it becomes possible that, for example, the reproduction of multimedia content performed by the terminal 1203 is paused and is resumed by the terminal 1204.

Note that here the control device 1202 receives at least the data position for resuming the output from the data output device 1201 and creates resume position information, however, the data output device 1201 may create resume position information, and the control device 1202 may receive and save the resume position information.

Additionally, here the control device 1202 receives at least the data position for resuming the output from the data output device 1201 and creates resume position information, however, the control device 1202 may create the resume position information by receiving at least the data position at which data has last been reproduced and so on from the terminal 1203 or the terminal 1204 which execute reproduction

Additionally, here the control device 1202 issues a request to the terminal 1203 or the terminal 1204 and transmits a data transmission request from the terminal to the data output device 1201, however, it may be possible that the control device 1202 issues the request of transmitting the data to the terminal 1203 or the terminal 1204 to the data output device 1201 and further issues the request of receiving the data from the data output device 1201 to the terminal. This kind of data transfer control can be performed by File Transfer Protocol (FTP).

Additionally, the control device 1202 which is stand alone on the network saves the resume position information, however, it may be possible that an arbitrary equipment which has a storage unit on the network saves the resume position information, and one of the data output device, the equipment control device or the terminal acquires and interprets the resume position information.

(6) In the above first embodiment, RTP/RTSP is used as a data transfer protocol, however, data transfer may be performed using other protocol such as Hypertext Transport Protocol (HTTP). When HTTP is used, the request to pause data output may be performed by closing an HTTP-GET session short, and may be performed in a separate communication session. Additionally, when using HTTP, the request to resume data output may be performed using a proprietary extension header in HTTP-GET such as the X-Restart above.

(7) In the first embodiment above, the next data position after the last transmitted data is used as the transmission resume position, however a position before a specified amount of data from the last transmitted data position may also be used.

Additionally, the resume position information may be created by referencing content in the data such as scene switching in the content. For example, a specific example is raised in which the switching position for a scene containing content just before the position where the content is paused is used as the resume position information.

Further, when the multimedia data is MPEG2 coded data, the resume position may be the beginning of the unit of transmitted data which is indispensable for decoding such as I frame, PAT of the MPEG2-TS, and so on. Additionally the same manner can be applied when the multimedia data is other coded data.

(8) It is possible that a part or all of the constituent elements making up each of the above-mentioned devices is made from one system Large Scale Integration circuit (LSI). The system LSI is a super multi-function LSI that is manufactured by integrating plural elements on one chip, and is specifically a computer system which is configured by including a microprocessor, a ROM, a RAM, and so on. A computer program is stored in the RAM. The system LSI accomplishes its functions through the operation of the microprocessor in accordance with the computer program.

(9) It is possible that a part or all of the constituent elements making up each of the above-mentioned devices is made from an IC card that can be attached to/detached from each device, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(10) The data output device and the equipment control device in the present invention may also operate in the aforementioned methods. The present invention may also be a computer program for causing a computer to execute such methods or as a digital signal made from the computer program.

Furthermore, the data output device and the equipment control device in the present invention may be a computer-readable recording medium, such as a flexible disk, a hard disk, a CD-ROM, an MO, a DVD, a DVD-ROM, a DVD-RAM, a BD (Blu-ray Disc), or a semiconductor memory, on which the computer program or the digital signal is stored. Additionally, the data output device and the equipment control device in the present invention may be the computer program or the digital signal recorded on the recording mediums.

Furthermore, the data output device and the equipment control device in the present invention may also transmit the computer program or the digital signal via an electrical communication line, a wireless or wired communication line, a network represented by the Internet, a data broadcast, and so on.

Furthermore, it is also possible that the present invention is a computer system including a microprocessor and a memory, with the above computer program being stored in the memory and the microprocessor operating in accordance with the computer program.

Furthermore, the present invention may also be implemented in another independent computer system by recording the program or the digital signal on the recording medium and transferring the recording medium, or by transferring the program or the digital signal via the network, and the like.

(11) It is also possible to combine the above-described embodiments and the above variations.

### Second Embodiment

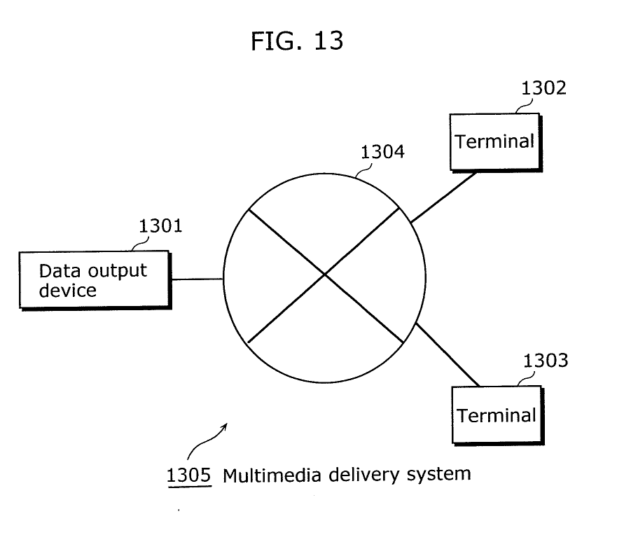

FIG. 13 is a diagram which shows an example of the structure of the multimedia delivery system in the second embodiment of the present invention.

A multimedia delivery system 1305 shown in FIG. 13 includes a data output device 1301, a first terminal 1302, a second terminal 1303 and a network 1304. The data output device 1301, the terminal 1302 and the terminal 1303 are connected to the network 1304, and can communicate mutually through the network 1304.

The data output device 1301 in the present embodiment is the CATV Set Top Box (STB) with a network interface and an accumulation unit which accumulates multimedia data which receives a digital broadcast.

The data output device 1301 accumulates the multimedia data of the received digital broadcast content in the accumulation unit. Furthermore, the data output device 1301 is connected to the network 1304 via the network interface. In addition, it receives requests transmitted from the terminal 1302 and the terminal 1303 via the network 1304. Subsequently, the data output device 1301 transmits the information, attributes or the multimedia data of each received contents of digital broadcast or accumulated contents to the terminal 1302 and the terminal 1303 via the network 1304 according to the request.

When a pause request is received from the transmission destination terminal for data output in the content accumulated during execution, the data output device 1301 combines the data position for resuming the output, which is a next position after the last transmitted data position, with the file name or a Uniform Resource Identifier (URI) for the data, as resume position information which the data output device 1301 stores inside the device, and the data output device 1301 puts the attribute ‘output paused’ to the data.

Additionally, when the pause request is received from the transmission destination terminal for the data output in the digital broadcast content received during execution, succeeding potion of the data is accumulated in the accumulation unit.

Further, attributes and a URI for the multimedia data are created. The information for the attribute ‘output paused’ is included. Subsequently, the file name or the URI, and the top position in the accumulated file are stored inside the device as resume position information.

Further, when a data transmission resume request is received from the terminal, the data output device 1301 resumes the data transmission to the designated terminal from the beginning of the untransmitted data by referring the stored resume position information.

The terminal 1302 and the terminal 1303 transmit a transmission request for multimedia data or content attributes through the network 1304 to the data output device 1301 according to a user request. Subsequently, when the terminal 1302 and the terminal 1303 receive the content attributes, they present the content attributes to the user when necessary, and when they receives the multimedia data, they reproduce the data and display the decoded data. The terminal 1302 and the terminal 1303 can judge whether or not the content is “paused output” from the content attributes, and issue a request to resume data transmission according to a user's request.

The network 1304 is a home network established in the household, and is an IP network configured of Ethernet, a wireless LAN, and so on.

Below, communication between the data output device 1301, the terminal 1302 and the terminal 1303 and their respective functions are described.

Communication of control information of multimedia data transmission is performed using RTSP. First, an example is described which is the process from the transmitting of the multimedia data to pausing of the data transmission between the data output device 1301 and the terminal 1302. Subsequently, an example is described which is the process of the paused transmission for which transmission to the terminal 1302, is resumed in communication between the data output device 1301 and the terminal 1303.

First, communication and the respective functions in the process until pausing the data transmission to the terminal 1302 are explained below.

The data output device 1301 and the terminal 1302 search for a device connected to the network 1304 and obtain what functions each terminal has. Since such communication is carried out according to a method defined by the UPnP Device Architecture (DA), detailed description shall be omitted.

Thus, the data output device 1301 can identify that the terminal 1302 is the player which is connected to the network 1304 and which receives and reproduces the multimedia data through the network 1304. And, the terminal 1302 can identify that the data output device 1301 is the multimedia server which is connected to the network 1304.

First, the terminal 1302 issues a request to obtain a content list accumulated in the data output device 1301 or EPG. In response to it, the data output device 1301 creates the content list of the accumulated data or convert the received EPG data to the format for communication and transmits the content list or the converted EPG data to the terminal 1302.

The content list includes, for each content, at least a content title and a URI for accessing the content. Additionally, when the output of the multimedia data is paused, such attribute is also included. Additionally, attribute information is read out for each multimedia data and the content is attached and transmitted when necessary.

Additionally, the EPG data includes at least the title for each program and a URI for accessing each program or the channel on which the program is broadcasted. Since as the protocols for the request to acquire the content list or the EPG and its response, and the data format of the content list or the EPG the method defined in UPnP AV can be used, a detailed explanation is not provided. However, a proprietary extended format is used for he output paused attribute of the multimedia data.

Since the format of the content list is defined in XML, the format can be extended without contradictions by using an XML Namespace. For example, the PAUSE element which belongs to an proprietary name space Na is added to each piece of information of the content, and when the content of the PAUSE element is ‘Yes’, this can be used to express “output paused”.

Next, the terminal 1302 presents the information such as the content title from the received content list or the EPG data to the user. Further, when the request to reproduce the selected one content from the content list or from the EPG data is accepted from the user the terminal 1302 issues a transmission request for the multimedia data. For example, when a request is issued to transmit the content data whose URI is rtsp://192.168.0.3/AVData/0001.m2ts, starting from the beginning of the multimedia data, the PLAY message below is transmitted from the terminal 1302 to the data output device 1301 following the SETUP message of RTSP.

PLAY rtsp://192.168.0.3/AVData/0001.m2ts RTSP/1.0

### CSeq: 2

### Session: 12345

Range: smtpe=0:00:00

The data output device 1301 which has received the PLAY message above reads out the multimedia data from the accumulation unit when the multimedia data indicated by the URI is the content accumulated in the accumulation unit. Or, when the URI indicates a channel, the data output device 1301 performs tuning in the channel on the tuner. Subsequently, the data output device 1301 creates the response message below and transmits it to the terminal 1302.

RTSP/1.0 200 OK

### CSeq: 2

### Session: 12345

Range: smtpe=0:00:00-0:55:00
RTP-Info: url=rtsp://192.168.0.3/AVData/0001.m2ts; seq=12312 3532; rtptime=53265

Subsequently, the data output device 1301 sequentially transmits the multimedia data which has been read out from the accumulation unit or obtained from the tuner which is tuned in to the terminal 1302. Since data transmission is performed using a method defined in RTP, a detailed explanation is not provided.

Next, the terminal 1302 issues a data transmission pause request to the data output device 1301 when a reproduction pause request is received in an instruction from the user. Pausing the data transmission can be performed by using the PAUSE command. The message below is transmitted from the terminal 1302 to the data output device 1301.

PAUSE rtsp://192.168.0.3/AVData/0001.m2ts

### RTSP/1.0

### CSeq: 3

### Session: 12345

When the data output device 1301 receives the above PAUSE command, the data output device 1301 stops the data transmission, creates the response message below, and transmits the response message to the terminal 1302.

RTSP/1.0 200 OK

### CSeq: 3

### Session: 12345

Additionally, when the transmitted content is accumulated in the accumulation unit, the data output device 1301 adds the ‘output paused’ attribute to the content attribute information. Furthermore, the data output device 1301 finds a transmission resume position which is the starting point when the data transfer is resumed from the amount of transmitted data. Thus, for example, when 50,119 bytes of data are transmitted, the beginning of the data is the 50,120th byte.

The data output device 1301 creates the resume position information by combining this transmission resume position with something to identify the multimedia data, for example the identifier of the content, and store the resume position information.

Note that in the present embodiment, a transmission resume position is found based on the amount of transmitted data, however, the transmission resume position may be found, for example, based on the amount of data read out from the accumulation unit.

Additionally, when the transmitted content is multimedia data obtained from the tuner, the data output device 1301 writes the succeeding portion of the multimedia data into the accumulation unit. Further, the data output device 1301 creates the attribute information for the multimedia data and writes the information into the accumulation unit. In addition, the data output device 1301 creates a URI for the multimedia data and makes it possible for the multimedia data to be accessed from the terminal. Additionally, the data output device 1301 issues an identifier for the multimedia data, and makes the resume position information from the identifier and the resume position which is the beginning of the file, and stores the resume position information.

The terminal 1302 transmits the TEARDOWN command message which closes the session when a request to finish is accepted from the user; the data output device 1301 accepts the TEARDOWN message, transmits the response message and finishes communication. In the present embodiment, even when the process for TEARDOWN is performed, the above resume position information and the attribute information are not updated.

Note that in order to express more clearly the pause which is to be resumed later, a structure may be utilized in which PAUSE or TEARDOWN are extended, and it is requested that the resume position information be created or held and that the attribute information be updated or held. For example, considering the case where using the X-Keep-Pause-Status which is a proprietary extension header, and only when the value of its header is ‘Yes’ the resume position information is created or held and the attribute information is updated or held. In this case, the PAUSE message sent from the aforementioned terminal 1302 to the data output device 1301 is as follows.

PAUSE rtsp://192.168.0.3/AVData/0001.m2ts RTSP/1.0

### CSeq: 3

### Session: 12345

### X-Keep-Pause-Status: Yes

In this case, since the data output device 1301 find that an X-Keep-Pause-Statis header is in the received message and that its value is ‘Yes’, the data output device 1301 creates the resume position information and hold it, and updates the attribute information and hold it. In the cases where there is no X-Keep-Pause-Status header, or where there is an X-Keep-Pause-Status but with a value other than ‘Yes’, the data output device 1301 does not create the resume position information, and does not update the attribute information.

Next, communication of the process for resuming the paused data transmission process with the terminal 1303 and the processes of the data output device 1301 and the terminal 1303 are explained.

First, searching for a device connected to the network of the data output device 1301 and the terminal 1303, and obtaining a content list or an EPG of the terminal 1303 are performed in the same way as described above and thus an explanation is not provided.

The terminal 1303 presents the content list or the EPG received from the data output device 1301 to the user. When the content list is presented, the terminal 1303 judges whether or not output of the content is paused and also presents such information to the user. Presenting that data output is paused can be performed by for example using a method such as marking the content title, displaying the content title in another color or by creating and displaying another guide to paused content.

When the terminal 1303 receives the resume request for reproducing content for which ‘data output is paused’ from the user, the terminal 1303 issues a resume request for the paused data transmission to the data output device 1301. The request is made by using the proprietary extension header X-Restart in a PLAY message of RTSP, which has the value ‘Yes’. In this case, the below message from the terminal 1303 is transmitted to the data output device 1301.

PLAY rtsp://192.168.0.3/AVData/0001.m2ts RTSP/1.0

### CSeq: 2

### Session: 54321

### X-Restart: Yes

In the data output device 1301, at first, the resume position information of the multimedia data indicated by the URI sent in the PLAY message is retrieved from the stored resume position information. The data output device reads out the data position for resuming transmission from the resume position information and reads out the multimedia data from the accumulation unit.

The data output device 1301 next creates the response message below, and transmits the response message to the terminal 1303. Note that the resume position is the 8 minute past from the beginning of the multimedia data.

### RTSP/1.0 200 OK

### CSeq: 2

### Session: 54321

Range: smtpe=0:08:00-0:55:00
RTP-Info:url=rtsp://192.168.0.3/AVData/0001.m2ts;
seq=123073412; rtptime=52865

Subsequently, the data output device 1301 judges the data transmission destination to be the terminal 1303 since the PLAY message is sent from the terminal 1303, and transmits the read out data to the terminal 1303. Additionally, the data output device 1301 deletes the resume position information from the device, deletes the attribute “output paused” from the multimedia data attribute information and updates the attribute information.

Note that for the present embodiment, since the data output device 1301 judges the terminal from which the RTSP message is sent to be a transmission destination terminal, the terminal 1303 does not provide a explicit designation of the output destination being the transmission destination terminal. In this case, the output destination can be obtained from the reception packet or from the socket interface. Or, a structure may be utilized in which the transmission destination is designated by adding an proprietary extension to a method defined in UPnP AV or the PLAY message, and so on.

It follows from the above that, in the data output device 1301, the terminal 1302, the terminal 1303 and the multimedia delivery system 1305 in the present invention, for example, even when the transmission of data which was being received by the terminal 1302 is paused, the data transmission can be accurately resumed in another terminal 1303.

Hereinafter, the data output device 1301, the terminal 1302 and the terminal 1303 which make up the multimedia delivery system 1305 in the present invention are further described in detail. Here, an example is explained in which data transmission to the terminal 1302 is paused during data communication and the paused data transmission to the terminal 1303 is resumed, however other cases are the same.

Additionally, the RTSP server waits for a particular port number. The port number may use number 554 which is assigned by the Internet Assigned Numbers Authority (IANA), or the user may set the port number in the data output device 1301, the terminal 1302 and the terminal 1303. Additionally, an argument which determines the port number may be added to the method described below.

First, the data output device 1301 shall be described.

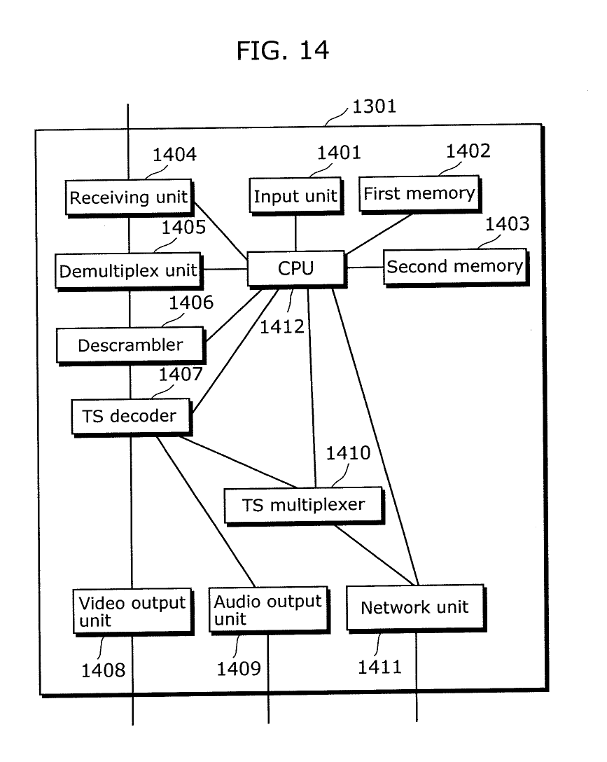

FIG. 14 is a block diagram showing an example of the structure of the data output device 1301 in the second embodiment of the present invention.

The data output device 1301 shown in FIG. 14 includes an input unit 1401, a first memory 1402, a second memory 1403, a receiving unit 1404, a demultiplex unit 1405, a descrambler 1406, a TS decoder 1407, a video output unit 1408, an audio output unit 1409, a TS multiplexer 1410, a network unit 1411 and a CPU 1412.

The input unit 201 is configured of a front panel, remote control signal receiver, and the like, and accepts an instruction such as channel selection from the user.

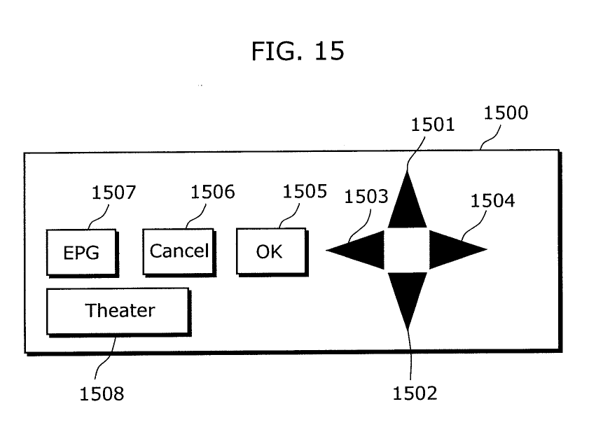

FIG. 15 is a diagram showing an example of an external view in the case where the input unit 1401 according to the second embodiment is configured of a front panel.

A front panel 1500 shown in FIG. 15 includes eight buttons, namely, an up-cursor button 1501, a down-cursor button 1502, a left-cursor button 1503, a right-cursor button 1504, an OK button 1505, a cancel button 1506, an EPG button 1507 and a theater button 1508. When the user presses down a button, the identifier of the pressed button is notified to the CPU 1412.

The first memory 1402 is configured of a RAM, or the like, and is used when the CPU 142 temporarily saves data.

The second memory 1403 is configured of a device that can hold information even when the power is turned off, such as a flash memory or a hard disk, or the like, and stores a program executed by the CPU 1412. For the second memory, a removable storage device such as an SD memory card and the like may also be used.

The receiving unit 1404 is connected to cable from a CATV station, and receives broadcast waves. The receiving unit 1404 tunes to the frequency specified by the CPU 1412, extracts an MPEG transport stream and passes this to the demultiplex unit 1405.

The demultiplex unit 1405 receives the MPEG transport stream from the receiving unit 1404, extracts information specified by the CPU 1412 and passes the information to the CPU 1412. In addition, the demultiplex unit 1405 passes the MPEG transport stream, as is, to the descrambler 1406.

The descrambler 1406 descrambles (decrypts) the scrambled MPEG transport stream provided from the demultiplex unit 1405, and passes the data to the TS decoder 1407. The descrambler 1406 may be a module built-into the data output device 1301, and may also be implemented through the CableCard™ introduced in North American cable receivers. The specification of the CableCARD is described in the CableCARD Interface Specification laid out by the CableLabs in United States, and thus the description is omitted herein.

The TS decoder 1407 receives identifiers of audio data, video data and section data such as PSI/SI information and so on from the CPU 1412. Further, the TS decoder 1407 extracts, from the descrambled stream received from the descrambler 1406, data corresponding to the received identifiers of audio data, video data and section data such as PSI/SI information and so on, and passes the extracted video data to the video output unit 1408, and the audio data to the audio output unit 1409. Furthermore, the TS decoder 1407 passes both the extracted video data and the audio data, and the section data to the TS multiplexer 1410.

The video output unit 1408, which includes a video output terminal, converts the received video data to video data that complies with the terminal and outputs the video data. An example of the terminal is a composite cable terminal, and so on.

The audio output unit 1409, which includes an audio output terminal, converts the received audio data to audio data that complies with the terminal and outputs the audio data. Examples of the terminal are earphone terminals, a composite cable terminal, and so on.

The TS multiplexer 1410 configures an MPEG2 transport stream from the received video data, audio data, and section data, and passes the MPEG2 transport stream to the network unit 1411. The PSI/SI information may be rewritten as necessary.

The network unit 1411, which includes a network interface, converts the data received from the CPU 1412 into a signal that corresponds to the physical media of the network to which the network interface is connected, and outputs the signal. Furthermore, the network unit 1411 receives a signal from the network interface, converts the signal into packets defined in the IP network, and passes the packets to the CPU 1412.

The CPU 1412 controls the receiving unit 1404, the demultiplex unit 1405, the descrambler 1406, the TS decoder 1407, the TS multiplexer 1410, and the network unit 1411 by executing the program stored in the second memory 1403.

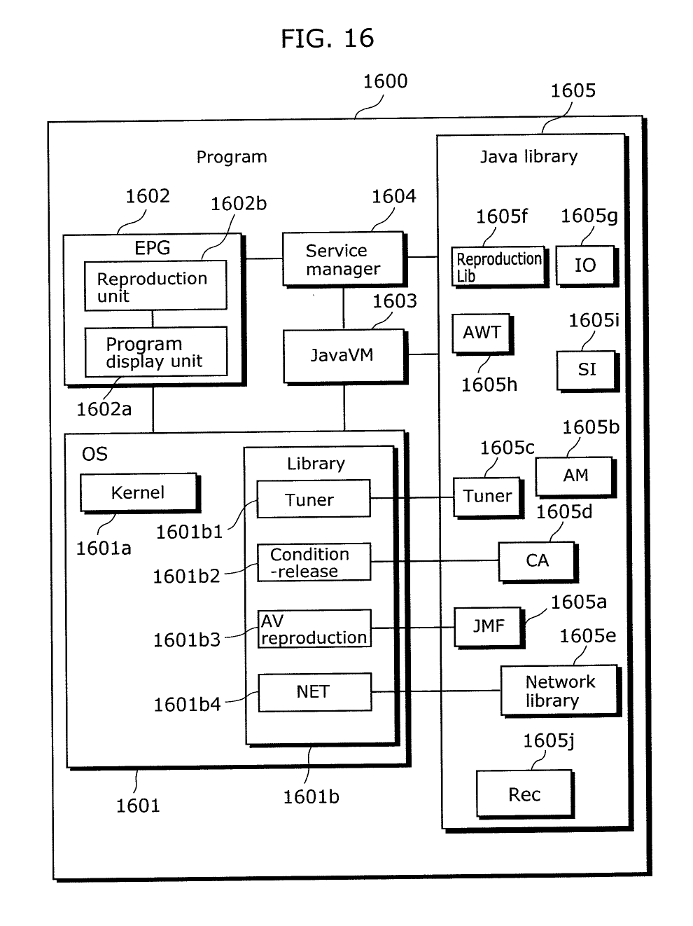

FIG. 16 is a diagram showing an exemplary structure of the program held and executed by the data output device 1301 in the second embodiment of the present invention. In other words FIG. 16 shows an example of a structure of the program stored in the second memory 1403 of the data output device 1301 and executed by the CPU 1412.

The program 1600 is formed by plural subprograms, more specifically, an OS 1601, an EPG 1602, a Java VM 1603, a service manager 1604 and a Java library 1605.

The OS 1601 is a subprogram activated by the CPU 1412 when power to the data output device 1301 is turned on. OS is the acronym of operating system, an example of which is Linux (registered trademark) and the like.

The OS 1601 is a generic name for publicly known technology made up of a kernel 1601a for executing a subprogram concurrently with another subprogram and of a library 1601b, and therefore detailed description is omitted.

In the present embodiment, the kernel 1601a of the OS 1601 executes the EPG 1602 and the Java VM 1603 as subprograms. Furthermore, the library 1601b provides these subprograms with plural functions required for controlling each unit included in the data output device 1301.

The library 1601b in the present embodiment includes for example a tuner 1601b1, a condition-release 1601b2, an AV reproduction 1601b3 and a NET 1601b4 as functions.

The tuner 1601b1 receives tuning information including a frequency from other subprograms and the Tuner 1605c of the Java library 1605, and passes the tuning information to the receiving unit 1404.

The receiving unit 1404 can perform demodulation based on the provided tuning information, and pass the demodulated data to the demultiplex unit 1405. As a result, the other subprograms and the tuner 1605 in the Java library 1605 can control the receiving unit 1404 through the library 1601b.

The condition-release 1601b2 receives information from other subprograms and a CA 1605d in the Java library 1605, and passes these to the descrambler 1406.

The AV reproduction 1601b3 receives the audio packet ID and video packet ID from the other subprograms and a JMF 1605a in the Java library 1605. The AV reproduction 1601b3 then provides the received audio packet ID and video packet ID to the TS decoder 1407.

As a result, the TS decoder 1407 performs filtering based on the provided packet IDs, and implements the reproduction of video/audio.

The NET 1601b4 creates the packets of a protocol lower than the application layer defined in the IP network using the data received from the other subprograms or the network library 1605e in the Java library 1605. A protocol lower than the application layer refers to, for example, a TCP packet, a UDP packet, an IP packet, and so on.

By passing this to the network unit 1411, messages and data are transmitted to another device via the network 1304. Furthermore, when a message is received from another device via the network 1304, the NET 1601b4 converts the message to an application layer protocol packet and passes to the other subprograms or the network library 1605e of the Java library 1605. An application layer protocol refers to, for example, Hypertext Transfer Protocol (HTTP), RTP, and so on.

The EPG 1602 is made up of a TV-program display unit 1602a for displaying a TV-program guide to the user as well as for accepting an input from the user, and a reproduction unit 1602b for selecting channels.

Here, EPG is an abbreviation of Electric Program Guide. The EPG 1602 is activated by the kernel 1601a when power to the data output device 1301 is turned on. Inside the activated EPG 1602, the program display unit 1602a and the reproduction unit 1602b are activated simultaneously.

When activated, the TV-program display unit 1602a waits for an input from the user via the input unit 1401 of the data output device 1301.

Here, in the case where the input unit 1401 is made up of the front panel illustrated in FIG. 15, when the user presses down the EPG button 1507 on the input unit 1401, the CPU 1412 is notified of the identifier such as the EPG button. The program display unit 402a in the EPG 402, which is a subprogram that functions on the CPU 1412, receives the identifier, creates program information display data and outputs the program information display data to the monitor using a monitor output unit which is not pictured. The monitor may be included in the data output device 1301, and may also be a television connected to the data output device 1301 by a composite cable, HDMI cable, or the like. The monitor displays the received TV-program information display data.

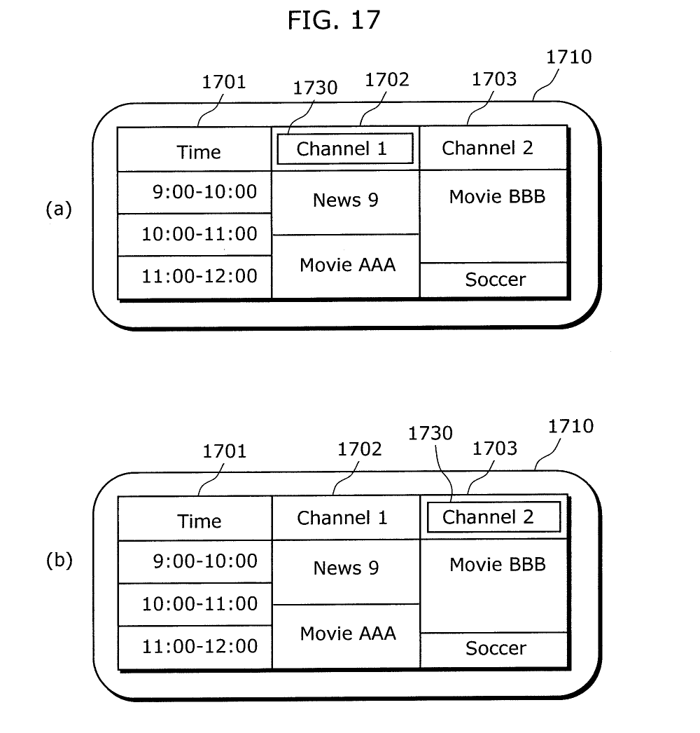

FIG. 17 (a) and (b) are diagrams which respectively show examples of the program guide displayed in the monitor according to the second embodiment of the present invention.

Referring to FIG. 17 (a), TV-program information is displayed in a grid in the program guide 1710 displayed on the monitor. Time information is displayed in a column 1701. A channel name “Channel 1” and TV-programs to be broadcast during time periods corresponding to the times described in the column 1701 are displayed in a column 1702.

It is shown that a program ‘News 9’ is broadcast in ‘Channel 1’ from 9:00 to 10:30, and ‘Movie AAA’ is broadcast from 10:30 to 12:00. As in the case of the column 1703 and the column 1702, the channel name ‘channel 2’ and TV shows to be broadcast during time periods corresponding to the times in the column 1701 are displayed. The program ‘movie BBB’ is broadcast from 9:00 to 11:00, and ‘News 11’ is broadcast from 11:00 to 12:00.

The cursor 530 moves at the press of the left-cursor 303 or the right-cursor 304 on the front panel 300. When the right-cursor 304 is pressed down in the state illustrated in FIG. 17 (a), the cursor 530 moves to the right as shown in FIG. 17 (b). Furthermore, when the left-cursor 303 is pressed down in the state illustrated in FIG. 17 (b) the cursor 530 moves to the left as shown in FIG. 17 (a).

When the OK button 1505 on the front panel 1500 is pressed down in the state shown in FIG. 17 (a), the TV show display unit 1602a notifies the reproduction unit 1602b of the identifier for “Channel 1”. When the OK button 1505 on a front panel 1500 is pressed down in the state shown in FIG. 17 (b), the TV program display unit 1602a notifies the reproduction unit 1602b of the identifier of the “Channel 2”.

Additionally, the program display unit 1602a regularly stores the displayed program information in the second memory 1403 through the demultiplex unit 1405. Generally, it takes time to obtain TV-program information from the broadcast station. It is possible to quickly display a TV-program guide by displaying the TV-program information, stored ahead of time in the second memory 1403, at the press of the EPG button 1507 in the front panel 1500.

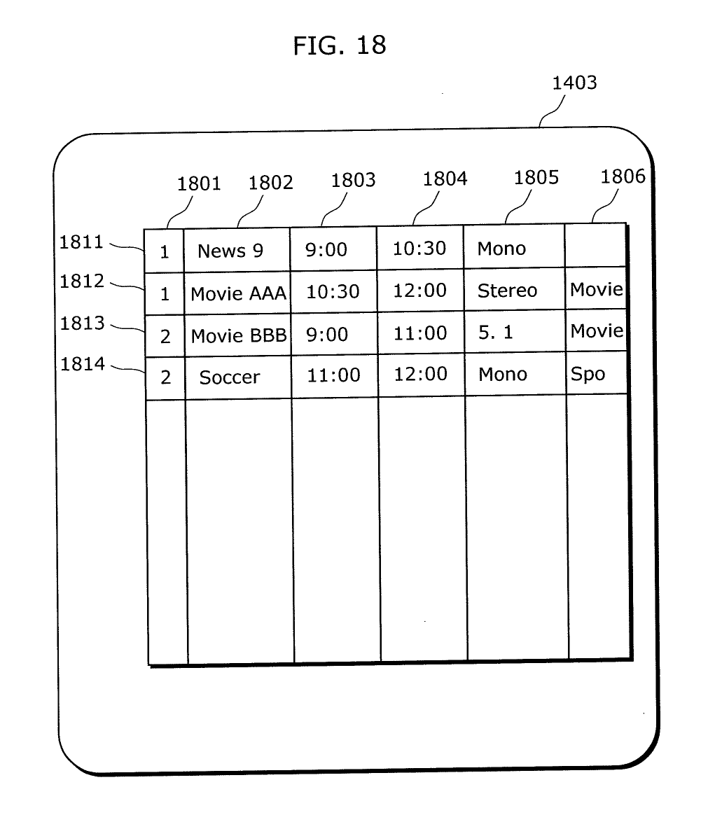

FIG. 18 is a diagram which shows an example of a program guide stored in the second memory 1403 according to the second embodiment in the present invention. The TV-program information is stored in tabular form.

A column 1801 displays the channel identifiers. A column 1802 displays the TV-program names. A column 1803 describes the broadcast start times of the TV-programs, and a column 1804 describes the broadcast end times. The column 1805 displays the type of audio for the program and displays monaural audio, stereo audio and 5.1 channel audio respectively as ‘monaural’, ‘stereo’ and ‘5.1’. A column 1806 displays the type of the programs. A regular TV-program is displayed as an empty cell, a movie is displayed as “movie”, and a sports program is displayed as “sports”.

Each row 1811 to 1814 displays information for a TV-program. In this example, one combination of TV-program information has a set of the channel identifier, a TV-program name, a broadcast start time, a broadcast end time, and a TV-program audio type.

For example, the row 1811 includes a combination in which the identifier is ‘1’, the program name is ‘news 9’, the broadcast start time is ‘9:00’, the broadcast end time is ‘10:30’, the audio type is ‘monaural’ and the type of program is ‘normal’.

The reproduction unit 1602b reproduces a channel using the received identifier for the channel. In other words, the reproduction unit 1602b reproduces the video and audio making up the channel. The relationship between channel identifiers and channels is pre-stored in the second memory 1403 as channel information.

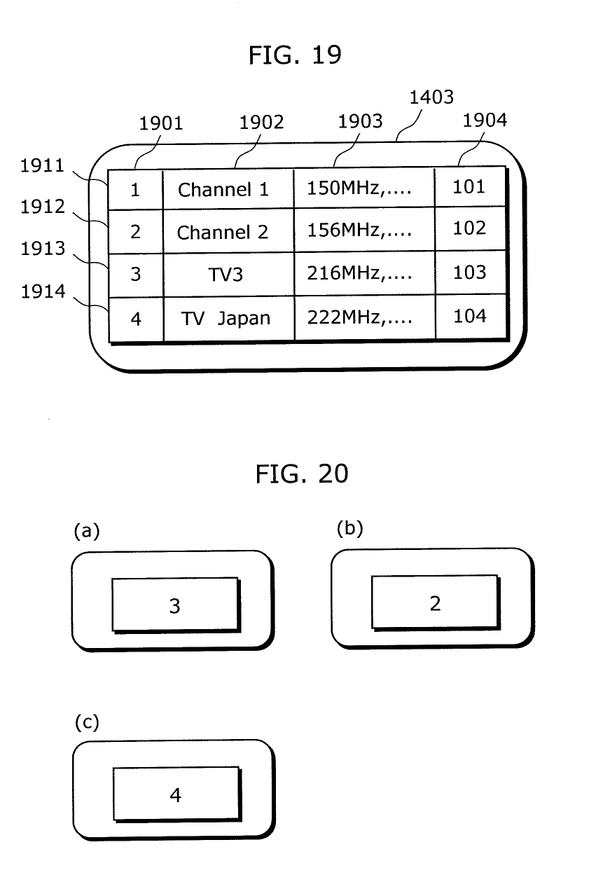

FIG. 19 shows an example of the channel information stored in the second memory 1403 according to the second embodiment of the present invention.

The channel information is stored in tabular form. A column 1901 describes the identifiers of channels. A column 1902 displays channel names. A column 1903 displays tuning information. Here, the tuning information is values to be provided to the receiving unit 1404 including frequency, transmission rate, coding ratio and so on. A column 1904 describes program numbers.

Program numbers are numbers used to identify PMTs defined by the MPEG-2 Standard. A description about PMT is given later.

Each row 1911 to 1914 indicates a combination of the identifier, channel name, and tuning information for each channel. The row 1911 describes a combination that includes “1” as an identifier, “Channel 1” as a channel name, a frequency of “150 MHz” as tuning information, and “101” as a program number. The reproduction unit 1602b passes the identifier of the received channel directly to the service manager 1604 in order to reproduce the channel.

Moreover, when the user presses down the up-cursor 1501 and the down-cursor 1502 on the front panel 1500 during reproduction, the reproduction unit 1602b receives a notification about the button being pressed from the input unit 1401 through the CPU 1412, and changes the channel being reproduced accordingly.

When the up-cursor 1501 is pressed down, a channel having the next lower channel identifier to that of the currently-reproduced channel is reproduced, and when the down-cursor 1502 is pressed down, a channel having the next higher channel identifier to that of the currently-reproduced channel is reproduced.

First, the reproduction unit 1602b stores, in the second memory 203, the identifier of the channel that is currently reproduced.

FIG. 20(a), (b) and (c) shows an example of the channel information stored in the second memory 1403 according to the second embodiment of the present invention.

FIG. 20 (a) shows that an identifier “3” is stored, and in reference to FIG. 19, it is shown that a channel with the channel name “TV 3” is being reproduced.

When the user presses down the up-cursor 301 in the state illustrated in FIG. 20(a), the reproduction unit 402b refers to the channel information shown in FIG. 19, and passes the identifier “2” of a channel named “Channel 2” to a service manager 1604 in order to switch reproduction to the channel named “Channel 2” which is the next lower channel from the currently-reproduced channel. At the same time, the reproduction unit 402b rewrites the identifier stored in the second memory 1403 to the channel identifier “2”.

FIG. 20 (b) shows the state in which the channel identifier has been rewritten. When the user presses down the down-cursor 1502 in the state illustrated in FIG. 20(a), the reproduction unit 1602b refers to the channel information shown in FIG. 19, and passes the identifier “4” of a channel named “TV Japan” to the service manager 1604 in order to switch reproduction to the channel named “TV Japan” which is the next higher channel from the currently reproducing channel in the guide. At the same time, the reproduction unit 402b rewrites the identifier stored in the second memory 1403 to the channel identifier “4”.

FIG. 20 (c) shows the state in which the channel identifier has been rewritten. The channel identifier is saved, even when power to the data output device 1301 is cut-off, since it is stored in the second memory 203.

Further, upon being activated when power to the data output device 1301 is turned on, the reproduction unit 1602b reads out the channel identifier stored in the second memory 1403. Then, the reproduction unit 1602b passes the channel identifier to the service manager. With this, when the power is turned on, the data output device 1301 is able to start the reproduction of the last channel that was being reproduced at the time of its previous operation.

The Java VM 1603 is a Java virtual machine that sequentially analyzes and executes programs written in the Java™ language. Programs written in the Java language are compiled into an intermediate code known as a byte code which is not dependent on hardware. A Java virtual machine is an interpreter which executes the byte code.

Some Java virtual machines pass the byte code to the CPU 1412 after translating the byte code into an execution format which can be interpreted by the CPU 1412, and executes the byte code.

The Java VM 1603 is activated, with a Java program to be executed being designated by the kernel 1601a. In the present embodiment, the kernel 1601a designates the service manager 1604 as the Java program to be executed.

Details of the Java language are described in many publications such as “Java Language Specification” (ISBN 0-201-63451-1). Here, such details are omitted.

Furthermore, the detailed operations of the Java VM itself are described in many publications such as “Java Virtual Machine Specification (ISBN 0-201-63451-X)”. Here, such details are omitted.

The service manager 1604 is a Java program written in Java language and successively executed by the Java VM 1603. It is possible for the service manager 1604 to call or be called by another subprogram not written in Java language, through the Java Native Interface (JNI). The JNI is also described in many publications such as in the book “Java Native Interface” and so on. Here, such details are omitted.

First the process in the case of receiving a digital broadcast, and reproducing the received multimedia data shall be described.

The service manager 1604 accepts the identifier of a channel from the reproduction unit 1602b, through the JNI.

The service manager 1604 first passes the channel identifier to the Tuner 1605c in the Java library 1605, and requests tuning. The Tuner 1605c refers to the channel information stored in the second memory 1403, and obtains the tuning information.

Now, when the service manager 1604 passes the identifier “2” for the channel to the Tuner 1605c, the Tuner 1605c refers to the row 1912 shown in FIG. 19, and obtains the corresponding tuning information “156 MHz,”. The tuner 1605c passes the tuning information to the receiving unit 1404 through the tuner 1601b1 of the library 1601b in the OS1601.

The receiving unit 1404 performs demodulation on the signal transmitted from the broadcast station, based on the provided tuning information, and passes the result to the demultiplex unit 1405.

Next the service manager 1604 requests descrambling from the CA 1605d inside the Java library 1605. The CA1605d applies information necessary for decoding to the descrambler 1406 through the condition-release 1601b2 in the library 1601b of the OS 1601.

On the basis of such provided information, the descrambler 1406 descrambles the signal provided by the receiving unit 1404, and passes the result to the TS decoder 1407.

The service manager 1604 provides the channel identifier to a JMF 1605a inside the Java library 1605, and requests reproduction of the video and audio.

First, the JMF 1605a obtains, from a PAT and a PMT, packet IDs used to specify the video and audio to be reproduced. PAT and PMT are tables defined by the MPEG-2 standard that express the TV-program line-up included in an MPEG-2 transport stream. PAT and PMT are embedded in the payloads in packets included in the MPEG-2 transport stream, and are sent together with audio and video. Refer to the Specification for details. Here, only the outline shall be described.

PAT, which is an abbreviation of Program Association Table, is stored and sent in packets with the packet ID “0”. In order to obtain the PAT, the JMF 1605a designates the packet ID “0” to the demultiplex unit 1405, through the library 1601b of the OS 1601. The demultiplex unit 1405 performs filtering based on the packet ID “0” and, by passing the result to the CPU 1412, the JMF 1605a collects the PAT packets.

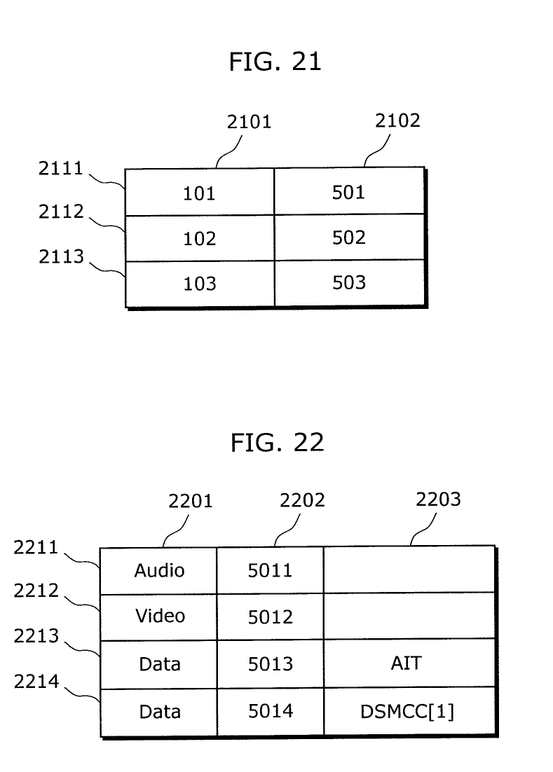

FIG. 21 is a guide which schematically shows an example of the collected PAT information.

A column 2101 displays program numbers. A column 2102 displays packet IDs. The packet IDs shown in the column 2102 are used to obtain the PMT.

Each of rows 2111 to 1213 holds a combination of a program number for a channel and a corresponding packet ID. Here, three channels are defined. The row 2111 defines a combination of the program number “101” and the packet ID “501”.

Now, when the channel identifier provided to the JMF 1605a is “2”, the JMF 1605a refers to the row 2112 in FIG. 21, so as to obtain the corresponding program number “102”, and then refers to the row 2112 in the PAT shown in FIG. 21, so as to obtain the packet ID “502” corresponding to the program number “102”.

PMT, which is an abbreviation of Program Map Table, is stored and sent in packets of the packet ID defined in the PAT. In order to obtain the PMT, the JMF 1605a designates the packet ID to the demultiplex unit 1405 through the library 1601b of the OS 1601. Here, it is assumed that the packet ID designated is “502”. The demultiplex unit 1405 performs filtering with the packet ID “502” and, by passing the result to the CPU 1412, the JMF 1605a collects the PMT packets.

FIG. 22 is a diagram which schematically shows an example of the collected PMT information.

A column 2201 displays stream types. A column 2202 displays packet IDs. Information designated in the respective stream types is stored and transmitted in the payloads of packets with the packet IDs designated in the column 2202. A column 2203 displays supplementary information.

Each row 2211 to 2214 is a combination of a packet ID and the type of information being transmitted, which is known as an elementary stream.

The row 2211, which is a combination of the stream type “audio” and the packet ID “5011”, indicates that audio data is stored in the payload of the packet with the packet ID “5011”. The JMF 1605a obtains, from the PMT, the packet IDs of the video and audio to be reproduced. Referring to FIG. 22, the JMF 1605a obtains the audio packet ID “5011” from the row 2211, and the video packet ID “5012” from the row 2212.

Next, the JMF 1605a passes the obtained audio packet ID and video packet ID to the AV reproduction 1601b3 in the library 1601b of the OS 1601. Upon receiving the audio packet ID and video packet ID, the AV reproduction 1601b3 provides the received audio packet ID and video packet ID to the TS decoder 1407. The TS decoder 1407 performs filtering based on the provided packet IDs.

Here, the packet with the packet ID “5011” is passed to the audio output unit 1409, and the packet with the packet ID “5012” is passed to the video output unit 1408 respectively.

The audio output unit 1409 converts (for example, digital-analog conversion) the provided packet, as necessary, and outputs this.

The video output unit 1408 converts (for example, digital-analog conversion) the provided packet, as necessary, and outputs this.

The service manager 1604 finally provides the channel identifier to an AM1605b in the Java library 1605, and requests reproduction of the data broadcast.

Here, data broadcast reproduction refers to extracting a Java program included in the MPEG-2 transport stream, and having it executed by the Java VM 1603. As a method of inserting a Java program into the MPEG-2 transport stream, a method referred to as DSMCC, which is described in the MPEG Standard ISO/IEC 13818-6, is being used. Here, detailed description of DSMCC shall be omitted. The DSMCC format defines a method of encoding, in packets within an MPEG-2 transport stream, a file system made up of directories and files used by a computer.

Furthermore, information about the Java program to be executed is embedded and sent in packets in the MPEG-2 transport stream in a format referred to as AIT. AIT is defined in 10 chapters in V.1 of the DVB-MHP Standard (formally as, ETS TS101 812 DVB-MHP Specification V1.0.2), and is an abbreviation for Application Information Table.

First, in order to obtain the AIT, the AM 1605b obtains the PAT and PMT in the same way as the JMF 1605a, so as to obtain the packet ID of the packet that stores the AIT.

Now, when “2” is the identifier of the provided channel and the PAT shown in FIG. 21 and the PMT shown in FIG. 22 are being transmitted, the PMT in FIG. 22 is obtained according to the same procedure followed by the JMF 1605a. The AM 1605b extracts, from the PMT, the packet ID of the elementary stream having a stream type of “Data” which has “AIT” as additional information. In FIG. 22, the elementary stream corresponds to the elementary stream in the row 1013, and therefore the packet ID “5013” is obtained.

The AM 1605b provides the packet ID of the AIT to the demultiplex unit 1405, through the library 1601b in the OS 1601. The demultiplex unit 1405 performs filtering based using the provided packet ID, and passes the result to the CPU 1412. As a result, the AM 1605b can collect the packets of AIT.

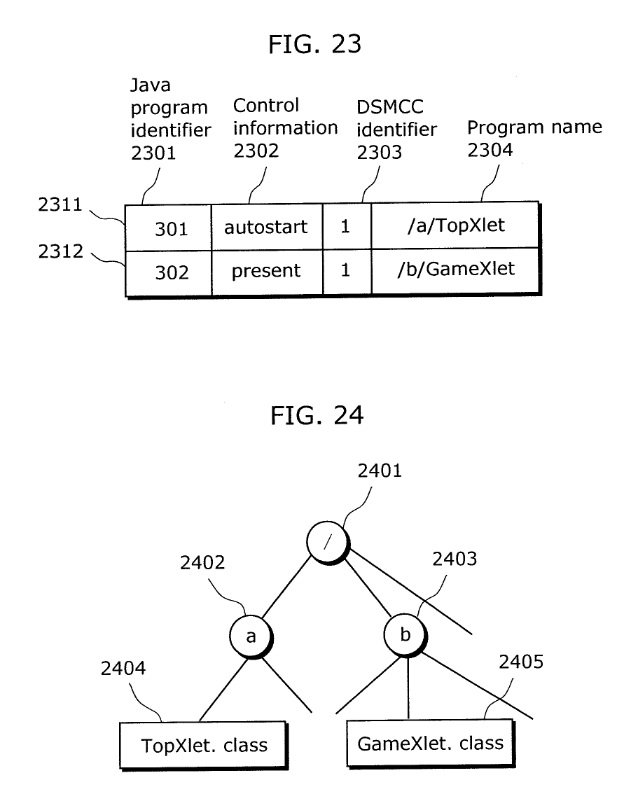

FIG. 23 is a diagram which schematically shows an example of information in the collected AIT.

A column 2301 displays the identifiers for Java programs.

A column 2302 displays control information for Java programs. The control information includes “autostart”, “present”, and “kill” and so on. “autostart” means that the data output device 101 automatically executes the program immediately. “present” means that the program is not executed automatically. “kill” means that the program is terminated.

A column 2303 displays DSMCC identifiers for extracting packet IDs which include a Java program in the DSMCC format.

A column 2304 displays the program name of Java applications.

Rows 2311 and 2312 display combinations of Java program information. The Java program defined in the row 2311 is a set of an identifier “301”, control information “autostart”, a DSMCC identifier “1”, and a program name “a/TopXlet”. The Java program defined in the row 2312 is a combination of an identifier “302”, control information “present”, a DSMCC identifier “1”, and a program name “b/GameXlet”.

Here, the two Java programs have the same DSMCC identifier which indicates that two Java programs are included within a single file system encoded in the DSMCC format. Here, only four items of information are defined for the Java programs, but more items of information are actually defined. Refer to the DVB-MHP standard for details.

The AM 1605b finds the “autostart” Java program within the AIT, and extracts the corresponding DSMCC identifier and Java program name. With reference to FIG. 23, the AM 1605b extracts the Java program in the row 2311, and acquires a DSMCC identifier ‘1’ and the Java program name ‘a/TopXlet’.

Next, using the DSMCC identifier obtained from the AIT, the AM 1605b obtains, the packet ID of packets that store Java programs in the DSMCC format from the PMT. More specifically, the AM 1605b obtains, from within the PMT, the packet ID of the elementary stream whose stream type is “Data” and which has a matching DSMCC identifier in the supplementary information.

Now, assuming that the DSMCC identifier is “1” and the PMT is that shown in FIG. 22, the elementary stream in the row 2214 matches, and the packet ID “5014” is extracted.

The AM 1605b designates the packet ID of the packet in which data is embedded in the DSMC format, to the demultiplex unit 1405, through the library 1601b in the OS 1601.

Here, the packet ID “5014” is provided. The demultiplex unit 1405 performs filtering using the provided packet ID, and passes the result to the CPU 1412. As a result, the AM 1605b can collect the required packets. The AM 1605b decrypts the file system from the collected packets, according to the DSMCC format, and saves this in the first memory 1402 or the second memory 1403. Extracting the data of a file system, and the like, and saving the data in the first memory 1402 or the second memory 1403 shall hereafter be referred to as downloading.

FIG. 24 shows an example of a downloaded file system.

In the figure, a circle denotes a directory and a square denotes a file. 2401 denotes a root directory, 2402 denotes a directory “a”, 2403 denotes a directory “b”, 2404 denotes a file “TopXlet.class”, and 2405 denotes a file “GameXlet.class.”

Here, although an example of downloading a file system from an MPEG-2 transport stream is described, however the OCAP specification also defines downloading using an IP network, and so on. Furthermore, a method for specifying the location of a file system using information referred to as XAIT is defined, instead of AIT, and a method for downloading the file system is prescribed.

Next, the AM 1605b passes, to the Java VM 1603, the Java program to be executed from within the file system downloaded into the first memory 1402 or the second memory 1403. Here, when the name of the Java program to be executed is “a/TopXlet”, the file “a/TopXlet.class”, having “.class” added to the Java program name, is the file to be executed. “/” is a division of a directory or file name and, by referring to FIG. 24, the file 2404 is the Java program to be executed. Next, the AM 1605b passes the file 2404 to the Java VM 1603.

The Java VM 1603 executes the Java program passed to it.

When the service manager 1604 receives another channel identifier, the execution of the video or audio reproduced through each library included in the Java library 1605 is stopped through each library included in the Java library 1605 in the same way, and reproduction of the video or audio is executed based on the newly received channel identifier.

Furthermore, the service manager 1604 also includes a function for receiving the identifier of a channel from a Java program executed in the Java VM 1603, aside from the reproduction unit 1602b.

Specifically, a Java language class for receiving the channel identifier, and the method thereof, are provided. When another channel identifier is received, service manager 1604 stops the execution of the video or audio reproduced through each library included in the Java library 1605 through each library included in the lava library 1605 in the same way, and afterwards reproduction of the video or audio and execution of the Java program is performed based on the newly received channel identifier.

Next, the process of receiving a digital broadcast and accumulating the multimedia data thereof in the second memory 1403 shall be described for the data output device 1301.

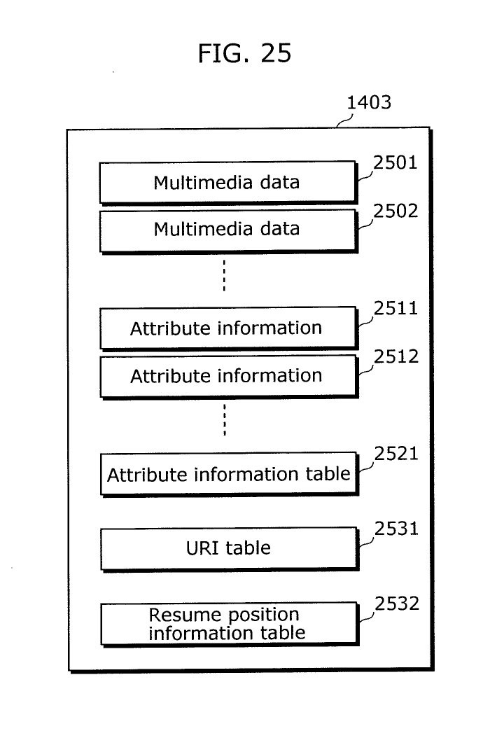

FIG. 25 is a diagram which shows an example of the form in which the data output device 1301 accumulates the multimedia data in the second memory 1403.

The data output device 1301 stores multimedia data and its attribute information, an attribute information table, a URI table and the resume position information table in the second memory 1403. The information stored in the second memory shown by FIG. 25 includes multimedia data 2501, multimedia data 2502, attribute information 2511 for the multimedia data, attribute information 2512 for the multimedia data, an attribute information table 2521, a URI table 2531 and a resume position information table 2532.

The multimedia data 2501 and the multimedia data 2502 are multimedia data encoded in the MPEG transport stream format. The attribute information 2511 and the attribute information 2512 are additional information such as the title of each multimedia data. Here, the attribute information 2511 describes attribute information for the multimedia data 2501, and the attribute information 2512 describes the attribute information for the multimedia data 2502 respectively.

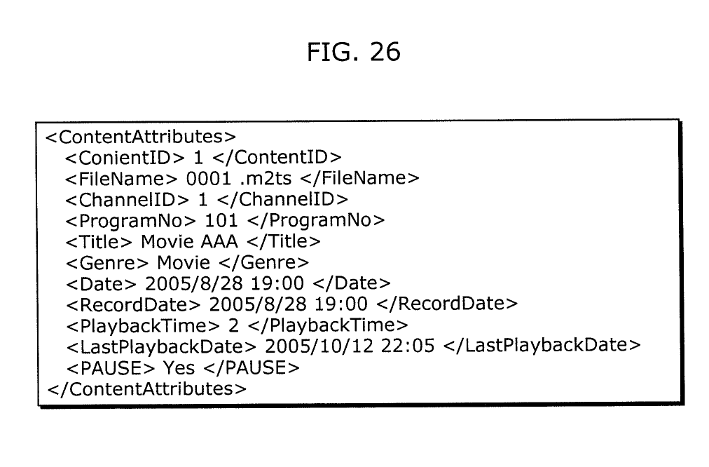

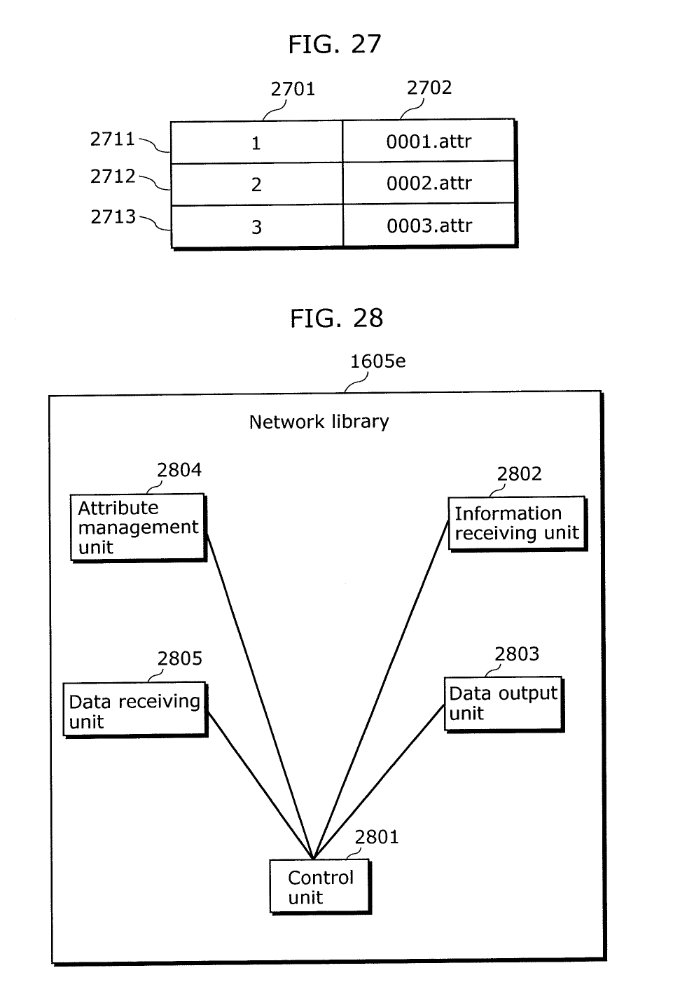

FIG. 26 is a diagram which shows an example of attribute information in the second embodiment of the present invention. In the present embodiment, the attribute information is text defined in the Extensible Markup Language (XML).

In FIG. 26, a ContentID element describes the identifier of a content; a FileName element describes the filename of the multimedia data; a ChannelID element describes an identifier of a channel on which the TV-program was broadcast, as in column 1801 in FIG. 18; a ProgramNo element describes a program number for searching for the PMT, as in column 1904 in FIG. 19; a Title element describes the TV-program name as in column 1802 in FIG. 18; a Gunre element describes the type of the program, as in column 1806 in FIG. 18; a Date element describes the date and time the TV-program was broadcast; a RecordDate element describes the date and time the TV-program was stored; a PlaybackTime element describes the number of times the multimedia data has been reproduced or outputted to the network 104; a LastPlaybackDate element describes respectively the date and time that the multimedia data was last reproduced or was outputted to the network.

Note that the attribute information is not limited to the XML structure, and recording in other formats such as binary data for example is also possible. The attribute information table is a correspondence table for the content identifier and the file on which the multimedia data of the content indicated by the identifier is stored. FIG. 27 shows an example thereof.

FIG. 27 is a diagram which shows an example of an attribute information table in the second embodiment of the present invention.

In FIG. 27, a column 2701 displays the content identifiers, and a column 2702 displays file names which are attribute information. Rows 2711 to 2713 are file name combinations of the attribute information corresponding with the content identifier. From row 2711, it can be read that the attribute information of the content for the identifier 1 is stored in the file 0001.attr. The URI table 2531 and the resume position information table are described below.

Hereinafter, the storing process shall be described. First, the operation up to descrambling is the same as in the case of the previously described reproduction. Next, the service manager 1604 requests the storing of the multimedia data, to the Rec 1605j inside the Java library 1605. The Rec 1605j first obtains the PAT and PMT in the same manner as the JMF 1605a and AM 1605b above, and obtains packet IDs for the video data, audio data, and respective section data relating to the accumulated TV-program. Now, when “2” is the identifier provided for the channel and the PAT shown in FIG. 21 and the PMT shown in FIG. 22 are being transmitted, the PMT shown in FIG. 22 is obtained by the same procedure followed by the JMF 1605a. The data to be stored is all the data described in the PMT in FIG. 22.

The Rec 1605j provides these packet IDs to the TS decoder 1407 via the library 1601b in the OS 1601 and causes the packet IDs to be outputted to the TS multiplexer 1410. The TS decoder 1407 performs filtering using such provided packet IDs, and passes the result to the TS multiplexer 1410.

Note that, with regard to the section data, a version number may be assigned to respective section data, and the TS decoder 1407 may output only once per version number for the same type of data, and performs filtering for the rest.

Additionally, the Rec 1605j provides what type of data is sent to the TS multiplexer 1410 through the library 1601b in the OS 1601 and composes an MPEG2 transport stream from the data passed from the TS decoder 1407. The TS multiplexer 1410 passes the composed MPEG transport stream to the CPU 1412.

Further, the Rec1605j requests the IO1605g in the Java library 1605 to write the MPEG transport stream received by the CPU 1412 from the TS multiplexer into the second memory. Further, the Rec 1605j receives the channel identifier for the TV-program by requesting it to the service manager 1604, and reads out the TV-program information corresponding to the accumulated multimedia data from among the TV-program information shown in FIG. 18 and stored in the second memory 1403, by requesting to the IO 1605g.

Further, the Rec 1605j issues an identifier for the accumulated multimedia, creates the acquired program information, and creates attribute information from the file name for which multimedia data is accumulated, and writes the attribute information into the second memory 1403 by requesting to the IO 1603. Further, the Rec 1605j reads out the attribute information table by requesting to the IO 1605g, updates the content and updates the attribute information table by writing into the second memory 1403 after requesting to the IO 1605g.

Next, the processing when outputting the multimedia data of a received digital broadcast from the network unit 1411 is explained below.

First, the network library 1605e located inside the Java library 1605 receives a request from a terminal connected to the network 1304, and provides the identifier for the channel being requested to the service manager 1604. The service manager 1604 provides the received channel identifier to the Tuner 1605c and requests tuning, then further requests descrambling to the CA 1605d. Subsequently, the service manager 1604 returns the process to the network library 1605e.

The network library 1605e controls the TS decoder 1407 and the TS multiplexer 1410 and creates an MPEG transport stream from the video data, audio data, and section data of the TV-program, in the same manner as the Rec 1605j described above.

Further, the network library 1605e provides the transmission destination address to the NET1601b4 in the library 1601b of the OS1601. Subsequently, the network library 1605 converts the MPEG2 transport stream received from the TS multiplexer 1410 into a format that is in accordance with the protocol of the application layer to be transmitted, and outputs the MPEG2 transport stream sequentially to the NET 1601b4.

An application layer protocol refers to, for example, HTTP, RTP, and so on. Using an application layer protocol, the NET 1601b4 refers to the transmission destination address, and converts the data passed onto it into IP network packets and passes the packets to the network unit 1411. The network unit 1411 converts the data passed onto it into a signal that is in accordance with the physical media of the network connected to, and outputs this signal.

Next, the process in the case of reproducing multimedia data stored in the second memory 1403 shall be described.

Upon receiving the content identifier, the service manager 1604 reads out the attribute information table 2521 from the second memory 1403 by requesting to the IO 1605g inside the Java library 1605 and searches for the file on which the attribute information of the content for the identifier is stored. When the content identifier is 1 in the attribute information table in FIG. 27, the file corresponds to 0001.attr.

Next, after requesting to the IO 1605g, the service manager 1604 reads out the file on which the attribute information is stored, from the secondary memory 1403. The service manager 1604 obtains the file name on which the multimedia data of the content is stored, from the read-out attribute information. In the case of the attribute information in FIG. 26, 0001.m2ts corresponds to the file name.

Next, after requesting to the IO 1605g, the service manager 1604 reads out the MPEG transport stream from the file of the multimedia data. The IO 1605g reads out the data via the library 1601b in the OS 1601, and passes the data to the CPU 1412.

The service manager 1604 passes the read-out MPEG transport stream to the demultiplex unit 1405 through the library 1601b in the OS 1601.

Next, the service manager 1604 requests, to the CA 1605d inside the Java library, that the data be made to pass through without being descrambled by the descrambler.

The CA1605d provides information to the descrambler 1406 through the condition-release 1601b2 in the library 1601b of the OS 1601. With this, the descrambler 1406 passes the data passed onto it by the demultiplex unit 1405, as-is, to the TS decoder 1407.

Next, the service manager 1604 reads out the channel identifier or program number from the read-out attribute information, provides this to the JMF 1605a inside the Java library 1605, and requests reproduction. Hereinafter, the reproduction of video data and audio data can be performed according to the same process as in the case above of a content received from a broadcast.

Further, the service manager 1604 provides the channel identifier or the program number to the AM1605b in the Java library 1605, and requests reproduction of the data broadcast. Hereafter, the data broadcast can be reproduced according to the same process as in the case above of a content received from the broadcast.

The Java library 1605 is a collection of plural Java libraries stored in the second memory 1403. In the present embodiment, the Java library 1605 includes a JMF1605a, an AM1605b, a Tuner1605c, a CA1605d, a network library 1605e, a reproduction Lib1605f, an IO1605g, an AWT1605h, an SI1605i, a Recl1605j and so on.

Since the functions of the JMF1605a, the AM1605b, the Tuner1605c, the CA1605d and the Rec405j have already been explained, the explanation is not repeated.

The reproduction Lib1605f provides a Java language class and method (described below as JavaAPI) for passing the identifier for the channel currently being reproduced, the language class and method being stored in the second memory 1403. By using the Java API, the Java program can ascertain the channel currently being reproduced.

The IO1605g provides a Java API which the Java program uses to write data into the second memory 1403 or a Java API for reading written data out of the second memory 1403 to the Java program. By using the Java API, the Java program can save arbitrary data in the second memory 1403. Since the saved data does not disappear even when the power source of the data output device 1301 is turned off, after the data output device 1301 is again powered up, the data can be written again.

AWT1605h provides a JavaAPI used by the Java program to perform rendering and to receive a key input notification from the input unit 1401. More specifically, the JavaAPI corresponds to a java.awt.event package and a java.awt subpackage defined in “The Java class Libraries Second Edition, Volume 2” (ISBN 0-201-31003-1). Here, a detailed explanation is not provided.

SI1605i provides a JavaAPI used by the Java program to obtain channel information and electronic program guide information. More specifically, there is a Java TV specification and so on. Additionally, an MPEG section filter API for obtaining raw binary data from an MPEG2 transport stream that is being broadcasted is defined in the OCAP specification, and a Java application which interprets transmitted independent electronic program data can be utilized.

The network library 1605e is connected to the network 1304 through the NET1601b4 in the library 1601b in the OS1601, and communicates with the terminal 1302 and the terminal 1303. Communication includes transmitting a content list and EPG, transmitting multimedia data from the terminal, transmission pausing, transmission resumption, receiving a transmission finish request and transmitting multimedia data.

FIG. 28 is a block diagram showing an example of the interior structure of the network library 1605e. The network library 1605e includes a control unit 2801, an information receiving unit 2802, a data output unit 2803, a property management unit 2804 and a data receiving unit 2805. Note that the network library 1605e may include other functions related to the IP network.

The control unit 2801 provides a function realized by a network library 1605e for the downloaded Java application. In other words, the control unit 2801 provides a Java API for the Java application and the Java application can execute a function using a network by calling out the API.

When the Java API is called out, the control unit 2801 performs processing appropriately using an information communication unit 2802, a data output unit 2803, a property control unit 2804, a data receiving unit 2805, and a library 1601b in another Java library 1605 and in the OS1601.

Additionally, the control unit 2801 uses a callback function in the Java application when necessary to notify the Java application.

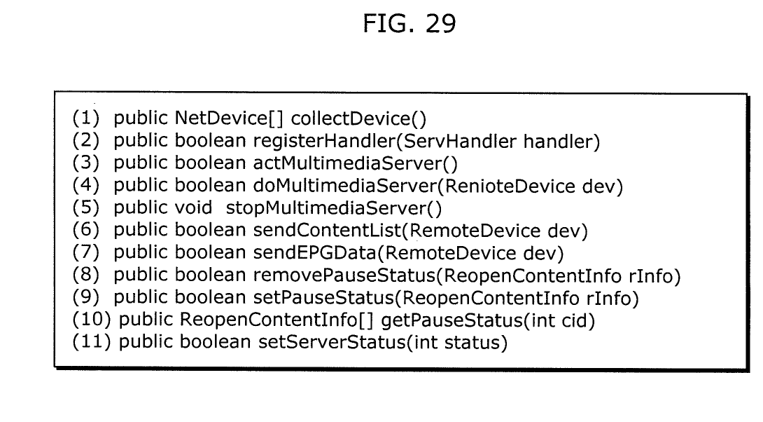

FIG. 29 is a diagram which shows an example of a Java API provided by the control unit 2801 included in the internal structure of the network library 1605e.

(1) in FIG. 29, the method collectDevice( ) gathers information in the external device connected to the network 1304 and returns an object sequence of the NetDevice object as the information. When there is a failure to collect information, the method collectDevice( ) returns ‘null’. Using the present method, information about the equipment connected to the network 1304 can be obtained.

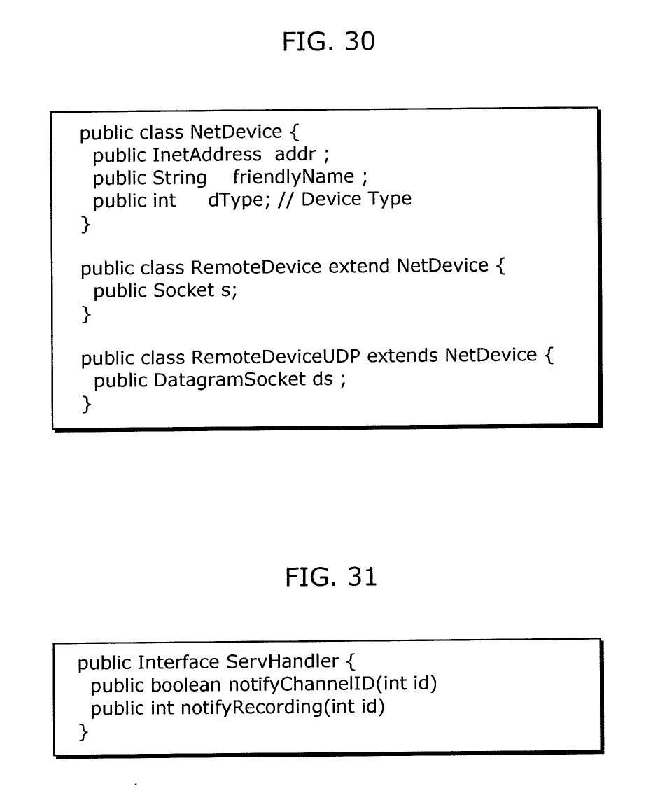

FIG. 30 is a diagram which shows the structure of a NetDevice class used by the network library 1605e.

In FIG. 30, addr indicates the network address of the device, friendlyName indicates the nickname attached to the device and dType indicates the device type; 0 indicates a data output device which can receive a digital broadcast, 1 indicates a data output device which does not have a digital broadcast receiving unit and 2 indicates a terminal. In this way, since information can be acquired by performing the method defined in UPnP DA, the details of the process are not provided.

The method registerHandler( ) in FIG. 29 (2) registers in the system a handler which includes a ‘ServHandler’ interface, to which an argument ‘handler’ is provided. When successful, the method registerHandler( ) returns ‘true’ and when unsuccessful, the method registerHandler( ) returns ‘false’. The Java application can receive a callback from the network library 1605e by registering the handler.

FIG. 31 is a diagram which shows an example of the ‘ServHandler’ interface structure used in the network library 1605e.

The method notifyChannelID( ) of the ‘ServHandler’ interface in FIG. 31 notifies the Java application of a channel identifier for which the transmission of multimedia data from the terminal is requested.

The Java application provides the identifier to the service manager 1604, requests channel tuning and descrambling, and when successful, the Java application returns ‘true’; when unsuccessful the Java application returns ‘false’ and returns control to the network library 1605e.

Note that the above channel identifier may be structured so as to be passed by the network library 1605e directly to the service manager 1604 and to request tuning and descrambling.

Additionally, a method notifyRecording( ) notifies the channel identifier to the Java application and requests that the data be accumulated, receiving the accumulated content identifiers as return values. The Java application applies the channel identifier to the service manager 1604, requests the accumulation of multimedia data and receives the content identifier.

The service manager 1604 uses Rec1605j as above to accumulate the multimedia data. Note that the network library 1605e may pass the above channel identifier directly to the service manager 1604 and request accumulation.

A method ‘actMultimediaServer( )’ requests the initialization and functioning of the multimedia server from the Java application to the network library 1605e, and when the process ends correctly, the method ‘actMultimediaServer( )’ returns ‘true’ and when there is an error the method ‘actMultimediaServer( )’ returns ‘false’. When the present method is called out, the control unit 2801 in the network library 1605e performs the processes of a multimedia server which provides multimedia data by using the information communication unit 2802, the data output unit 2803, the property management unit 2804, the data receiving unit 2805, another Java library 1605 and the library 1601b in the OS1601, and by notifying the Java application and the service manager 1604. A description of the process is given later.

The method ‘doMultimediaServer( )’ in FIG. 29 (4) requests that a device connected to the network 1304 expressed by a RemoteDevice given by the argument ‘dev’ function as a multimedia server from the Java application to the network library 1605e, and when the process ends correctly, the method ‘doMultimediaServer( )’ returns ‘true’ and when there is an error the method ‘doMultimediaServer( )’ returns ‘false’.

FIG. 30 is a diagram which shows an example of the RemoteDevice class.

In FIG. 30, the RemoteDevice class is defined as an extended class of the NetDevice class.

A member variable ‘s’ indicates a Socket object which communicates with a device expressed by a member variable of the NetDevice class. When the present method is called out, the control unit 2801 in the network library 1605e performs processes of a multimedia server which provides multimedia data to the provided device by using the information communication unit 2802, the data output unit 2803, the property management unit 2804, the data receiving unit 2805, another Java library 1605 and the library 1601b in the OS1601, and by notifying the Java application and the service manager 1604. A description of the process is given later.

A method ‘stopMultimediaServer( )’ in FIG. 29 (5) requests, from the Java application to the network library 1605e, that the multimedia server initialized by the method ‘actMultimediaServer( )’ or ‘doMultimediaServer( )’ finishes. When the present method is called out, the network library 1605e finishes the initialization function of the multimedia server.

A method ‘sendContentList( )’ in FIG. 29 (6) transmits a multimedia data guide accumulated in the second memory 1403 to the device connected to the network 1304 to which the argument ‘dev’ is provided. The transmission can be realized via the method defined in UPnP AV and thus a detailed explanation is not provided.

When the present method is called out, the network library 1605e uses the I01605g to read out a property information table 2521 and read out each content property information obtained from the property information table 2521 which is read out. Additionally, the network library 1605e reads out a URI table 2531 using I01605g.

The network library 1605e acquires a URI for accessing each content by searching for a URI table 2531, and creates a content list for the format decided in UPnP Av according to the property information. Subsequently, a network unit 1411 is controlled through a NET1601b4 in the library 1601b of the OS1601 and transmits the created content list. The transmission may be performed using a method ‘sendData( )’ in a data output unit described below.

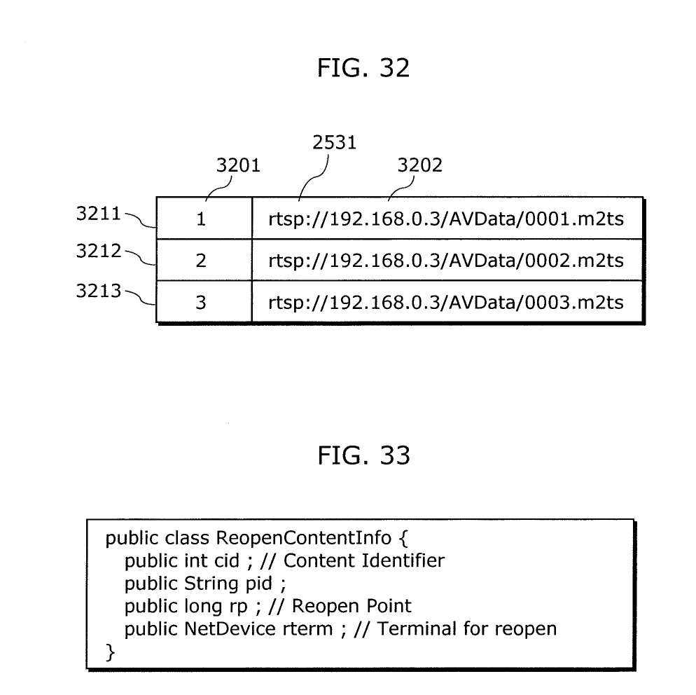

FIG. 32 is a diagram which shows an exemplary structure of a URI table 2531 in the second embodiment of the present invention.

In FIG. 32, a column 3201 shows the identifier for each content, and a column 3201 describes URIs for accessing the respective content. Each row 3211 to 3213 shows combinations of the content identifier and URI of content. For example, the row 3211 indicates that the URI of the content for identifier 1 is rtsp://192.168.0.3/AVData/0001.m2ts.

Method ‘sendEPGData( )’ in FIG. 29 (7) transmits EPG information to the device connected to the network 1304 to which the argument ‘dev’ is provided. The transmission can be performed by a method defined in UPnP AV in the same way as the method ‘sendContentList( )’ and thus a detailed description is not provided.

When the present method is called out, the network library 1605e uses the I01605g to read out EPG information shown in FIG. 18 which is stored in the second memory 1403 and converts the EPG information into a format defined in UPnP AV. Subsequently, a network unit 1411 is controlled through a NET1601b4 in the library 1601b of the OS1601 and transmits the converted EPG information.

Note that the URI is allocated for each channel and is accumulated in the same format as the URI table 2531 in the second memory 1403 and the URI is acquired by reading out the table. The transmission may be performed using a method ‘sendData( )’ in the data output unit described below. Additionally, the URI may transmit the data as-is in the EPG information stored in the second memory 1403 shown in FIG. 18.

A method ‘removePauseStatus( )’ in FIG. 29 (8) deletes the resume position information, to which the argument ‘rInfo’ has been provided, from the second memory 1403 and when the deletion is successful, whether or not the resume position information originally existed or not, the method ‘removePauseStatus( )’ returns ‘true’ and when the deletion fails, method ‘removePauseStatus( )’ returns ‘false’. The argument ‘rInfo’ is an instance of the ReopenContentInfo class.

FIG. 33 is a diagram which shows an example of the structure of the ‘ReopenContentInfo’ class used by the network library 1605e.

The member variable ‘cid’ in FIG. 33 shows an identifier for the accumulated content shown in FIG. 26 and FIG. 27, and the member variable ‘pid’ expresses an identifier which specifies the pause point of the multimedia data transmission expressed by the present ‘ReopenContentInfo’ object, the member variable ‘rp’ indicates the data position at which multimedia data output is resumed in a byte position from the top of the file at which the multimedia data is written, and the member variable ‘rterm’ indicates a NetDevice object which indicates the terminal when the transmission destination terminal is designated for when multimedia data output is resumed. A method ‘removePauseStatus( )’ deletes the resume position information which matches with the argument ‘rInfo’, the content identifier and the pause point identifier. The resume position information is stored in the second memory 1403 as the resume position information table 2532 as shown in FIG. 25.

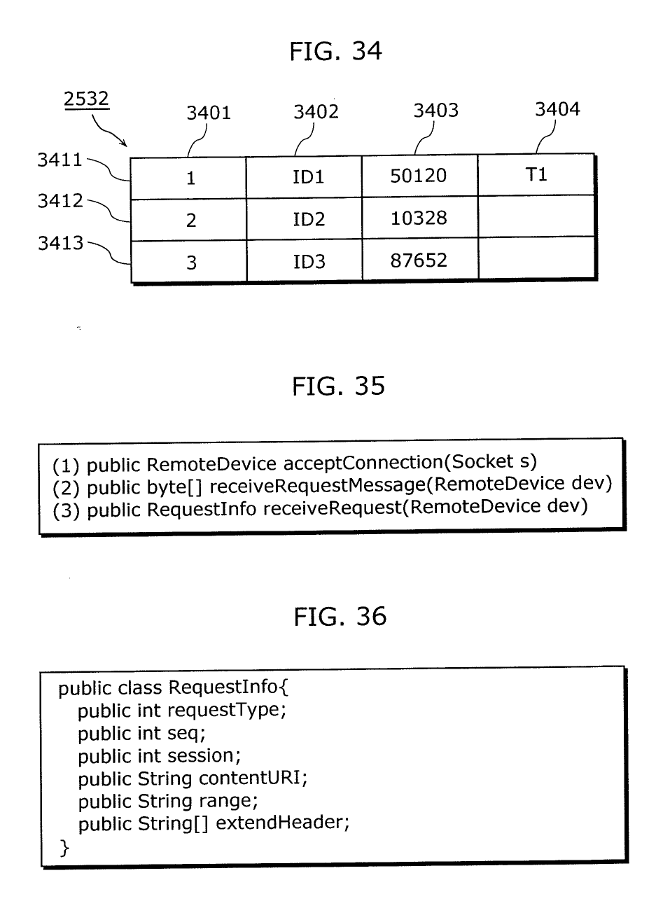

FIG. 34 is a diagram which shows an example of the structure of the resume position information table 2532 in the second embodiment of the present invention.

The column 3401 indicates a content identifier, the column 3402 indicates an output paused identifier, the column 3403 indicates a data position for resuming multimedia data output, and the column 3404 indicates a transmission destination terminal when the multimedia data output is resumed. The resume position information is expressed as a combination of the above information and corresponds to the rows 3411 to 3413.

Note that since a terminal for data output resumption is designated in the resume position information in the row 3411, and the terminal is shown in the column 3404, however since the terminal when data output is resumed is not designated in the resume position information for the row 3412 and the row 3413, the terminal is not shown in the column 3404.

Note that the network library 1605e may have a structure that does not allocate pause identifiers. In this case, the present method may be structured to delete content which matches the content identifier.

When the present method is called out, the network library 1605e first uses the I01605g to read out a resume position information table 2532. Subsequently, the resume position information table 2532 is searched and a row which matches the argument ‘rInfo’ is searched for between a content identifier described in the column 3401, and a content identifier shown in the column 3402.

When the row is found, the row is deleted from the resume position information table 2532. Subsequently, the updated resume position information table 2532 is written into the second memory 1403 using the IO1605g. Further, the content properties are updated by applying the identifier of the content and the content of the resume position information table 2532 to the method ‘updateAttribute( )’ in the property management unit described below, and by calling out the combination, the content property is updated, the method ‘updateAttribute( )’ returns a return value and the process is finished.

A method ‘setPauseStatus( )’ in FIG. 29 (9) writes the resume position information, to which the argument ‘rInfo’ has been provided, into the second memory 1403 and when the writing is successful, the method ‘setPauseStatus( )’ returns ‘true’ and when the writing fails, the method ‘setPauseStatus( )’ returns ‘false’.

When the present method is called out, the network library 1605e issues an identifier for when the argument ‘rInfo’ is provided to the pause point of the resume position information, and sets the identifier as the variable ‘pid’ in the rInfo. Subsequently, the resume position information table 2532 is read out using the IO1605g. A row which indicates the content of rInfo is added to the read-out resume position information table 2532 and updated. Subsequently, the updated resume position information table 2532 is written into the second memory 1403 using the IO1605g.

Subsequently, the content property is updated by applying the identifier of the content and the content of the resume position information table 2532 to the method ‘updateAttribute( )’ in the property management unit described below, and by calling out the combination, the method ‘updateAttribute( )’ returns a return value and the process is finished.

A method ‘PauseStatus( )’ in FIG. 29 (10) reads out the resume position information table 2532 from the second memory 1403, returns the content as a sequence of ‘ReopenContentInfo’ objects, and when successful, the method ‘PauseStatus( )’ returns the sequence, and when not successful, the method ‘PauseStatus( )’ returns ‘null’.

When the present method is called out, the network library 1605e first uses the I01605g to read out a resume position information table 2532 from the second memory 1403. Subsequently, a sequence is created by creating a ‘ReopenContentInfo’ object in which the content has been inserted for each row of the resume position information table 2532. When a sequence which includes the content of all of the rows is completed, the sequence is returned. Additionally, whether or not the resume position information table 2532 is present, the method ‘PauseStatus( )’ returns ‘null’ when there is an error in processing. Additionally, when there are no rows in the resume position information table 2532, a sequence in which the number of elements is 0 is returned.

A method ‘setServerStatus( )’ in FIG. 29 (11) sets whether or not the data pause resumption is supported or not from the Java application to the network library 1605e. When a 0 is provided to the argument, the network library 1605e works as a multimedia server which does not support data pause resumption, and when a non-0 is not provided to the argument, the network library 1605e works as a multimedia server which supports data pause resumption.

The information receiving unit 2802 controls a network unit 1411 through a NET1601b4 in the library 1601b of the OS1601, and receives the message when a connection request is received from the external device connected to the designated network 1304.

The information receiving unit 2802 provides a Java API to the control unit 2801 and the downloaded Java application.

FIG. 35 is a diagram which shows an example of a Java API provided by the information receiving unit 2802 included in the internal structure of the network library 1605e.

The method ‘acceptConnection( )’ in FIG. 35(1) performs the standby from the external device according to the socket object to which the argument ‘s’ is applied, establishes a connection with the device for which there has been a connection request, and he method ‘acceptConnection( )’ returns the ‘RemoteDevice’ object which includes the device information and a Socket object which communicates with the device, and when the return is successful, the method ‘acceptConnection( )’ returns the ‘RemoteDevice’ object, and when the return fails, the method ‘acceptConnection( )’ returns ‘null’.

For example, when a connection request for an RTSP session is received from the terminal, a ‘RemoteDevice’ object can be generated from the Socket object for sending and receiving the RTSP message and the IP address of the terminal for which there has been a request.

Note that the present method further may be structured such that a NetDevice object sequence is provided as an argument, and that only a connection request from the external device shown by each element of the sequence is responded to. Additionally, in the same way, the present method may be structured such that a NetDevice object sequence is provided as an argument, and that, when there is a connection request from the external device shown by each element in the sequence, a ‘RemoteDevice’ object is generated using the Socket object which communicates with the NetDevice object.

The method receiveRequestMessage( ) in FIG. 35 (2) receives the message from the external device to which the argument ‘dev’ is provided using the Socket object to which the argument ‘dev’ is provided, a byte data sequence is returned, and when successful the method receiveRequestMessage( ) returns a message byte column and when unsuccessful, the method receiveRequestMessage( ) returns ‘null’.

A method ‘receiveRequest( )’ in FIG. 35(3) receives the RTSP request message from the external device to which the argument ‘dev’ is provided using the Socket object to which the argument ‘dev’ is provided, the content is interpreted and is returned as a ‘RequestInfo object’, and when the return is successful, the method ‘receiveRequest( )’ returns a ‘RequestInfo object’ which indicates the request message is returned, and when the return fails, method ‘receiveRequest( )’ returns ‘null’.

FIG. 36 is a diagram which shows an example structure of the RequestInfo class used in the network library 1605e. A member variable ‘requestType’ indicates a type of request, 0 indicates SETUP, 1 for PLAY, 2 for PAUSE and 3 for TEARDOWN.

Additionally, the member variable ‘seq’ indicates a sequence number which is a Seq header value in the RTSP request. The member variable ‘session’ indicates a session number which is a ‘Session’ header for the RTSP request. The member variable ‘contentURI’ is a character string which expresses the URI for the content that has been requested. The member variable ‘range’ is a character string which is a Range header value for the RTSP request. The member variable ‘extentHeader’ is a sequence of String objects which stores an RTSP request extension header and stores a String object per extension header.

The data output unit 2803 controls a network unit 1411 through the NET1601b4 in the library 1601 of the OS1601, and outputs the designated data to the external device connected to the designated network 1304.

The data output unit 2803 provides a Java API to the control unit 2801 and the downloaded Java application.

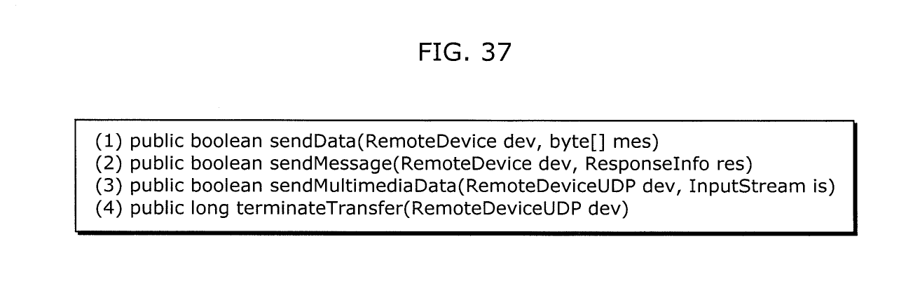

FIG. 37 is a diagram which shows an example of a Java API provided by the data output unit 2803 included in the internal structure of the network library 1605e.

The method ‘sendData( )’ in FIG. 37(1) transmits the data, to which the argument ‘mes’ has been provided, to the external device to which the argument ‘dev’ is provided using the Socket object to which the argument ‘dev’ is provided, and when successful the method ‘sendData( )’ returns ‘true’ and when unsuccessful the method ‘sendData( )’ returns ‘false’.

The method ‘sendMessage( )’ in FIG. 37(2) generates an RTSP message to which the argument ‘res’ has been provided and transmits the RTSP message to the external device to which the argument ‘dev’ is provided using the Socket object to which the argument ‘dev’ has been provided. When the transmission is successful the method ‘sendMessage( )’ returns ‘true’ and when unsuccessful, the method ‘sendMessage( )’ returns ‘false’. The argument ‘res’ is provided in an instance of the ResponseInfo.

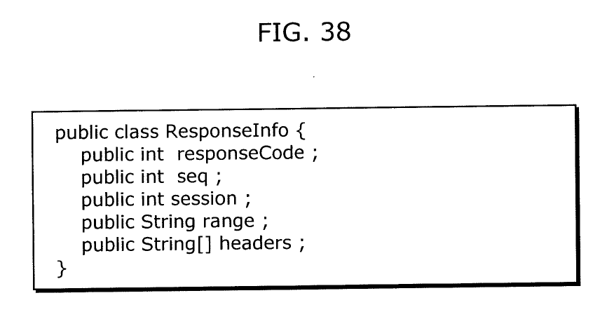

FIG. 38 is a diagram which shows an example of the structure of the ResponseInfo class used in the network library 1605e. In FIG. 38, the member variable ‘responseCode’ indicates a response code for example when the response is ‘200 OK’, the response code is ‘200’. Please reference RFC in RTSP in regards to the response code.

The member variable ‘seq’ is a sequence number which is a Seq header value in the RTSP response. The member variable ‘session’ indicates a session number which is a ‘Session’ header for the RTSP request. The member variable ‘range’ is a character string which is a Range header value for the RTSP response. A member variable ‘headers’ is a sequence of String objects which stores other headers in the RTSP response and stores a String object per header.

The method ‘sendMultimediaData( )’ in FIG. 37(3) reads out the multimedia data from the ‘InputStream’ to which the argument ‘is’ is provided, and transmits the read-out multimedia data to the external device to which the argument ‘dev’ is provided using the Socket object to which the argument ‘dev’ is provided, and a sequence of byte data is returned; when the return is successful the method ‘sendMultimediaData( )’ returns ‘true’ and when the return fails, the method ‘sendMultimediaData( )’ returns ‘false’. In the present method, a readout process is performed from ‘is’ to ‘EOF’. The argument ‘dev’ is provided as a RemoteDevice UDP class object.

FIG. 30 is a diagram which shows an exemplary structure of the RemoteDevice UDP class. The present class is defined as an extended class in the NetDevice class. A member variable ds indicates a DatagramSocket object which communicates with a device represented by a member variable of the NetDevice class using a UDP base.

A method ‘terminateTransfer( )’ in FIG. 37 (4) stops the transmission of multimedia data to the device to which the argument ‘dev’ is provided, and returns the number of bytes in the data transmitted until the transfer is stopped.

The property management unit 2804 updates a property which expresses that the data output is paused from among the content attribute information stored in the second memory 1403.

The information management unit 2804 provides a Java API to the control unit 2801 and the downloaded Java application.

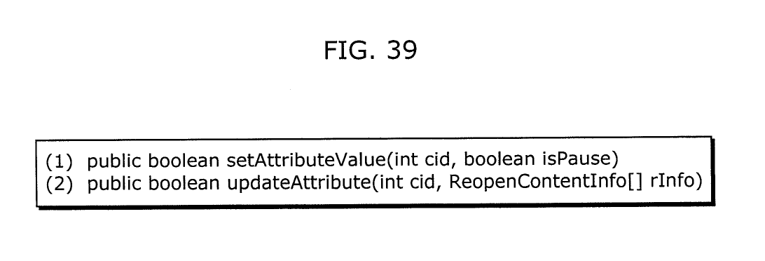

FIG. 39 is a diagram which shows an example of a Java API provided by the information receiving unit 2802 included in the internal structure of the network library 1605e.

‘setAttributeValue( )’ in FIG. 39(1) sets a value for the attribute information “data output paused” in the content of the identifier provided by the argument ‘cid’, and sets a value provided by the argument ‘isPause’. In other words, when the argument ‘isPause’ is ‘true’, the attribute ‘data output paused’ is provided for the attribute information in the content of the identifier to which the argument ‘cid’ is provided, and when the argument ‘isPause’ is false and there is a “data output paused” property in the property information of the content in the identifier to which the argument ‘cid’ is provided, the “data output paused” attribute is deleted. When the “data output paused” attribute is deleted, the ‘setAttributeValue( )’ returns ‘true’ and when the “data output paused” attribute fails to be deleted, the ‘setAttributeValue( )’ returns ‘false’.

When the present method is called out, the network library 1605e uses the I01605g to read out the property information table 2521 and searches for property information with the content identifier. Subsequently, attribute information is read out from the file in which the content property information is stored using the IO1605g. Subsequently, the process is finished by deleting and updating the “data output paused” attribute, writing the updated attribute information into the second memory 1403 using the IO1605g, and ‘true’ is returned.

The method ‘updateAttribute( )’ in FIG. 39(2) relates to the content of the identifier provided by the argument ‘cid’, and the attribute update is performed for the “data output paused” in the attribute information of the content using the content of the resume position information table 2532 which is provided in the argument ‘rInfo’, and when the update is successful, the method ‘updateAttribute( )’ returns ‘true’ and when the update fails, the method ‘updateAttribute( )’ returns ‘false’.

When the present method is called out, the network library 1605e finds out whether or not there is information related to the content of the identifier to which the argument ‘cid’ is provided in the content of the resume position information table 2532, to which the argument ‘rInfo’ is provided. The present method is performed by searching for the column 3401 in the resume position information table 2532 shown in FIG. 34.

When there is information related to the content in the resume position information table 2532, the network library 1605e updates the attribute information by providing a ‘cid’ value and ‘true’ as an argument and calling out the method ‘setAttributeValue( )’. When there is no information related to the content in the resume position information table 2532, the network library 1605e updates the attribute information by providing a ‘cid’ value and ‘false’ as an argument and calling out the method ‘setAttributeValue( )’. In any case, a return value of the ‘setAttributeValue( )’ is returned as-is.

The data receiving unit 2805 controls the TS decoder 1407 and the TS multiplexer 1410 in the data output device 1301, through the library 1601b in the OS1601, and video, audio and section data which are filtered by the TS decoder are composed as an MPEG2 transport stream by the TS multiplexer 1410.

The data receiving unit 2805 provides a Java API to the control unit 2801 and the downloaded Java application.

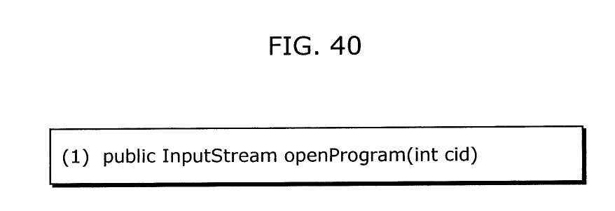

FIG. 40 is a diagram which shows an example of the Java API provided by the data receiving unit 2805 included in the internal structure of the network library 1605e.

The method ‘openProgram( )’ in FIG. 40 (1) controls the TS decoder 1407 and the TS multiplexer 1410, and returns an ‘InputStream’ object read out of the MPEG2 transport stream composed by the TS multiplexer 1410.

Note that when the object fails to be read out, ‘null’ is returned. When the present method is called out, the network library 1605e acquires the PID from video data, audio data and section data according to the channel from the PAT and PMT obtained from the channel identifier designated in the argument ‘cid’, and the PID is provided to the TS decoder 1407 through the library 1601b in the OS1601 and filtered, and the video data, audio data and section data is passed to the TS multiplexer 1410.

Here, the section data may have a structure for outputting only once for each version number. Further, the network library 1605e controls the TS multiplexer 1710 with the TS through the library 1601b in the OS1601, and the MPEG2 transport is structured using the data passed from the TS decoder 1407 and the MPEG2 transport is passed to the CPU 1412.

Here, the processes of the method ‘actMultimediaServer( )’ and the method ‘doMultimediaServer( )’ in the control unit 2801 are explained in detail.

First, the method ‘actMultimediaServer( )’ is described. When the present method is called out, the network library 1605e first calls out the collectDevice( ) and recognizes the device connected to the network. Additionally, a Socket object is generated and stands by for communication defined in UPnP DA and UPnP AV.

Another thread or process is generated and performed. Thus, communication as defined in UPnP DA is performed at any time, and the guide in the connected device is updated. Additionally, when a request for the content list defined in UPnP AV is received from the terminal connected to the network, the method ‘sendContentList( )’ is called out, and the content list is transmitted according to a definition in UPnP AV to the terminal which issued the request.

Additionally, when a request for EPG data transmission is received from the terminal connected to the network, the method ‘sendEPGData( )’ is called out, and EPG data is transmitted according to the UPnP AV definition to the terminal which has issued the request. Further, a Socket object ‘s’ is generated, the method ‘acceptConnection( )’ is called out with ‘s’ as an argument, and the connection request stands by for an RTSP session connection request from the terminal 1302 and the terminal 1303 which are connected to the network 1304. When a connection request for the method ‘acceptConnection( )’ is received and a ‘RemoteDevice’ object is returned, the terminal for which the connection request is received executes the functions of a multimedia server by calling out the method ‘doMultimediaServer( )’ with the ‘RemoteDevice’ object as an argument.

Note that when the method ‘doMultimediaServer( )’ is called out, the present method may have a structure in which a new thread or process is generated and functions. Additionally, when a connection request is received by the method ‘acceptConnection( )’, a new thread or process is generated which may have a structure that calls out the method ‘doMultimediaServer( )’.

Next, the processes of the method ‘doMultimediaServer( )’ are explained in detail. When the present method is called out, the network library 1605e calls out the method ‘receiveRequest( )’ in the information receiving unit 2802, and receives and interprets the RTSP request message. Subsequently, the network library 1605e performs processing according to the content of the request, and an RTSP response message is created and transmitted to the terminal by calling out the method ‘sendMessage( )’ in the information receiving unit 2802. Below, the processes according to the RTSP request are explained respectively.

First, when the RTSP request is SETUP, the URI table 2531 is read out using the IO1605g in the Java library 1605 and content which corresponds to the URI included in the request is searched for. When the content is content accumulated in the second memory 1403, an ‘InputStream’ object which reads out a file in the content is generated using the IO1605g. Additionally, when the request indicates a channel currently being broadcasted, tuning is requested by calling out a handler method ‘notifyChannel ID( )’ in which the ‘ServHandler’ which is registered by the method ‘registrarHandler( )’ is included, and by providing a channel identifier.

Further, the method ‘openProgram( )’ in the data receiving unit 2805 is called out and an InputStream which reads out the content is created. In any case, when the InputStream can be obtained, a ‘ResponseInfo’ object which indicates the RTSP response message is created, 200 is set as the member variable ‘responseCode’, and the same value as the RTSP request is set in the member variable ‘seq’.

Additionally, a session number for the RTSP session is issued and the session number is set in the member variable ‘session’. Additionally, a header in which an RTP port number for communicating the multimedia data is created and set for the member variable ‘headers’. Further, a response message is transmitted to the terminal by calling out the method ‘sendMessage( )’ in the data output unit 2803. Further, the terminal acquires a port number for use in data reception by the terminal from the header Transport value in the received RTSP request, and further the data output device 1301 issues an RTP port number for the data output device 1301 transmitting content which has set in the SETUP. A DatagramSocket object used first in RTP communication is generated using the port number and the ‘RemoteDevice’ object in the argument of the present method. Further, the RemoteDevice UDP object is created using the generated DatagramSocket object and the ‘RemoteDevice’ object in the argument. When an InputStream cannot be obtained, a ‘ResponseInfo’ object is created in which the corresponding error code is set, and the method ‘sendMessage( )’ in the data output unit 2803 is called out and transmitted to the terminal.

Next, when the RTSP request is ‘PLAY’ for a URI on which SETUP has been performed, and is a request for a channel being broadcast, a ‘ResponseInfo’ object in which a response message of ‘200 OK’ is generated and a method ‘sendMessage( )’ in the data output unit 2803 is called out and transmitted to the terminal. Subsequently, an ‘InputStream’ object obtained above and the method ‘sendMultimediaData( )’ in the data output unit 2803 are called out and data transmission is started using the ‘RemoteDevice’ object as an argument for the RTP communication generated above.

Additionally, when PLAY is provided to the content accumulated in the second memory 1403, a member variable ‘extentHeader’ for the ‘RequestInfo object’ returned by the method ‘receiveRequest( )’ is searched for and an X-Restart is searched for. When there is no X-Restart, or when there is an X-Restart but its value is ‘Yes’, the InputStream obtained during SETUP is controlled using a Seek function such that the data which partially corresponds to the value of the member variable ‘range’ is skipped over when read. The number of bytes in the skipped data is stored.

Further, a ‘ResponseInfo’ object in which the response message of ‘200 OK’ is set is generated, and the method ‘sendMessage( )’ in the data output unit 2803 is called out and transmitted to the terminal. Subsequently, the data transmission is started by calling out the method ‘sendMultimediaData( )’ in the data output unit 2803 using the ‘InputStream’ object and the ‘RemoteDevice’ object for RTP communication generated during SETUP as arguments.

Additionally, when there is an X-Restart and the value is ‘Yes’, the network library 1605e calls out the method ‘getPauseStatus( )’ and reads out the resume position information table 2532. The obtained ‘ReopenContentInfo’ object sequence is searched for, and the content resume position information is searched for. When there is no resume position information for the content, the same process is performed as when there is no X-Restart above.

When there is resume position information for the content, the value of the member variable ‘rp’ for the ‘ReopenContentInfo’ object is read out and the InputStream obtained during SETUP is controlled using the Seek function so as to skip over an amount of bytes in the data indicated by the value of the member variable ‘rp’. The number of bytes in the skipped data is stored.

Further, a ‘ResponseInfo’ object for which the response message of ‘200 OK’ is set is generated, and the method ‘sendMessage( )’ in the data output unit 2803 is called out and transmitted to the terminal. Subsequently, the method ‘sendMultimediaData( )’ in the data output unit 2803 is called out and data transmission is started using an argument including the ‘InputStream’ object and the ‘RemoteDevice’ object for RTP communication generated during SETUP.

Further, the method ‘removePauseStatus( )’ is called out and the resume position information related to the resumed data output is deleted from the resume position information table 2532, and the content attributes are updated. Note that the deletion may be structured so as to be performed by a user.

Further, when the broadcasted content described below is accumulated using the process of the network library 1605e, the content may be deleted from the second memory 1403 after the process is resumed and all content is transmitted. Additionally the deletion of the multimedia data may be performed according to a user's instruction. Additionally, the value of the X-Restart may be searched for in a resume position information table 25332 using the data output pause identifier, the content identifier and the data output paused identifier. When data output is resumed and a resume request from the transmission terminal during the resumption time set in the resume position information matches a resume request from another terminal, data may either not be transmitted or be transmitted from the top of the data or the position designated in the Range header.

Next, a case is explained in which the RTSP request is at PAUSE for the data transmission. First, when there is PAUSE for the transmission of content accumulated in the second memory 1403, the network library 1605e calls out the method ‘terminateTransfer( )’ in the data output unit 2803, stops data transmission and obtains the amount of data that has been transmitted. Next, the starting point during resumption is found by taking the sum of the amount of data skipped before transmission and the amount of data transmitted, which are stored.

Subsequently, an identifier which identifies the pause point is issued and a ‘ReopenContentInfo’ object is generated using the resume starting point and the content identifier above. Further, a method ‘setPauseStatus( )’ is called out, the resume position information is added to the resume position table 2532, and the attribute information for the content is updated. Further, a ‘ResponseInfo’ object for which the response message of ‘200 OK’ is set is generated, and the method ‘sendMessage( )’ in the data output unit 2803 is called out and transmitted to the terminal.

Additionally, when there is a PAUSE for the broadcasting channel, the network library 1605e calls out the method ‘terminateTransfer( )’ in the data output unit 2803 and stops data transmission. Subsequently, a method ‘notifyRecording( )’ in the handler in which the ‘ServHandler’ is registered in the method ‘registrarHandler( )’ is called out and a channel identifier is provided, the accumulation of the content is requested and the content identifier is received.

Subsequently, an identifier which identifies the pause point is issued and a ‘ReopenContentInfo’ object is generated using the received content identifier. Note that the resume position is at the top of the file and thus the member variable ‘rp’ is set to 0.

Further, a method ‘setPauseStatus( )’ is called out, the resume position information is added to the resume position table 2532, and the attribute information for the content is updated. Further, a ‘ResponseInfo’ object is generated for which the response message of ‘200 OK’ is set, and the method ‘sendMessage( )’ in the data output unit 2803 is called out and transmitted to the terminal.

Note that in the present embodiment, accumulation of the Java application is requested using the method notifyHandler( ) for the ‘ServHandler’, however the network library 1605e may write into the second memory 1403 using the IO1605g and may request the service manager 1604 to create the identifier and the attribute information for the content. Additionally, an X-Keep-Pause-Status header is included in the PAUSE request and only when the value is ‘Yes’, the network library 1605e may create resume position information as above. Additionally, a transmission destination terminal is designated as an extension header in the PAUSE request when output is resumed and the transmission destination terminal may be set as the member variable ‘rterm’ in the ‘ResumeContentInfo’ object.

Next, when the RTSP request is a TEARDOWN, and the multimedia data is being transmitted, the method ‘terminateTransfer( )’ in the data output unit 2803 is called out and the data transmission is stopped. Further, an ‘InputStream’ object which reads out the multimedia data obtained during SETUP is closed. Further, a ‘ResponseInfo’ object for which the response message of ‘200 OK’ is set is generated, and the method ‘sendMessage( )’ in the data output unit 2803 is called out and transmitted to the terminal. Further, ‘true’ is returned and the processing is finished.

Besides the RTSP request above or when an unauthorized request is received, a ‘ResponseInfo’ object is generated in which an error response message is set according to the content of the request, and a method ‘sendMessage( )’ in the data output unit 2803 is called out and transmitted to the terminal.

Next, the terminal 1302 and the terminal 1303 are explained.

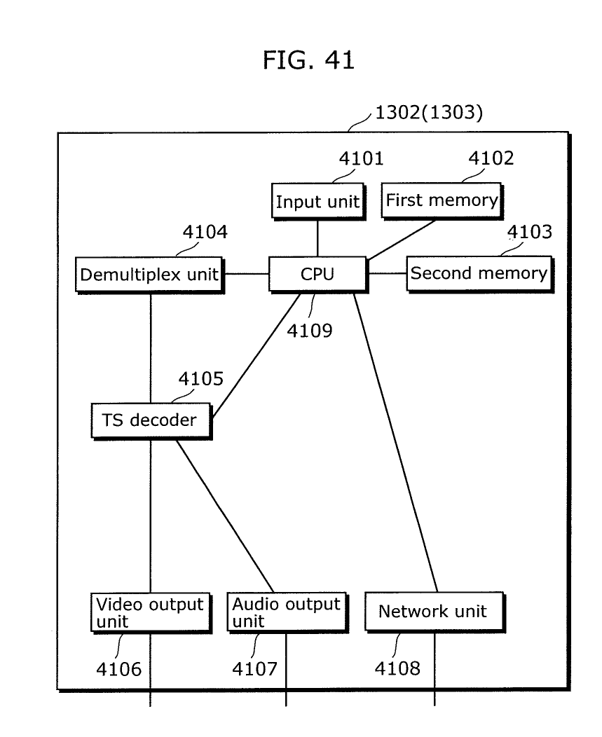

FIG. 41 is a block diagram showing an example of the structure of the terminal 1302 and the terminal 1303 in the second embodiment of the present invention. The terminal 1302 and the terminal 1303 include an input unit 4101, a first memory 4102, a second memory 4103, a demultiplex unit 4104, a TS decoder 4105, a video output unit 4106, an audio output unit 4107, a network unit 4108 and a CPU 4109.

The input unit 4101, the first memory 4102 and the second memory 4103 are the same as the input unit 1401, the first memory 1402 and the second memory 1403 in the data output device 1301 in the present embodiment above. Note that the terminal 1302 and the terminal 1303 accumulate program information such as the content list or the EPG data received from the data output device 1301, and the multimedia data identifier, the title, the broadcast date and time, the broadcast channel and so on in the second memory 4103.

The demultiplex unit 4104 receives the MPEG transport stream from the CPU 4109, extracts information designated by the CPU 4109 and passes it to the CPU 4109. In addition, the demultiplex unit 4104 passes the MPEG transport stream as-is to the TS decoder 4105.

The TS decoder 4105 receives an identifier of audio data and video data from the CPU 4109. Further, data corresponding to the received identifiers of the audio data and video data is extracted from the stream received from the demultiplex unit 4104. The extracted video data is passed respectively to the video output unit 4106 and the audio data is passed to the audio output unit 4107 respectively.

The video output unit 4106 and the audio output unit 4107 are the same as the video output unit 1408 and the audio output unit 1409 in the data output device 1301 in the present embodiment above.

The network unit 4108, which includes a network interface, converts the data received from the CPU 4109 into a signal that is in accordance with the physical media of the network to which the network interface is connected, and outputs the signal. Additionally, the network unit 4108 receives the signal from the network interface, converts the signal into packets defined in the IP network, and passes the packets to the CPU 4109.

The CPU 4109 controls the demultiplex unit 4104, the TS decoder 4105 and the network unit 4109 by executing the program stored in the second memory 4103.

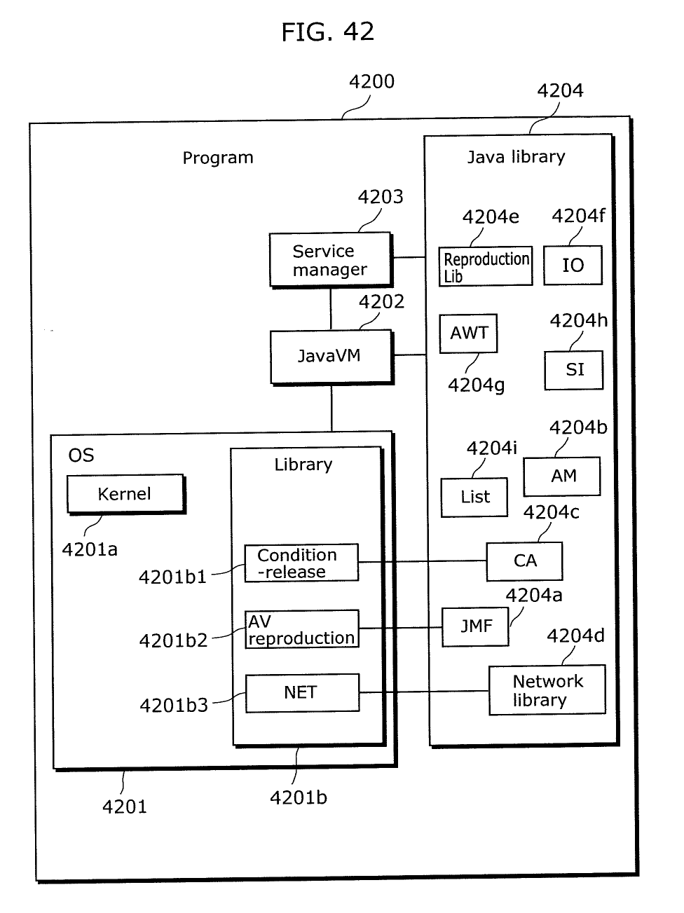

FIG. 42 is a diagram which shows an example of the structure of the program held in the terminal 1302 and the terminal 1303 according to the second embodiment in the present invention respectively. FIG. 42 is a structural example of the program stored in the second memory 4103 and executed by the CPU 4109.

A program 4200 is made up of plural subprograms, and more specifically of an OS 4201, a JavaVM 4202, a service manager 4203 and a Java library 4204.

The OS4201 is a subprogram started by the CPU 4109 when the terminal 1302 and the terminal 1303 are turned on. OS indicates operating system, an example of which is Linux and the like. The OS 4201 is a generic name for publicly known technology made up of a kernel 4201a for executing the subprogram concurrently with another subprogram and of a library 4201b, and therefore detailed description is omitted.

In the present embodiment, the kernel 4201a in the OS 4201 executes the Java VM4203 as a subprogram. Furthermore, the library 4201b provides these subprograms with plural functions for controlling the constituent elements held by the terminal 1302 and the terminal 1303.

In the present embodiment, the library 4201b includes a condition-release 4201b1, an AV reproduction 4202b2 and a NET 4201b3, as an example of functions.

The condition-release 4202b1 receives information from another subprogram and CA4204c in the Java library 4204, decrypts encrypted data received from the network, activates the AV reproduction 4201b2 and permits reproduction of the multimedia data received from the network.

The AV reproduction 4202b2 receives an audio packet ID and a video packet ID from the other subprogram and the JMF 4204a in the Java library 4204. The AV reproduction 4202b2 then provides the received audio packet ID and video packet ID to the TS decoder 4105. As a result, the TS decoder 4105 performs filtering based on the provided packet IDs, and implements the reproduction of video and audio.

The NET 4201b3 creates packets of a protocol lower than the application layer defined by the IP network, for the data received from the other subprogram and a network library 4204d of the Java library 4204.

A protocol lower than the application layer refers to, for example, a TCP packet, a UDP packet, an IP packet, and so on. By passing the protocol to the network unit 4108, messages and data are transmitted to another device via the network 1304.

Furthermore, when a message is received from another device via the network 1304, the NET 4201b3 converts the message to an application layer protocol packet and passes this to the other subprogram and the network library 4204d in the Java library 4204. An application layer protocol refers to, for example, HTTP, RTSP, RTP, and so on.

The Java VM4202 is the same as the JavaVM1603 in the data output device in the present embodiment above.

Besides the differences below, the service manager 4203 is the same as the service manager 1604 in the data output device 1301 in the present embodiment above.

The service manager 1404 receives a channel identifier from the reproduction unit 1602b in the EPG 1602, passing the identifier to the Tuner 1605c and tuning it, further requesting the CA1605d to descramble the identifier and requesting video and audio reproduction by providing a channel identifier to the JMF1605a. However, the service manager 4203 receives the content identifier from the List 4204i in the Java library 4204 and passes information about the content identifier and the device which accumulates the content identifier to the network library 4204d, receives a stream from the device and subsequently requests video and audio reproduction by providing the content identifier to the JMF4204a in the Java library 4204. The List4204i is described below.

The service manager 4203 provides information such as an IP address of the content identifier and the data output device 1301, and information such as a URI for accessing the content to the network library 4204d in the Java library 4204, requests issuance of a multimedia data transmission request and reception of the multimedia data to the data output device 1301 and further requests reception of the multimedia data transmitted from the data output device 1301 to the network library 4204d. When the requests are received in the network library 4204d, a multimedia data transmission request is issued by connecting with the data output device 1301. Subsequently, the network library 4204d passes the data transmitted from the data output device 1301 to the CPU 4109. Thus, it is possible to pass the received multimedia data to a demultiplex unit 4104 and to reproduce the multimedia data.

The Java library 4204 is a collection of plural Java™ libraries stored in the second memory 4103. In the present embodiment, the Java library 4204 includes a JMF4204a, an AM4204b, a CA4204c, a network library 4204d, a reproduction Lib4204e and a List 4204i.

The JMF4204a, the AM 4204b, the reproduction Lib4204e, the IO4204f, the AWT 4204g, the SI4204h are the same as the JMF 1605a, the AM1605b, the reproduction Lib1605f, the IO1605g, the AWT1605h and the SI1605i in the Java library 1605 of the data output device 1301 in the present embodiment above.

The CA4204c manages the rights authentication process for the multimedia data such as copy control and charge information in the multimedia data transmitted via the network 1304. Copy control performs re-writing when necessary by referencing the copy control information included in the section information in the transmitted transport stream. Additionally, the charges and so on are transmitted through the network library 4204d by communicating with the data output device 1301.

The List4204i displays an EPG in the data output device 1301 and a multimedia content list accumulated by the data output device 1301, and selects one multimedia content according to an operation by the user accepted by the input unit 4101 and requests reproduction to the service manager 4203. Thus, information in the data output device 1301 is passed to the service manager 4203. Additionally, the EPG in the data output device 1301 and the content list accumulated by the data output device can be obtained through the network library 4204d. Since the information can be realized via the method defined in UPnP AV, a detailed explanation is not provided.

The network library 4204d communicates with the data output device 1301 connected to the network 1304 through the NET4201b3 in the OS4201b. Communication with the data output device 1301 is transmission and reception of the multimedia data guide, issuance of the multimedia data transmission request and reception of the multimedia data.

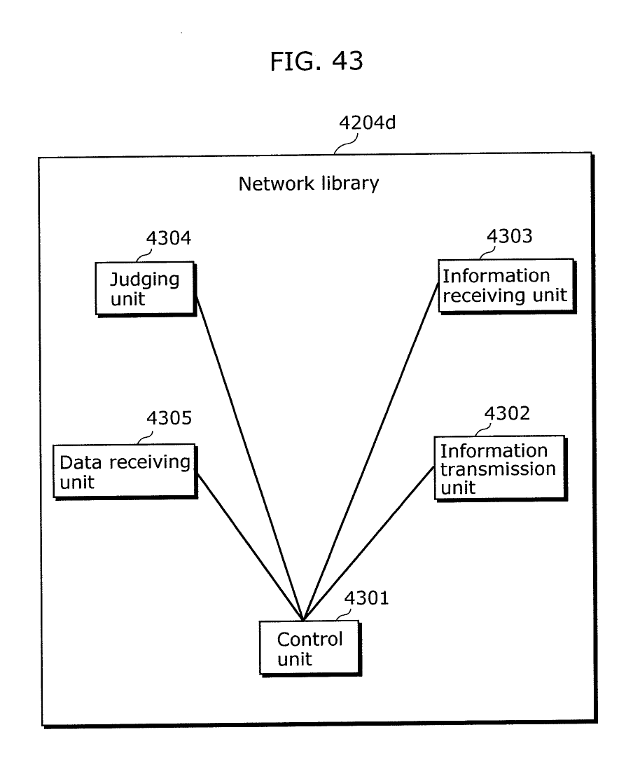

FIG. 43 is a block diagram showing an example of the internal structure of the network library 4204d.

The network library 4204d includes a control unit 4301, an information transmission unit 4302, an information receiving unit 4303, a judging unit 4304 and a data receiving unit 4305. Note that the network library 4205d may include other functions related to the IP network.

The control unit 4301 provides a function for realizing a network library 4204d for the downloaded Java application. In other words, the control unit 4301 provides a Java API for the downloaded Java application and the Java application can realize a function using a network by calling out the API.

The control unit 4301 performs processing by appropriately using an information transmission unit 4302, an information receiving unit 4303, a judging unit 4304, a data receiving unit 4305, and a library 4201b in another Java library 4204 and the OS4201.

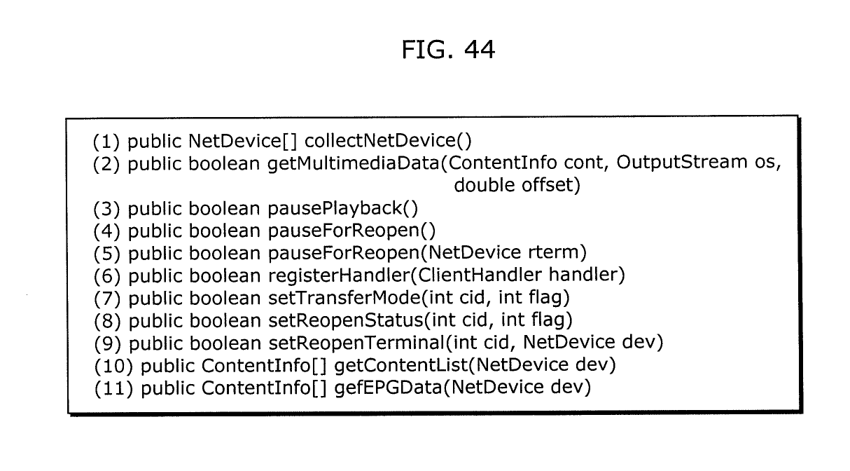

FIG. 44 is a diagram which shows an example of a Java API provided by the control unit 4301 included in the internal structure of the network library 4204d.

The method collectDevice( ) in FIG. 44 (1) gathers information about the external device connected to the network 1304 and returns a sequence of NetDevice objects as the information, and when the information fails to be gathered the method collectDevice( ) returns ‘null’. Using the present method, information about the equipment connected to the network 1304 can be obtained. The NetDevice class is the same as that shown in FIG. 30. Since the processing in the present method can be performed using the method defined in UPnP DA, a detailed explanation of the process is not provided.

The method ‘getMultimediaData( )’ in FIG. 44(2) receives the multimedia data to which the argument ‘cont’ has been provided from the time position provided in the argument ‘offset’ and outputs the multimedia data to the OutputStream object provided in the argument ‘os’.

The argument ‘os’ has the role of passing the received multimedia data to the CPU 4109. The argument ‘offset’ provides a time position on a seconds basis for which the top is 0. Additionally, when the starting point is not designated, a negative value is provided to the argument ‘offset’. The negative value is processed in the same way as the process in which 0 is provided for ‘offset’.

Note that in the present embodiment the argument is provided at only the start point, however a time position at the end point may be provided by adding the argument. In this case, when the end point is not designated, the end point may be realized by providing a negative number to the argument. Additionally, the start point and the end point are time positions at which data communication control using RTSP is performed, however another protocol, for example HTTP, may provide a byte position of the start point and the end point.

The argument ‘cont’ is provided as an object in the ContentInfo class.

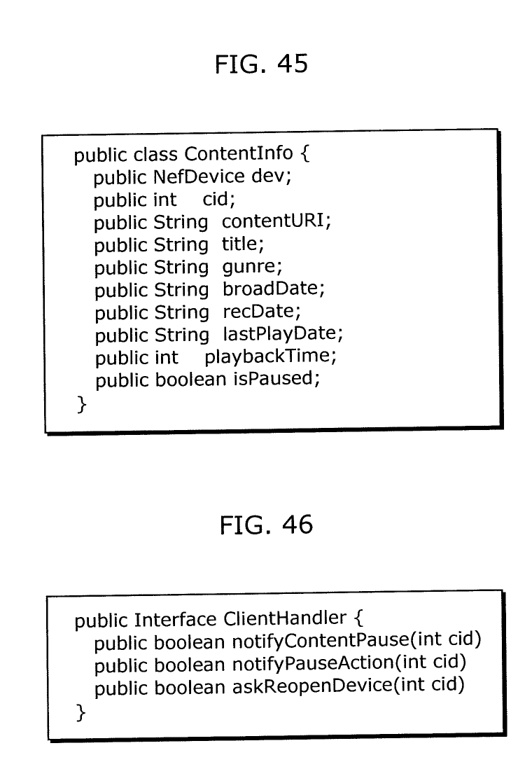

FIG. 45 is a diagram which shows an example of the structure of the ContentInfo class used by the network library 4204d.

The member variable ‘dev’ in FIG. 45 stores the terminal which transmits the multimedia data as a NetDevice object.

Additionally, the member variable ‘cid’ indicates the content identifier for the multimedia data. Additionally, the member variable ‘contentURI’ stores a URI for accessing the multimedia data in a character string. Additionally, the member variable ‘title’ stores the title of the content in a character string. Additionally, the member variable ‘gunre’ stores the type of the content, such as a movie, in a character string.

Additionally, the member variable ‘broadDate’ stores the date and time at which the content is broadcast in a character string. Additionally, the member variable ‘recDate’ stores the date and time at which the content is stored or accumulated in a character string. Additionally, the member variable ‘lastPlayDate’ expresses the final date and time for reproducing content hitherto or for when data is transmitted from the data output device 1301, in a character string.

Additionally, the member variable ‘isPaused’ is a Boolean type variable which is ‘true’ when the multimedia data is transmitted or the reproduction is paused in process, and is ‘false’ when the multimedia data is not transmitted or the reproduction is not paused in process. The information is included in the content list or the EPG data received from the data output device 1301 and can be obtained using the method ‘getContentList( )’ and ‘getEPGData( )’ described below.

Since the present method performs control related to data reception afterwards, information to which the argument ‘cont’ has been provided, a session number for the RTSP session opened by the present method and a sequence number for the message are stored and managed by the network library 4204d.

Additionally, in the present method, it is judged whether or not the multimedia data is paused output and when output of the multimedia data is paused, and the multimedia data is set by the below ‘setTransferMode( )’ before the present method, it is judged whether or not the multimedia data is to be resumed according to the setting. Additionally, when the multimedia data is not set, this is notified to the Java application using a handler object including a ClientHandler interface registered by the method registerHandler( ) described below.

By presenting to the user and accepting input by the user and so on, the Java application judges whether or not the paused data output is to be reopened and notifies the network library 4204d using the method ‘setTransferMode( )’ described below. Details of the method are described below.

The method ‘pausePlayback( )’ in FIG. 44 (3) issues a request from the Java application to the network library 4204d for reception of the multimedia data, and when the request is successful, the method ‘pausePlayback( )’ returns ‘true’ and when the request fails, the method ‘pausePlayback( )’ returns ‘false’. When the present method is called out, the network library 4204d calls out the method ‘notifyPause( )’ or ‘notifyPauseForReopen( )’ in the information transmission unit 4302 described below and transmits the PAUSE request message.

In this case, a value in which the above RTSP session number and the sequence number are increased by one only and provided as an argument. The sequence number is updated. Subsequently, a return value for the method ‘notifyPause( )’ is returned.

Additionally, the method ‘pauseForReopen( )’ in FIG. 44 (4) calls out and transmits the method ‘notifyPauseForReopen’ in the information transmission unit 4302 described below and when the transmission is successful, the method ‘pauseForReopen( )’ returns ‘true’, and when the transmission fails, the method ‘pauseForReopen( )’ returns ‘false’. In this case in the same way, a value in which the number of the above RTSP session number and the sequence number are increased by only one is provided as an argument, and the sequence number is updated.

The method ‘pauseForReopen( )’ takes a NetDevice object as an argument, and may create a PAUSE request described in the extension header as a transmission destination when output is resumed, as in FIG. 44 (5). The details of the processes for the method ‘pausePlayback( )’ and the method ‘pauseForReopen( )’ are described below.

The method registerHandler( ) in FIG. 44(6) registers an object which includes a ClientHandler interface, to which the argument ‘handler’ is provided, in the system. When the registration succeeds, the method registerHandler( ) returns ‘true’ and when the registration fails, the method registerHandler( ) returns ‘false’. The Java application can receive a callback from the network library 4204d by registering the object as the handler.

FIG. 46 is a diagram which shows an example of the structure of the ClientHanlder interface used in the network library 4204d.

The method ‘notifyPause( )’ in the ClientHandler interface in FIG. 46 notifies the Java application that the content of the identifier provided in the argument ‘cid’ is paused.

The Java application can be set to use the method ‘setTransferMode( )’ described below to resume the pause point or to obtain the content from the top of the data or a position designated by the user. The Java application can notify the user that the content is paused, and inquire to the user whether or not output is to be resumed. After the Java application has performed this kind of processing, a return value is returned according to whether the process is successful or not, and control is returned to the network library 4204d.

Additionally, the method ‘notifyPauseAction( )’ notifies the Java application that transmission of the content expressed in the argument ‘cid’ is to be paused.

The Java application can present and inquire to the user regarding whether or not the pause point shall be resumed later, and use the content in the method ‘setReopenStatus( )’ below, to notify the network library 4204d of whether or not the pause point shall be resumed later. After the Java application has performed this kind of processing, a return value is returned according to whether the process is successful or not, and control is returned to the network library 4204d.

Additionally, the method ‘askReopenDevice( )’ notifies the Java application of whether or not the output destination is to be registered when resuming a paused data transmission.

The Java application can present a guide for devices which can reproduce and resume data, such as a terminal connected to the network 1304, and can inquire about the user's selection. The Java application can notify the network library 4204d about the device selected by the user by using the method ‘setReopenTerminal( )’ described below. After the Java application has performed this kind of processing, a return value is returned according to whether or not the process is successful, and control is returned to the network library 4204d.

When output is paused for the content of the identifier provided in the argument ‘cid’ from the Java application to the network library 4204d, the method ‘setTransferMode( )’ in FIG. 44 (7) sets whether or not the transmission is resumed from the pause point, the transmission is started from the top of the data or a position designated by the user using the values provided in the argument ‘flag’. When the transmission is successful, the method ‘setTransferMode( )’ returns ‘true’, and when the transmission fails, the method ‘setTransferMode( )’ returns ‘false’. When 0 is provided for the argument ‘flag’, output is resumed and a positive value is provided, it is judged that output is not resumed and that data is to be obtained from the top of the data or from the position designated by the user.

Additionally, when a negative value is provided, the time point setting is cancelled and the device returns to a non-set state. Besides the case in which the Java application is called out as a call back response according to the method ‘notifyPauseContent( )’ in the ‘ClientHandler’ above, a callback response is also utilized when the present method is set in the system. The setting is saved in the first memory 4102 or the second memory 4103. The method ‘getMultimediaData( )’ is performed according to the setting by the present method.

Since the method ‘setReopenStatus( )’ in FIG. 44 (8) sets a state of whether or not the data is to be resumed below when the data transmission of the content of the identifier provided in the argument ‘cid’ is paused, when the argument ‘flag’ is 0, this expresses that the transmission shall be resumed and when there is a positive value, this expresses that the transmission shall not be resumed.

Additionally, when there is a negative value, the time point setting is cancelled and the device returns to a non-set state. When the processing succeeds, the method ‘setReopenStatus( )’ returns ‘true’ and when the processing fails, the method ‘setReopenStatus( )’ returns ‘false’. Besides the case in which the present method is called out of the Java application as a call back response according to the method ‘notifyPauseAction( )’ in the ‘ClientHandler’ above, a callback response is also utilized when the present method is set in the system. The setting is saved in the first memory 4102 or the second memory 4103.

The method ‘setReopenTerminal( )’ in FIG. 44 (9) pauses data transmission of the content in the identifier provided in the argument ‘cid’, and registers the device to which the argument ‘dev’ is provided as the transmission destination when transmission is resumed, and when the registration succeeds, the method ‘setReopenTerminal( )’ returns ‘true’ and when the registration does not succeed, the method ‘setReopenTerminal( )’ returns ‘false’.

When ‘null’ is provided in the argument ‘dev’, the device is returned to a non-set state. Besides the case in which the present method is called out of the Java application as a call back response according to the method ‘askReopenTerminal( )’ in the ‘ClientHandler’ above, the callback response is utilized when the present method is registered as a transmission destination in the system. The setting is saved in the first memory 4102 or the second memory 4103.

The method getContentList( ) in FIG. 44 (10) obtains the content list from the terminal to which the argument ‘dev’ is provided and returns the content list as a ContentInfo object sequence, and thus when the return succeeds, the method getContentList( ) returns the string and when the return fails, the method getContentList( ) returns ‘null’. Additionally, when there is no content to which the argument ‘dev’ is provided which can be provided to the terminal through the network 104, a sequence of ContentInfo objects with an element amount of 0 is returned. The transmission in the process can be performed via the method defined in UPnP AV and thus a detailed explanation is not provided.

The method getEPGData( ) in FIG. 44 (11) obtains the EPG from the terminal to which the argument ‘dev’ has been applied and returns the EPG as a ContentInfo object sequence, and thus when the return succeeds, the method getEPGData( ) returns the string and when the return fails, the method getEPGData( ) returns ‘null’. The transmission in the process can be performed via the method defined in UPnP AV and thus a detailed explanation is not provided.

The information transmission unit 4302 controls the network unit 4108 through the NET 4201b3 in the library 4201 of the OS4201, and transmits the RTSP request message to the external device connected to the designated network 1304.

The information transmission unit 4302 provides a Java API to the network library 4204d and the downloaded Java application.

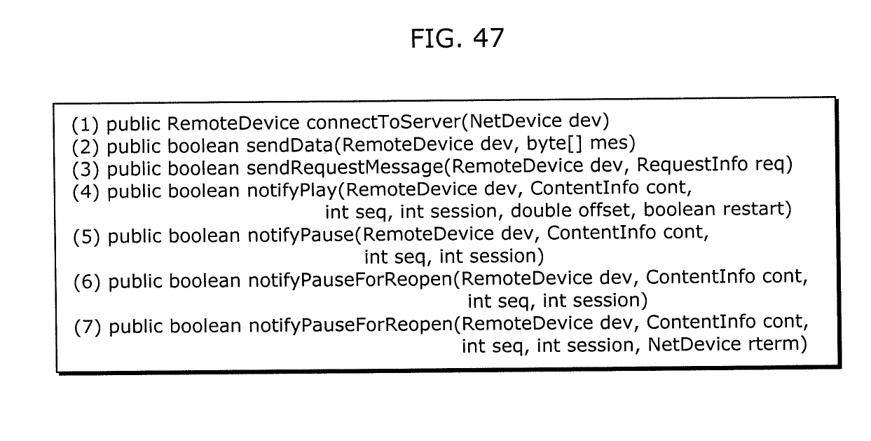

FIG. 47 is a diagram which shows an example of a Java API provided by the information transmission unit 4302 included in the internal structure of the network library 4204d.

A method ‘connectToServer( )’ in FIG. 47(1) generates a Socket object ‘s’ and establishes a TCP session with the device for which the argument ‘dev’ is provided using the Socket object ‘s’, a ‘RemoteDevice’ object is generated and returned using the content of the Socket object ‘s’ and the argument ‘dev’, and when successful, the method ‘connectToServer( )’ returns the ‘RemoteDevice’ object, and when unsuccessful, the method ‘connectToServer( )’ returns ‘null’. The structure of the RemoteDevice class is the same as that shown in FIG. 30. In the TCP session, RTSP session communication is performed.

The method ‘sendData( )’ in FIG. 47(2) transmits the data, to which the argument ‘mes’ has been provided, to the external device to which the argument ‘dev’ is provided, using the Socket object to which the argument ‘dev’ is provided, and when successful, the method ‘sendData( )’ returns ‘true’ and when unsuccessful, the method ‘sendData( )’ returns ‘false’.

The method ‘sendRequestMessage( )’ in FIG. 47 (3) generates and transmits an RTSP request message to which the argument ‘req’ has been applied to the external device to which the argument dev is applied using the Socket object to which the argument dev has been applied. When successful, the method ‘sendRequestMessage( )’ returns ‘true’ is returned and when unsuccessful, the method ‘sendRequestMessage( )’ returns ‘false’. The argument ‘req’ is provided by an object of the ‘RequestInfo’ class. The RequestInfo class is the same as that shown in FIG. 36.

The method ‘notifyPlay( )’ in FIG. 47(4) generates and transmits a PLAY request message in the RTSP using the provided information in the arguments ‘cont’, ‘seq’, ‘session’, ‘offset’ and ‘resume’, to the device for which the argument ‘dev’ is provided; when successful, the method ‘notifyPlay( )’ returns ‘true’, and when unsuccessful, the method ‘notifyPlay( )’ returns ‘false’.

The present method first generates a ‘RequestInfo’ object ‘req’. Subsequently, 1, which indicates ‘PLAY’ is set in the member variable ‘requestType’ of ‘req’. Subsequently, the values provided in the argument ‘seq’ and the argument ‘session’ are set in the ‘req’ member variable ‘seq’ and ‘session’ respectively. Further, the member variable ‘content URI’ is read out of the ContentInfo object to which the argument ‘cont’ is provided, and set as the member variable ‘content URI’ in ‘req’. Further, when the argument ‘offset’ has a value of at least 0, a Range header is generated from the value using a String object and the argument ‘offset’ is set in the member variable ‘range’ for ‘req’.

Additionally, when the argument ‘restart’ is ‘true’, the X-Restart header is created with the value ‘Yes’ and a ‘String’ object is created and stored. Further, another header such as an extension header is generated as a String object when necessary, and set as the member variable for ‘extendHeader’ in req. Subsequently, the ‘RemoteDevice’ object to which ‘req’ and the argument ‘dev’ is provided is called out as an argument using the method ‘sendRequestMessage( )’ and the PLAY request message is transmitted.

The method ‘notifyPause( )’ in FIG. 47 (5), generates and transmits a PAUSE request message in the RTSP using the information to which the arguments ‘cont’, ‘seq’, and ‘session’ are provided, to the device for which the argument ‘dev’ is provided; when successful, the method ‘notifyPause( )’ returns ‘true’, and when unsuccessful, the method ‘notifyPause( )’ returns ‘false’.

The present method first generates a ‘RequestInfo’ object ‘req’. Subsequently, ‘2’, which indicates ‘PAUSE’ is set in the member variable ‘requestType’ of ‘req’. Subsequently, the values provided in the argument ‘seq’ and the argument ‘session’ are set in the ‘req’ member variable ‘seq’ and ‘session’ respectively. Further, the member variable ‘content URI’ is read out of the ContentInfo object provided in the argument ‘cont,’ and set as the member variable ‘content URI’ in ‘req’. Further, the member variable ‘range’ in ‘req’ is set to ‘null’. Further, another header such as an extension header is generated as a String object when necessary, and set as the member variable ‘extendHeader’ in ‘req’. Subsequently, by calling out the method ‘sendRequestMessage( )’ as an argument which is the ‘RemoteDevice’ object to which ‘req’ and the argument ‘dev’ is provided, the ‘PAUSE’ request message is transmitted.

The method ‘notifyPauseForReopen( )’ in FIG. 47(6) generates and transmits a PAUSE request message in the RTSP that includes an X-Keep-Pause-Status header, using the information to which the arguments ‘cont’, ‘seq’ and ‘session’ are provided, to the device for which the argument ‘dev’ is provided; when successful, the method ‘notifyPauseForReopen( )’ returns ‘true’, and when unsuccessful, the method ‘notifyPauseForReopen( )’ returns ‘false’. The X-Keep-Pause-Status header is used with the intention of clearly showing when the paused transmission is to be resumed later.

The present method first generates a ‘RequestInfo object’ ‘req’. Subsequently, ‘2’, which indicates ‘PAUSE’ is set in the member variable ‘requestType’ in ‘req’. Subsequently, the values provided in the argument ‘seq’ and the argument ‘session’ are set in the ‘req’ member variable ‘seq’ and ‘session’ respectively. Further, the member variable ‘content URI’ is read out of the ContentInfo object provided in the argument ‘cont,’ and set as the member variable ‘content URI’ in ‘req’. Further, the member variable ‘range’ in ‘req’ is set to ‘null’. Further, the X-Keep-Pause-Status extension header has a value of ‘Yes’ and is generated using the String object. Additionally, another header such as an extension header is generated by the String object when necessary, and set as the member variable ‘extendHeader’ in ‘req’ as a String object sequence. Subsequently, by calling out the method ‘sendRequestMessage( )’ with the ‘RemoteDevice’ object to which ‘req’ and the argument ‘dev’ is provided as the argument, the ‘PAUSE’ request message is transmitted.

The method ‘notifyPauseForReopen( )’ in FIG. 47(7) generates and transmits a PAUSE request message in the RTSP that includes a transmission destination device in the extension header when transmission is resumed, using the information to which the arguments ‘cont’, ‘seq’, ‘session’, and ‘rterm’ are provided, to the device for which the argument ‘dev’ is provided; when successful, the method ‘notifyPauseForReopen( )’ returns ‘true’, and when unsuccessful, the method ‘notifyPauseForReopen( )’ returns ‘false’. X-Reopen-Terminal is used as an extension header which shows the transmission destination terminal when transmission is resumed.

The present method first generates a ‘RequestInfo object’ ‘req’. Subsequently, ‘2’, which indicates ‘PAUSE’ is set in the member variable ‘requestType’ of ‘req’. Subsequently, the values provided in the argument ‘seq’ and the argument ‘session’ are set in the ‘req’ member variables ‘seq’ and ‘session’ respectively. Further, the member variable ‘content URI’ is read out of the ContentInfo object provided in the argument ‘cont,’ and set as the member variable ‘content URI’ in ‘req’. Further, the member variable ‘range’ in ‘req’ is set to ‘null’. Further, the header described in the transmission destination terminal when transmission is resumed is generated using a String object using the extension header X-Reopen-Terminal. The value of the extension header X-Reopen-Terminal is obtained from the argument ‘rterm’ and may be an IP address of the terminal, a host name of the terminal or a nickname given to the terminal. The nickname is obtained from the ‘rterm’ NetDevice object member variable ‘friendlyName’. Further, another header such as an extension header is generated as a String object when necessary, and set as the member variable ‘extendHeader’ in ‘req’ as a String object sequence. Subsequently, by calling out the method ‘sendRequestMessage( )’ as an argument which is the ‘RemoteDevice’ object to which ‘req’ and the argument ‘dev’ is provided, the ‘PAUSE’ request message is transmitted. The present message may include the X-Keep-Pause-Status extension header.

The information receiving unit 4303 controls the network unit 4108 through the NET 4201b3 in the library 4201 of the OS4201, and receives the RTSP response message from the external device connected to the designated network 1304.

The information receiving unit 4303 provides a Java API to the network library 4204d and the downloaded Java application.

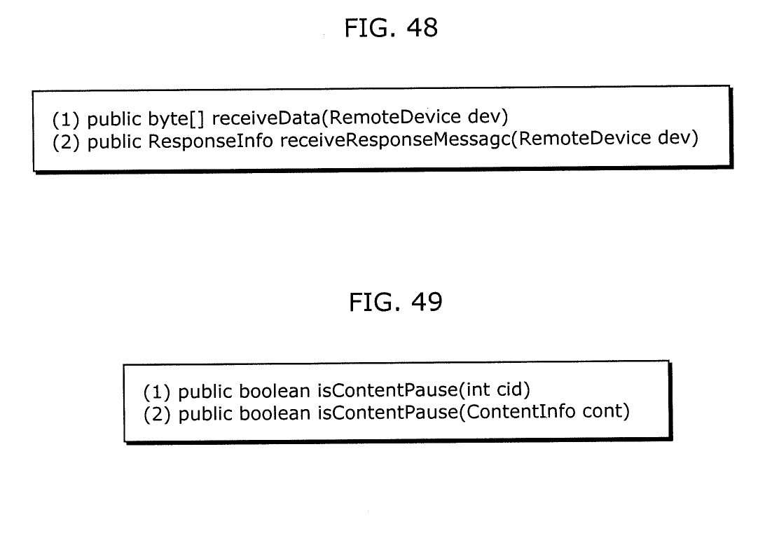

FIG. 48 is a diagram which shows an example of a Java API provided by the information receiving unit 4303 included in the internal structure of the network library 4204d.

The method ‘receiveData( )’ in FIG. 48(1) receives the message from the external device to which the argument dev is provided using the Socket object to which the argument ‘dev’ is provided, returning the message as a sequence of bytes. When successful, the method ‘receiveData( )’ returns the message byte column and when unsuccessful, the method ‘receiveData( )’ returns ‘null’.

A method ‘receiveResponseMessage( )’ in FIG. 48(2) receives the RTSP response message from the external device to which the argument ‘dev’ is provided using the Socket object to which the argument ‘dev’ is provided, interprets the message and generates and returns a ‘ResponseInfo’ object; when successful the method ‘receiveResponseMessage( )’ returns the ‘ResponseInfo’ object and when unsuccessful, the method ‘receiveResponseMessage( )’ returns ‘null’. The ‘ResponseInfo’ class is the same as that shown in FIG. 38.

When the present method is called out, a response message is received by first calling out the method ‘receiveData( )’ then receiving the response message. Subsequently, the ‘ResponseInfo’ object ‘res’ is generated. Additionally, the received response message is interpreted, and the member variables ‘responseCode’, ‘seq’ and ‘session’ are set in ‘res’. Additionally, when a ‘Range’ header is included in the response message, the header is set in the member variable ‘range’ in ‘res’ as a String object. When there are headers other than a ‘Seq’ header, a ‘Session’ header and a ‘Range’ header, one ‘String’ object is generated and set for each header, and the ‘String’ objects are set in the member variable ‘headers’ in ‘res’ as a sequence. When there are headers other than a ‘Seq’ header, a ‘Session’ header and a ‘Range’ header, the member variable ‘headers’ in ‘res’ is set to ‘null’. Subsequently, the method ‘receiveResponseMessage( )’ returns ‘res’. Additionally, when there is an unauthorized response message or reception of the response message has failed, the method ‘receiveResponseMessage( )’ returns ‘null’.

The judging unit 4304 judges whether or not the content has an output paused attribute using the attribute information for the content.

The judging unit 4304 provides a Java API to the network library 4204d and the downloaded Java application.

FIG. 49 is a diagram which shows an example of a Java API provided by the judging unit 4304 included in the internal structure of the network library 4204d.

The method ‘isContentPause( )’ in FIG. 49 (1) judges whether or not the content having the identifier provided by the argument ‘cid’ is paused, and when the method ‘isContentPause( )’ judges the content to be paused, ‘true’ is returned, and when the method ‘isContentPause( )’ judges that the content is not paused, or processing fails, ‘false’ is returned.

When the present method is called out, the network library 4204d uses the IO4204f to read out a content list which is stored in the second memory 1403. A content having an identifier to which the argument ‘cid’ is provided is searched for in the content list that has been read out. The attribute information of the searched content is searched for and when there is an output paused attribute, the method ‘isContentPause( )’ returns ‘true’ and the process finishes, and when there is no paused attribute, the method ‘isContentPause( )’ returns ‘false’ and the process is finished. Additionally, when the content list cannot be read out of the second memory 4103, or there is no content with the identifier to which the argument ‘cid’ is provided in the read-out content list, the method ‘isContentPause( )’ returns ‘false’ and the process is finished.

The method ‘isContentPause( )’ in FIG. 49 (2) has a structure with a ‘ContentInfo’ object in the argument. The present method judges whether or not the content in the ‘ContentInfo’ object provided in the argument is paused. When it is judged that the content is paused, ‘true’ is returned and when it is judged that the content is not paused, ‘false’ is returned. The present method returns the value of the member variable ‘isPause’ in the ContentInfo object provided in the argument.

A data receiving unit 4305 controls a network unit 4108 through the NET 4201b3 in the library 4201 of the OS4201, and receives the multimedia data from the external device connected to the designated network 1304.

The data receiving unit 4305 provides a Java API to the control unit 4301 and the downloaded Java application.

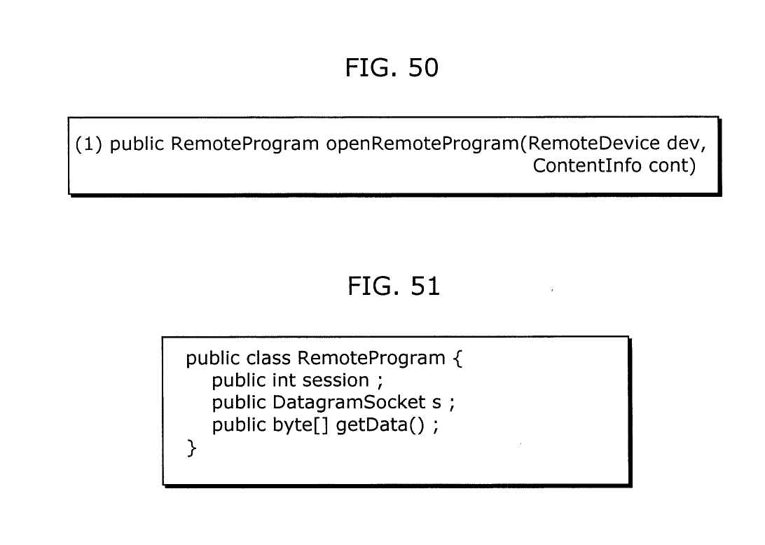

FIG. 50 is a diagram which shows an example of a Java API provided by the receiving unit 4305 included in the internal structure of the network library 4204d.

The method ‘openRemoteProgram( )’ in FIG. 50 (1) secures a communication route which receives multimedia data in the content to which the argument ‘cont’ is provided, from the device to which the argument ‘dev’ has been provided and since a ‘RemoteProgram’ object is returned, when successful the method ‘openRemoteProgram( )’ returns the object and when unsuccessful method ‘openRemoteProgram( )’ returns ‘null’.

FIG. 51 is a diagram which shows an example of the structure of the ‘RemoteProgram’ class used in the network library 4204d.

In FIG. 51, the member variable ‘session’ expresses a session number for the RTSP session which controls the multimedia data communication. Additionally, the member variable ‘s’ expresses a DatagramSocket object for an RTP which receives the multimedia data. Additionally, the method ‘getData( )’ receives data from the RTP and multimedia data is extracted from the RTP packet and returned.

The present invention is not limited to calling out the method ‘getData( )’ and returning one packet's worth of data, however when plural RTP packets are combined and returned, data must be returned which includes a space in which the packet numbers are successive. When the method ‘openRemoteProgram( )’ is called out, the network library 4204d transmits an RTSP SETUP message for the content to which the argument ‘cont’ is provided, to the terminal to which the argument ‘dev’ has been provided. Subsequently, a response message is received, interpreted and when SETUP succeeds, the method ‘getData( )’ creates and returns a RemoteProgram object and when SETUP does not succeed, the method ‘getData( )’ returns ‘null’.

Additionally, when there is an error such as the SETUP message could not be transmitted or the response message could not be received due to the TCP session being interrupted and so on, the method ‘getData( )’ returns ‘null’.

The process of the present method is explained in more detail below. First, when the present method is called out, a ‘RequestInfo’ object ‘req’ is generated. Subsequently, 0, which indicates ‘SETUP’ is set in the member variable ‘requestType’ of ‘req’. The member variable ‘seq’ is set to 1.

Subsequently, when the session number has yet to be allocated in the SETUP request, the member variable ‘session’ may be an arbitrary value. Further, the member variable ‘content URI’ is read out of the ‘ContentInfo’ object provided in the argument ‘cont,’ and set as a String object in the member variable ‘content URI’ in ‘req’. The member variable ‘range’ in ‘req’ is set to ‘null’ since the ‘Range’ header in SETUP is not transmitted.

Further, a UDP port number which receives the multimedia data is issued, a ‘Transport’ header in which the value is described is generated, a ‘String’ object is generated and a character string in the ‘Transport’ header is set. Further, the element count generates a String object sequence which is only 1 String object which includes the Transport header, and the member variable ‘extentHeader’ is set in ‘req’.

Subsequently, by calling out the method ‘sendRequestMessage( )’ in the information transmission unit 4302 as an argument which is the ‘RemoteDevice’ object to which ‘req’ and the argument ‘dev’ is provided, the ‘SETUP’ message is transmitted. Further, by calling out the method ‘receiveResponseMessage( )’ in the information receiving unit 4303 as an argument which is the ‘RemoteDevice’ object to which the argument ‘dev’ is provided, a response message is received and the ‘ResponseInfo’ object is obtained.

When the ‘ResponseInfo’ object is ‘res’, first the member variable ‘responseCode’ is searched for and it is searched whether or not ‘ResponseCode’ is 200 OK. When the ‘ResponseInfo’ is not 200, it is shown that SETUP has failed, the method ‘sendRequestMessage( )’ returns ‘null’ and the process finishes. Subsequently, the ‘RemoteProgram’ object generates ‘rp’.

The member variable ‘session’ for ‘rp’ sets the value for the member variable ‘session’ in ‘res’. Additionally, the member variable ‘headers’ in ‘res’ is searched for and a ‘Transport’ header is searched for. When there is no ‘Transport’ header, the method ‘sendRequestMessage( )’ returns ‘null’ and the process finishes. When there is a ‘Transport’ header, ‘server_port’ is displayed from the ‘Transport’ header and the server obtains a port number for outputting the multimedia data.

The ‘DatagramSocket’ object is generated, the server is connected to and the member variable ‘s’ is set in ‘rp’ using the port number, a port number at which the above network library 4204d receives data and the server information obtained from the argument ‘dev’ T. Subsequently, the method ‘sendRequestMessage( )’ returns ‘rp’ and the processing is finished.

The process of the method ‘getMultimediaData( )’ in the control unit 4301 is explained in more detail below. When the present method is called out, the content information provided in the argument ‘cont’ is stored and managed in the network library 4204d.

The network library 4204d subsequently calls out a method ‘connectToSever( )’ in the information receiving unit 4302 by providing the member variable ‘dev’ in the argument ‘cont’ to an argument and establishes a TCP session which communicates the RTSP message with the data output device 1301 and receives the ‘RemoteDevice’ as a return value. The ‘RemoteDevice’ object is ‘rdev’. ‘rdev’ is stored and managed by the network library 4304d.

Additionally, the method ‘rdev’ may perform a callback using the handier object registered by the ‘registerHandler( )’ and provide the handler object to the Java application which manages the handler object. More specifically, a method known as ‘public Boolean notifyRemote (RemoteDevice dev)’ in the ClientHandler interface shown in FIG. 46 is added and by providing ‘rdev’ to the argument and calling out the argument, the argument can be provided to the Java application.

Subsequently, a method ‘openRemoteProgram( )’ in the data receiving unit 4305 is called out with ‘rdev’ and ‘cont’ as arguments, and in addition to starting an RTSP session, a ‘RemoteProgram’ object which receives multimedia data is received. The ‘RemoteProgram’ object is ‘rp’.

Subsequently, by calling out the method ‘isContentPause( )’ in the judging unit 4304 with ‘cont’ as the argument, it is judged whether or not multimedia data output is paused. When it is judged that the multimedia data output is not paused, a ‘PLAY’ request message is issued for the data output device 1301 by calling out the method ‘notifyPlay( )’ in the information transmission unit 4302.

The argument in this case respectively uses ‘rdev’ in the first argument, ‘cont’ in the second argument, ‘2’ in the third argument, the member variable ‘session’ in ‘rp’ for the fourth argument, the value applied in the argument ‘offset’ in the fifth argument and ‘false’ in the sixth argument.

The third argument is a sequence number in the RTSP session, and 1 is used for SETUP in the method ‘openRemoteProgram( )’ of the data receiving unit 4305. The network library 4204d stores and manages the session number, and after the method ‘notifyPlay( )’ is called out, the stored session number is ‘2’.

When it is judged that output of the content is paused, the network library 4204d first searches for a first memory 4102 or a second memory 4103 using the IO4204 and then searches for whether or not the device is set such that output of the content is to be resumed.

When the device is set to not resume output, the same process as above is performed and the method ‘notifyPlay( )’ in the information transmission unit 4302 is called out. When the device is set to resume output, the method ‘notifyPlay( )’ in the information transmission unit 4302 is called out after changing the above, the fifth argument and the sixth argument. In this case, an arbitrary negative value is provided to the fifth argument and ‘true’ is provided to the sixth argument.

Additionally, when the device is not set in relation to resuming output, the method ‘notifyContentPause( )’ in the handler ‘h’ set in the method ‘registerHandler( )’ is called out and a notification is issued that the method ‘notifyContentPause( )’ is content for which output to the Java application is paused. In this case, the argument provides the member variable ‘cid’ in ‘cont’.

After the Java application performs the settings using the method ‘setTransferMode( )’, the Java application returns control to the network library 4204d. The network library 4204d calls out the method ‘notifyPlay( )’ in the information transmission unit 4302 in the same way as the above, according to the setting performed by the Java application. At this point, when the Java Application does not perform the setting, the device recognizes that output will not be resumed.

After the method ‘notifyPlay( )’ is called out, the method ‘receiveResponse( )’ in the information receiving unit 4303 is called out by providing ‘rdev’ as an argument, a response message is received for the PLAY request and a ‘ResponseInfo’ object is received. The received ‘ResponseInfo’ object is ‘ri’.

The member variable ‘responseCode’ in ‘ri’ is searched for and when the responseCode is 200 which indicates ‘OK’, the ‘rp’ method ‘getData( )’ is called out and the data transmitted from the data output device 1301 is received. When data is received from the method ‘getData( )’ in rp, the data is outputted to an ‘OutputStream’ to which the argument ‘os’ has been provided, and subsequently the method ‘getData( )’ in ‘rp’ is called out and the ‘os’ of the received data is outputted repeatedly until the method in the control unit 4301 which issues the PAUSE message is called out.

The method in the control unit 4301 which issues the ‘PAUSE’ message is ‘pausePlayback( )’ and ‘pauseForReopen( )’, and when the method is called out, a loop of receiving data and outputting to the ‘os’ is stopped by setting a flag for reference during a repeating loop, and so on. Otherwise, the present method may generate another thread or process, and function using the thread or process, or function using only the loop above of the thread or the process, for example by preparing a method for the thread ‘notifyTerminate( )’, issuing notification that the method is used and that the inter-process communication is used. When the response is not 200, the member variable ‘responseCode’ in ‘ri’ returns ‘false’ and finishes processing.

Note that multimedia data can be accumulated in the second memory 4103 using the present method when ‘OutputStream’, which is outputted to the file in the second memory 4103 received from the IO4204f, is provided for the argument ‘os’ in the method ‘getMultimediaData( )’.

Next, the details of the processes for the method ‘pausePlayback( )’ and the method ‘pauseForReopen( )’ are described below.

When the method ‘pausePlayback( )’ is called out, the network library 4204d first searches for a first memory 4102 or a second memory 4103 using the IO4204, and searches for a setting indicating whether or not output is to be resumed for the paused data transmission of the content.

When the device is set not to resume output, the method ‘notifyPause( )’ in the information transmission unit 4302 is called out. In this case, the ‘RemoteDevice’ object in the server, the ContentInfo object corresponding to the content which receives data, the sequence number and the session number in RTSP respectively managed by the network library 4204d are provided as an argument.

Additionally, when it is set that the output shall be resumed, the first memory 4102 or the second memory 4103 are searched using the IO4204f and it is searched whether or not the transmission destination device is set when output is resumed.

When the transmission destination terminal is set, the method ‘notifyPauseForReopen’ in FIG. 47 (7) is called out. The arguments provided are the ‘RemoteDevice’ object in the server, the ContentInfo object corresponding to the content which receives data, the sequence number and the session number in RTSP and the ‘NetDevice’ object in the set device, which are respectively managed by the network library 4204d.

When the transmission destination terminal is set, the method ‘notifyForReopen’ in FIG. 47 (6) is called out. The arguments provided are the ‘RemoteDevice’ object in the server, the ContentInfo object corresponding to the content which receives data and the sequence number and the session number in RTSP which are respectively managed by the network library 4204d.

Additionally, when the device is not set for resuming output, the method ‘notifyPauseAction( )’ in the set handler object ‘h’ is called out using the method ‘registerHandler( )’ and notification is issued in order to stop the transmission in the Java application. The argument provided is the member variable ‘cid’ in the ‘ContentInfo’ object managed by the network library 4204d.

In the Java application, a settings request is notified when output is resumed using the method ‘setReopenStatus( )’ and control is returned to the network library 4204d. The method ‘notifyPauseForReopen( )’ in the information transmission unit 4302 is called out as above based on the set content in the network library 4204d in the same way as above. At this point, when the content is not set by the Java Application, the device recognizes that output will not be resumed.

After the above process, a process to stop the receiving process in the ‘getMultimediaData( )’ method above is performed, and the ‘getMultimediaData( )’ method returns a return value for the method ‘notifyPause( )’ or ‘notifyPauseForReopen( )’ in the called out information transmission unit 4302 and the process finishes. Note that when the terminal is set when the output is resumed, the method ‘notifyReopenDevice( )’ in the handler ‘h’ is called out, notified to the Java application and the Java application may set the output destination terminal using the method ‘setReopenTerminal( )’. In this case, when the output destination terminal is not set by the Java application, it is recognized that the output destination terminal is not designated.

The method ‘notifypauseForReopen( )’ in FIG. 47 (6) has the same process when the terminal is set to resume output in the method ‘pausePlayback( )’ above.

The method ‘notifypauseForReopen( )’ in FIG. 47 (7) is set to resume output in the method ‘pausePlayback( )’ above, and when the output destination terminal is set, the process is performed with the exception of the points below.

The difference is that in the above ‘pausePlayback( )’, when the method ‘notifyPauseForReopen’ in FIG. 47(7) is called out, a NetDevice object for the output destination terminal set as a fifth argument is used, however in the present method, a ‘NetDevice’ object provided in the argument ‘dev’ is used.

As explained above, when the data output device 1301 which composes the multimedia delivery system 1305 according to the embodiment receives the output pause request from the terminal while outputting data, stores the resume position information obtained from the multimedia data for which output is paused and the output pause position in the device, receives the data output resume request and the output destination terminal from the terminal, reads out the stored resume position information and resumes data output.

Additionally, when the output of some multimedia data is judged to be paused in the data output device 1301, then the terminal 1302 and the terminal 1303 according to the present embodiment include an equipment control unit 1501 which resumes data output to the data output device 1301 by transmitting a data output resume request and an output destination terminal. According to this structure for example, viewing of some multimedia content is paused in the terminal 1302 and it is possible to resume the viewing of the multimedia content in the terminal 1303 from the pause point.

### Modification of Second Embodiment

Although the present invention is described for the second embodiment, the present invention is not limited to the above second embodiment. The present invention also includes such cases as described below.

(1) The data output device 1301 may have a structure in which an identifier for identifying the pause point is issued when the data output is paused is transmitted to the terminal using a method such as including the identifier in the content list, including the identifier in the SETUP request response as an extension header, and so on, and resuming data output when the data output resume request and the identifier are received. Communication of the identifier may be performed by establishing an extension header in the ‘PLAY’ request message, and by using the identifier as an X-Restart header value. In this case, when there is an extension header X-Restart in the data output device 1301, it is judged that the data output shall be resumed and the resume position information is searched from the pause point identifier and the content identifier.

Additionally, when the equipment control unit 1501 in the terminal 1302 and the terminal 1303 have obtained the identifier above, the equipment control unit 1501 may transmit a data output resume request along with the identifier above.

Additionally the identifier above may be used as an attribute value for the paused output. In other words, the content of the PAUSE element in FIG. 26 is set in the identifier, and it may be judged that when there is a PAUSE element and its content is described, the data output is paused, and when there is no PAUSE element, or when there is a PAUSE element but it is an empty element with no content, the data output is not paused.

Additionally, the above identifier may be used as an attribute value which indicates paused output in the content list outputted by the data output device 1301.

Additionally, the data output device 1301 may reply to the terminal with a response to the data output pause request and may not include the identifier above in the content list, and the above identifier may be included in the content list. In this case, only the user who knows the identifier can resume output, thereby realizing the effect of improving security and so on.

Additionally, the identifier above may be provided to the data output device 1301 from the terminal. Further, the data output device 1301 may have a structure which does not include the identifier above in the content list. In the same way in this case, only the user who knows the identifier can resume output, thereby realizing the effect of improving security and so on.

Additionally, the data output device 1301 may have a structure which manages the above identifier as a combination of the date and time at which the content is paused and the terminal at which the content is paused.

(2) When the terminal 1302 and the terminal 1303 transmit a request for pausing data output, the output destination when data output is resumed may also transmit data, the data output device 1301 may save the resume position information and the output destination in the storage unit 1407 and when the data output resume request for the data is accepted, the data may be outputted to the output destination.

Adding an extension header X-Reopen-Terminal to the PAUSE request message in the above embodiment and describing a specific terminal as the value is an example of the data output pause request in this case. The IP address of the terminal, the host name of each terminal or the nickname given to each terminal may serve as the output destination. This information can be obtained using a method defined in UPnP DA.

Additionally, when the data output device 1301 receives a data output pause request along with an output destination when data output is resumed, data output may be resumed only via a request from the terminal which is the output destination.

Additionally, when the data output device 1301 receives a data output pause request along with an output destination for when data output is resumed, data output may be resumed only when a data output resume request and an output destination are received and match each other when compared to the stored output destination.

(3) In the above embodiment, the data output device 1301 is an STB which receives digital broadcasts, however the present invention is not limited to this. The present invention may be structured to receive and accumulate content from the network without a tuner. The structure in this case is the same as in FIG. 41. Additionally, the present invention may have a structure in which an element other than a network accumulates data.

(4) Additionally, when a request for pausing the data output is received above, data is subsequently written into the second memory 1403, however the present invention may write from the top of the multimedia data beforehand into the second memory 1403 without waiting for a request to pause the data output.

In this case, the output resume position information can be created using the same method as the content accumulated in the second memory 1403 in the above embodiment.

Additionally, the data output device 1301 always inserts into the first memory 1402 or a non-pictured buffer region data of a fixed amount of time or a fixed capacity in the multimedia data outputted by the TS multiplexer 1410, and may write the data including the data in the buffer region when a request to pause output is received. Additionally, the data output resume position may be calculated including the data in the buffer region or without including the data in the buffer region.

(5) The data output device 1301 may further generate and store the resume position information for multimedia data for which reproduction in the data output device 1301 has been paused.

In the structure, when reproduction in the data output device 1301 is paused by the same process as in the above embodiment, data output to the terminal 1302 or the terminal 1303 can be resumed, and output to the terminal 1302 or the terminal 1303 can be paused and resumed as reproduction in the data output device 1301.

(6) In the above embodiment, the data output device 1301 may store the resume position information, however a third device on the network may store the data.

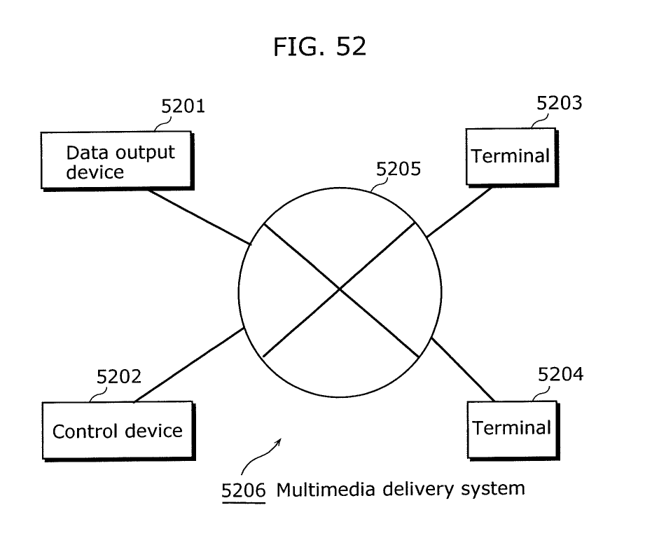

FIG. 52 is a diagram which shows the structure of the multimedia delivery system in a sixth modification of the second embodiment in the present invention.

A multimedia delivery system 5206 shown in FIG. 52 includes a data output device 5201, a control device 5202 which controls the data output device and terminal through the network, a first terminal 5203, a second terminal 5304 and a network 5205. The data output device 5201, the control device 5202, the terminal 5203 and the terminal 5204 are connected to a network 5205 and can communicate mutually through the network 5205.

The data output device 5201 receives a request from the control device 5202, the terminal 5203 and the terminal 5204 transmitted through the network 5205. Subsequently, information and attributes for each content accumulated are transmitted through the network 5205 to the control device 5202 when necessary, and additionally, multimedia data in the content accumulated is transmitted through the network 5205 to the terminal 5203 and the terminal 5204 when necessary.

Additionally, transmitting the multimedia data can be performed by transmitting data from an arbitrary location when necessary.

When the data output device 5201 receives the pause request from the transmission destination terminal for the data output to be executed, the data position at which output is to be resumed, which is the position after the position of the last transmitted data, as well as the file name or the URI of the multimedia data are transmitted through the network 5205 to the control device 5202. Note that as described below, in this case the file name or URI of multimedia data does not have to be transmitted.

The control device 5202 functions according to a user's request. The control device 5202 receives multimedia data through the network 5205 from the data output device 5201 by controlling the terminal 5203 and the terminal 5204 and performs control to reproduce the multimedia data. This control can be performed by the method defined in UPnP AV and thus the details are not provided.

Additionally, information and attributes such as the title of the content are received by making a request to the data output device 5201, and are presented to the user by the display unit in the terminal 5203, the terminal 5204 and the control device 5202 itself.

Additionally, when the user receives the request for pausing the reproducing content, the control device 5202 transmits the data transmission pause request to the data output device 5201 by controlling reproduction in the executing terminal 5203 or the terminal 5204, and reproduction is paused. Further, the control device 5202 receives information which can specify the data such as the data position at which output is resumed, the file name or the URI of multimedia data by communicating with the data output device 5201, and stores the name or URI in the control device 5202.

The resume position information can use the same function as the second embodiment.

Note that since the URI of the multimedia data is used when the control device 5202 issues a reproduction request, the URI is already known during reproduction pausing and does not necessarily receive data from the data output device when reproduction is paused. When the reproduction resume request and the reproducing terminal are designated by the user, the control device 5202 further reads out the resume position information and receives and reproduces data starting from the resume position from the data output device 5201 in the terminal.

According to the request transmitted through the network 5205 from the control device 5202, the designated multimedia data and the designated range data is received from the designated server, is reproduced and displayed.

The network 5205 is the same as the network 1304 in the above embodiment.

According to the explanation above, for example in the multimedia delivery system 5206 with the present structure, the reproduction of multimedia content performed by the terminal 5203 is paused and can be resumed in the terminal 5204 by for example the control device 5202 managing the resume position information.

Note that here the control device 5202 creates resume position information by receiving at least the data position for resuming the output from the data output device 5201, however the data output device 5201 may create resume position information, and the control device 5202 may receive and save the resume position information.

Additionally, here the control device 5202 creates resume position information by receiving at least the data position for resuming the output from the data output device 5201, however the control device 5202 may receive from the terminal 5203 or the terminal 5204 which execute reproduction at least the data position at which data has been most recently reproduced and so on, and may create the resume position information.

Additionally, here the control device 5202 issues a request to the terminal 5203 or the terminal 5204 and transmits a data transmission request from the terminal to the data output device 5201, however the control device 5202 may issue a transmission request from the data output device 5201 to the terminal 5203 or the terminal 5204 and further may issue a data reception request to the terminal from the data output device 5201. This kind of data transfer control can be performed by File Transfer Protocol (FTP).

Additionally, the control device 5202 which is independent on the network saves the resume position information, however equipment which includes an arbitrary storage unit on the network can save the resume position information, and one of the data output device, the equipment control device or the terminal may acquire and interpret the resume position information.

(7) In the above second embodiment, RTP/RSTP is utilized as a data transfer protocol, however data transfer may be performed using another protocol such as HTTP. When HTTP is used, the request to pause data output may be performed by cutting an HTTP-GET session short, and may be performed in a separate communication session. Additionally, when using HTTP, the request to pause data may be performed using a proprietary extension header in HTTP-GET such as the X-Restart above.

(8) In the second embodiment above, the next data position after the last transmitted data is used as the transmission resume position, however a position at which a specified amount of data has been transmitted may be used. Subsequently, when the multimedia data is MPEG2 encoded data, a PAT and so on in the I-frame and the MPEG2-TS is indispensable for coding and may be the top of the last data in the transmitted data, and so on. Additionally, even when the multimedia data is other coded data, the same is true.

(9) It is possible that a part or all of the constituent elements making up each of the above-mentioned devices is made from one system LSI (Large Scale Integration circuit). The system LSI is a super multi-function LSI that is manufactured by integrating plural elements on one chip, and is more specifically a computer system which is configured including a microprocessor, a ROM, a RAM, and so on. A computer program is stored in the RAM. The system LSI accomplishes its functions through the operation of the microprocessor in accordance with the computer program.

(10) It is possible that a part or all of the constituent elements making up each of the above-mentioned devices is made from an IC card that can be detached from each device, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(11) The data output device and the equipment control device may also be the methods described above. The present invention may also be a computer program for executing such methods through a computer, or a digital signal made up of the computer program.

Furthermore, the data output device and the equipment control device in the present invention may be for example a computer-readable recording medium, such as a flexible disk, a hard disk, a CD-ROM, an MO, a DVD, a DVD-ROM, a DVD-RAM, a BD (Blu-ray Disc), or a semiconductor memory, on which the computer program or the digital signal can be stored. Additionally, the data output device and the equipment control device in the present invention may be the computer program or the digital signal stored on the recording mediums.

Furthermore, the data output device and the equipment control device in the present invention may also transmit the computer program or the digital signal via an electrical communication line, a wireless or wired communication line, a network represented by the Internet, a data broadcast, and so on.

Furthermore, the data output device and the equipment control device in the present invention may be a computer system including a microprocessor and a memory, with the above computer program being stored in the memory and the microprocessor operating in accordance with the computer program.

Furthermore, the present invention may also be implemented in another independent computer system by recording the program or digital signal on the recording medium and transferring the recording medium, or by transferring the program or the digital signal via the network, and the like.

(12) It is also possible to combine the second embodiment and the above modifications.

### INDUSTRIAL APPLICABILITY

The data output device, the equipment control device and the multimedia delivery system in the present invention are useful as a server device, a receiving terminal, an equipment control device, a data output method, an equipment control method, and so on for multimedia content in a network environment such as a home network, since the present invention has a superior effect in which during data transmission related to multimedia content reproduction through a network, the data transmission can be precisely resumed even when a terminal or a device which receives a paused data transmission is changed.

1. A data output device which outputs multimedia data that includes at least one of video and audio, said data output device comprising:
a receiving unit operable to receive a signal from an external device;
an accumulation unit operable to accumulate the multimedia data;
a readout unit operable to read out the multimedia data from said accumulation unit;
an output unit operable to output the multimedia data to a designated output destination;
a storage unit operable to store the multimedia data for which output by said output unit has been paused and resume position information which shows a position for resuming output of the multimedia data; and
a control unit operable to
generate the resume position information and to cause said storage unit to store the generated resume position information when a pause request, which is a request to pause output by said output unit, is received by said receiving unit, and
to read out the resume position information from said storage unit, to cause said readout unit to read out the multimedia data, starting from the resume position shown by the resume position information, from said accumulation unit and to cause said output unit to output the read-out multimedia data to the output destination, when a resume request which is a request to resume output by said output unit is received by said receiving unit.

2. The data output device according to claim 1,
wherein the data output device is connected to plural terminals through a network, and
said output unit is operable to output a designated one of the plural terminals as the output destination.

3. The data output device according to claim 1,
wherein said output unit is operable to output the multimedia data to one of plural output destinations, and
said control unit is operable to read out the resume position information from said storage unit, to cause said readout unit to read out the multimedia data, starting from the resume position shown by the resume position information from said accumulation unit, and to cause said output unit to output the read-out multimedia data to the output destination received by said receiving unit when said receiving unit has received the resume request and one of the plural output destinations.

4. The data output device according to claim 1,
wherein said control unit is operable to generate the resume position information and a pause identifier, the pause identifier identifying the pause request, when the pause request is received by said receiving unit, and to cause said storage unit to store the generated resume position information and the pause identifier, and
to read out the resume position information corresponding to the pause identifier from said storage unit, to cause said readout unit to read out the multimedia data starting from the resume position shown by the resume position information from said accumulation unit, and to cause said output unit to output the read-out multimedia data to the output destination when the resume request, the output destination and the pause identifier are received by said receiving unit.

5. The data output device according to claim 1,
wherein said output unit outputs the multimedia data to one of the output destinations, and
said control unit is operable to,
when a second output destination is received which differs from the output destination when the resume request and the pause signal are received,
read out the resume position information from said storage unit, cause said readout unit to read out the multimedia data starting from the resume position shown in the resume position information and to cause said output unit to output the read-out multimedia data to the second output destination.

6. The data output device according to claim 1, further comprising:
a data receiving unit operable to receive the multimedia data from an external device; and
a writing unit operable to write multimedia data received by said data receiving unit into said accumulation unit;
wherein said control unit is further operable to cause said data receiving unit to receive a succeeding portion of the multimedia data, and to cause said writing unit to write the received succeeding portion of the multimedia data into said accumulation unit when said data receiving unit receives and said output unit outputs the multimedia data, and the pause request is received, and
to cause said readout unit to read out the succeeding portion of the multimedia data written into said accumulation unit by said writing unit, and to cause said output unit to output the read-out multimedia data to the output destination when said receiving unit has received the resume request and the output destination.

7. The data output device according to claim 1, further comprising
a reproduction unit operable to reproduce the multimedia data;
wherein said output unit is operable to output the multimedia data to one of plural output destinations or said reproduction unit, and
said control unit is further operable to
generate the resume position information and cause said storage unit to store the generated resume position information when said output unit outputs to said reproduction unit and the pause signal is received by said receiving unit.

8. The data output device according to claim 7, further comprising
a data receiving unit operable to receive the multimedia data from an external device; and
a writing unit operable to write the multimedia data received by said receiving unit,
wherein said control unit is further operable to:
cause said data receiving unit to receive a succeeding portion of the multimedia data, and to cause said writing unit to write the received succeeding portion of the multimedia data in said accumulation unit, when said data receiving unit receives and said output unit outputs the multimedia data to said reproduction unit, and
to cause said readout unit to read out the succeeding portion of the multimedia data written into said accumulation unit by said writing unit, and to cause said output unit to output the read-out multimedia data to the output destination, when said receiving unit has received the resume request.

9. A data output method for outputting multimedia data which includes at least one of video and audio, said data output method being executed in a device which includes an accumulation unit that accumulates the multimedia data, said data output method comprising:
a receiving step of receiving a signal from an external control device;
a read-out step of reading out data from the accumulation unit;
an output step of outputting the multimedia data to a designated output destination; and
a control step of
generating resume position information which indicates a position for resuming the multimedia data, obtained from the multimedia data for which the output is paused and a position at which the output is paused, and causing the generated resume position information to be stored in a storage unit, when a pause request which is a request to pause output in said output step is received in said receiving step, and
reading out the resume position information from the storage unit, causing the multimedia data to be read out in said read-out step from the accumulation unit starting from the resume position shown by the resume position information; and causing the read-out multimedia data to be outputted to the output destination when a resume request, which is a resume request for resuming the output in said output step, and an output destination are received in said receiving step.

10. The data output device according to claim 1, further comprising
a Java execution unit operable to execute a Java (registered trademark) application,
wherein said control unit is started by the Java application.

11. The data output device according to claim 10,
wherein said output unit is operable to output the multimedia data to one of plural output destinations, and
said control unit is operable to
read out the resume position information from said storage unit, cause said readout unit to read out the multimedia data, starting from the resume position shown in the resume position information, from said accumulation unit, and cause said output unit to output the read-out multimedia data to a different output destination than the output source when the resume request and a second output destination, which differs from an output source when the pause signal is received, are received.

12. The data output device according to claim 10,
wherein the data output device is connected to plural terminals through a network, and
said output unit is operable to output through the network to one of the plural terminals, the one being designated by the user.

13. The data output device according to claim 10,
wherein said control unit is operable to
generate the resume position information and a pause identifier which identifies the pause request when the pause request is received by said receiving unit, and to cause said storage unit to store the generated resume position information and the pause identifier, and
to read out the resume position information corresponding to the pause identifier from said storage unit, to cause said readout unit to read out the multimedia data, starting from the resume position shown in the resume position information, from said accumulation unit, and to cause said output unit to output the read-out multimedia data to the output destination when the resume request, the output destination and the pause identifier are received by said receiving unit.

14. The data output device according to claim 10,
wherein said control unit is further operable to,
when the pause request and an output destination when output is resumed are received by said receiving unit, generate the resume position information, and cause said storage unit to store the resume position information and the output destination, and
to read out the resume position information and the output destination from said storage unit when the resume request is received by said receiving unit, to cause said readout unit to read out the multimedia data, starting from the resume position shown by the resume position information, from said accumulation unit and to cause said output unit to output the read-out multimedia data from said storage unit to the read-out output destination.

15. The data output device according to claim 10, further comprising:
a data receiving unit operable to receive the multimedia data from an external device; and
a writing unit operable to write the multimedia data received by said data receiving unit into said accumulation unit,
wherein said control unit is further operable to,
cause said receiving unit to receive a succeeding portion of the multimedia data when said data receiving unit receives and said output unit outputs the multimedia data, and to cause said writing unit to write the received succeeding portion of the multimedia data in said accumulation unit, and
to cause said readout unit to read out the succeeding portion of the multimedia data written into said accumulation unit by said writing unit when said receiving unit has received the resume request and the output destination, and to cause said output unit to output the read-out multimedia data to the output destination.

16. The data output device according to claim 10, further comprising
a reproduction unit operable to reproduce the multimedia data,
wherein said output unit is operable to output the multimedia data to one of the plural output destinations or said reproduction unit,
said control unit is further operable to
receive the resume position information for which output has been paused from said output unit to said reproduction unit from the Java application, in the case where the pause signal has been received when said output unit outputs to said reproduction unit, and to cause said storage unit to store the resume position information, and
to receive the multimedia identifier from the Java application, and to pass the resume position information of the multimedia data stored in said storage unit to the Java application.

17. The data output device according to claim 16, further comprising:
a data receiving unit operable to receive multimedia data from an external device;
a writing unit operable to write the multimedia data received by said data receiving unit into said accumulation unit;
wherein said control unit is further operable to,
cause said data receiving unit to receive a succeeding portion of the multimedia data, and to cause said writing unit to write the received succeeding portion of the multimedia data in said accumulation unit according to an instruction from the Java application, when said data receiving unit receives, and the pause request is received when said output unit outputs the multimedia data to said reproduction unit,
to generate the reproduction position information in the written data and to cause said storage unit to store the reproduction position information, and
to cause said readout unit to read out the succeeding portion of the multimedia data written into said accumulation unit by said writing unit when said receiving unit has received the resume request, and to cause said output unit to output the read-out multimedia data to the output destination.

18. A data output method for outputting multimedia data, said data output method being executed in a device connected to a network which includes: an accumulation unit operable to accumulate multimedia data, a Java execution unit which executes a Java application and a control unit started by the Java application, said data output method including at least one of video and audio, and said data output method comprising:
a receiving step of receiving a message from an external control device connected to the network;
a read-out step of reading out multimedia data from the accumulation unit;
an output step of outputting the multimedia data to a designated output destination through the network;
a control step of
generating resume position information, obtained from the multimedia data for which output is paused in said output step and a position at which output is paused, which shows a position at which output is to be resumed and storing the generated resume position information in the storage unit when a pause request, which is a request to pause output in said output step, is received in said receiving step, and
reading out of the resume position information from the storage unit, and controlling the reading out of the multimedia data, starting from a resume position shown in the resume position information, from the accumulation unit in said read-out step, and outputting the read-out multimedia data to an output destination in said output step when a resume request, which is a request for resuming the output in said output step, and an output destination are received in said receiving step.

19. An equipment control device which issues a request to a data output device which outputs multimedia data which includes at least one of video and audio, said equipment control device comprising:
a transmission unit operable to transmit a request to the data output device, and
a control unit operable to specify an output destination and to cause said transmission unit to transmit to the specified output destination when a pause request which is a request to pause output of the multimedia data by the data output device is transmitted to the data output device, and the data output device resumes data output.

20. The equipment control device according to claim 19, further comprising:
a Java execution unit operable to execute a Java application, and
wherein said control unit is operable to specify an output destination when the data output device resumes data output and to cause said transmission unit to transmit the specified output destination when the pause request is received from the Java application and transmitted to the data output device.

21. The equipment control device according to claim 19, further comprising
a Java execution unit operable to execute a Java application;
wherein said control unit is operable to,
when the pause request and an output destination during output resumption are received, and when the pause request is transmitted to the data output device,
cause said transmission unit to transmit to the transmission destination.

22. A data output device which provides multimedia data that includes at least one of video and audio, and an equipment control device which functions by a user operation and is connected through a network, the equipment control device including:
an attribute receiving unit operable to receive attributes of a content provided from the data output device;
a transmission unit operable to transmit a request to the data output device, and
a control unit operable to,
when a resume request, which is a request to resume content data output based on the user operation, is received, judge whether or not output of the content is paused, and when it is judged that output of the content is paused, cause said transmission unit to transmit the resume request to the data output device.

23. The equipment control device according to claim 22,
wherein said attribute receiving unit is operable to receive attributes of the content that includes an identifier which indicates paused output for each content, and
said control unit is operable to cause said transmission unit to transmit the resume request and the identifier to the data output device when it is judged that output is paused.

24. The equipment control device according to claim 22, further comprising
a Java execution unit operable to execute a Java application;
wherein said control unit is operable to judge whether or not output of the content is paused, based on the content attributes received by said attribute receiving unit, when the resume request is received from the Java application, and to cause said transmission unit to transmit the resume request to the data output device when it is judged that the output is paused.

25. The equipment control device according to claim 24,
wherein said control unit is further operable to inquire to the Java application whether or not paused output is to be resumed when the output is judged to be paused and to cause said transmission unit to transmit the resume request to the multimedia server when an instruction from the Java application to resume output is received.

26. An equipment control device which is connected to a network and which controls a data output device which outputs multimedia data that includes at least one of video and audio, said equipment control device comprising:
a storage unit operable to store resume position information obtained from the multimedia data for which output is paused and the position at which output of the multimedia data is paused, and which indicates a position at which output is to be resumed, when an output pause request to the data output device;
a communication unit operable to communicate with the data output device;
a control unit operable to cause the resume position information to be received from the data output device and to cause said storage unit to store the resume position information; and
to cause the resume position information and an output destination stored by said storage unit to be transmitted to the data output device when the output resume request is sent to the data output device.

27. The equipment control device according to claim 26, further comprising:
a Java execution unit operable to execute a Java application,
wherein said control unit is operable to
cause said communication unit to transmit a pause request to the data output device, and to cause said transmission unit to receive the resume position information obtained from the multimedia data for which output is paused and a position at which output is paused from the data output device and to cause said storage unit to store the resume position information; and
to cause the resume position information stored in said storage unit to be read out and to cause said communication unit to transmit an output resume request and an output destination along with the resume position information to the data output device when the resume request is received in the data output device from the Java application.

28. A multimedia delivery system in which a data output device which outputs multimedia data that includes at least one of video and audio and plural terminals which receive the outputted multimedia data are connected through a network, the multimedia delivery system comprising:
the data output device including:
a receiving unit operable to receive a signal from an equipment control device;
an accumulation unit operable to accumulate the multimedia data;
a readout unit operable to read out the multimedia data from said accumulation unit;
an output unit operable to output the multimedia data to a designated output destination;
a storage unit operable to store resume position information which shows a position for resuming output which is obtained from the multimedia data for which output is paused by said output unit and a position at which output of the multimedia data is paused; and
a control unit operable to
generate the resume position information and to cause said storage unit to store the generated resume position information when a pause request, which is a request to pause output by said output unit, is received by said receiving unit, and
to read out the resume position information from said storage unit, to cause said readout unit to read out the multimedia data, starting from the resume position shown by the resume position information, from said accumulation unit and to cause said output unit to output the read-out multimedia data to the output destination, when a resume request which is a request to resume output by said output unit is received by said receiving unit,
the terminals including:
a transmission unit operable to transmit a request to the data output device; and
a control unit operable to specify an output destination when the data output device resumes output of the data and to cause said transmission unit to transmit to the specified output destination when the data output device sends a pause request which is a request to pause the multimedia data output to the data output device.
